(19) United States
(12) Patent Application Publication
(10) Pub. No.: US 2013/0169762 A1
(43) Pub. Date: Jul. 4, 2013

(54) RECEIVING APPARATUS, RECEIVING METHOD AND TRANSMITTING APPARATUS

(71) Applicants: Takashi KANEMARU, Yokohama (JP); Sadao TSURUGA, Yokohama (JP); Satoshi OTSUKA, Yokohama (JP)

(72) Inventors: Takashi KANEMARU, Yokohama (JP); Sadao TSURUGA, Yokohama (JP); Satoshi OTSUKA, Yokohama (JP)

(73) Assignee: Hitachi Consumer Electronics, Ltd.

(21) Appl. No.: 13/540,054

(22) Filed: Jul. 2, 2012

(30) Foreign Application Priority Data
Jul. 15, 2011 (JP) 2011-156261
Jul. 15, 2011 (JP) 2011-156262

(51) Int. Cl. H04N 13/04

(52) U.S. Cl. CPC H04N 13/0452
USPC 348/51

(57) ABSTRACT

Transmitting apparatus transmits a 3D video content, including video data, caption data, and information of depth display position or parallax information relating to the caption data, while a receiving apparatus conducts video processing on the video data and the caption data, so as to display it/them in 3D or 2D, wherein the video processing comprises a first video process for displaying the video data of the 3D video content received, and for displaying the caption data received with using the information of depth display position or the parallax information, and a second video process for displaying the video data of the 3D video content received in 2D, and for displaying the caption information received without based on the information of depth display position or the parallax information, when an operation input signal to change 3D display into 2D display is inputted, enabling a user to view/listen to 3D content.

This application relates to and claims priorities from Japanese Patent Application No. 2011-156262 filed on Jul. 15, 2011, and Japanese Patent Application No. 2011-156261 filed on Jul. 15, 2011, the entire disclosures of which are incorporated herein by reference.

### BACKGROUND OF THE INVENTION

The present invention relates to a broadcast receiving apparatus, a receiving method and a transmitting method of three dimension (hereinafter, being called “3D”) video.

In the following Patent Document 1 are described the followings: as a problem to be dissolved, “for providing a digital broadcast receiving apparatus for enabling to notice that a program desired by a user will start on a certain channel, etc., actively” (see [0005] of the Patent Document 1), and as a means for dissolving thereof, “comprises a means for taking out program information, which is included in digital broadcast waves, and for selecting a notice object program with using selection information, which is registered by the user, and a means for displaying a message of noticing an existence of the selected notice object program, while pushing it into a screen being displayed at present” (see of the Patent Document 1), etc.

Also, in the following Patent Document 2 are described the followings: “for enabling to display a caption at an appropriate position” (see [0011] of the Patent Document 2), as the problem to be dissolved, and as a means for dissolving thereof, “a caption generating portion generates a distance parameter “E” for indicating at how much distance should be displayed a caption upon basis of caption data “D”, separating from a user on a stereo display apparatus, i.e., the caption should be displayed to be seen at how much distance separating from the user, as well as, generating the caption data “D”, and supply it to a multiplexer portion. The multiplexer portion multiplexes the caption data “D” and the distance data “E”, which are supplied from the caption generating portion, onto encoded video data supplied from a stereo encoding portion, upon basis of a predetermined format, and transmits a data stream “F” multiplexed to a decoding system through a transmission path or medium. With this, on the stereo display apparatus can be displayed the caption so that it lies at a predetermined distance from the user in the direction of depth. The present invention can be applied into a stereo video camera . . . ” (see [0027] of the Patent Document 2), etc.

### PRIOR ART DOCUMENTS

### Patent Documents

[Patent Document 1] Japanese Patent Laying-Open No. 2003-9033 (2003); and
[Patent Document 2] Japanese Patent Laying-Open No. 2004-274125 (2004).

### BRIEF SUMMARY OF THE INVENTION

However, in the Patent Document 1 is no disclosure relating to viewing/listening of 3D content. For this reason, it has a drawback that it is impossible to recognize a program, which is received at present or will be received in future, to be a 3D program.

Also, in the Patent Document 2 are only displayed simple operation, such as, transmitting and receiving of the “encoded video data “C””, the “caption data “D” ” and the “distance parameter “E”, and therefore has a drawback that those are not sufficient for achieving a transmitting process and a receiving process, for enabling to deal with other various kinds of information and situations in an actual broadcasting or communication.

For dissolving such drawbacks as mentioned above, in an embodiment according to the present invention, for example, a transmitting apparatus receives 3D video content, including video data and caption data and display depth position information or parallax information in relation to the caption data, while a receiving apparatus receives the 3D video content mentioned above, wherein the receiving apparatus executes a video processing on the video data and the caption data received, so as to display them in 3D or 2D, and that video processing may be constructed to include first video processing for displaying the video data of the 3D content received in 3D and for displaying the caption data received in 3D with using the display depth position information or the parallax information, and a second video processing for displaying the video data of the 3D content data received in 2D, and for displaying the caption data received, but not upon basis of the display depth position information or the parallax information, when an input signal is inputted for an operation of exchanging 3D display into 2D display from an operation inputting portion of the receiving apparatus.

According to the present invention, it is possible for a user to view/listen the 3D contents, preferably.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 shows an example of a block diagram for showing an example of the configuration of a system;

FIG. 2 shows an example of a block diagram for showing an example of the configuration of a transmitting apparatus 1;

FIG. 3 shows an example of assignment of stream format kinds;

FIG. 4 shows an example of the structure of a component descriptor;

FIG. 5A shows an example of component contents and component to kinds, being constituent elements of the component descriptor;

FIG. 5B shows an example of component contents and component kinds, being constituent elements of the component descriptor;

FIG. 5C shows an example of component contents and component kinds, being constituent elements of the component descriptor;

FIG. 5D shows an example of component contents and component kinds, being constituent elements of the component descriptor;

FIG. 5E shows an example of component contents and component kinds, being constituent elements of the component descriptor;

FIG. 6 shows an example of the structure of a component group descriptor;

FIG. 7 shows an example of a component group kind;

FIG. 8 shows an example of component group identification;

FIG. 9 shows an example of a charging unit kind;

FIG. 10A shows an example of the structure of a 3D program detail descriptor;

FIG. 10B shows an example of the structure of a 3D/2D kind;

FIG. 11 is a view for showing an example of a format kind of 3D;

FIG. 12 shows an example of the structure of a service descriptor;

FIG. 13 shows an example of a service format kind;

FIG. 14 shows an example of the structure of a service list descriptor;

FIG. 15 shows an example of a transmission management rule or regulation in the transmitting apparatus 1 of the component descriptor;

FIG. 16 shows an example of a transmission management rule or regulation in the transmitting apparatus 1 of the component group descriptor;

FIG. 17 shows an example of a transmission management rule or regulation in the transmitting apparatus 1 of the 3D program detail descriptor;

FIG. 18 shows an example of a transmission management rule or regulation in the transmitting apparatus 1 of the service descriptor;

FIG. 19 shows an example of a transmission management rule or regulation in the transmitting apparatus 1 of the service list descriptor;

FIG. 20 shows an example of processing on each field of the component descriptor in a receiving apparatus 4;

FIG. 21 shows an example of processing on each field of the component group descriptor in the receiving apparatus 4;

FIG. 22 shows an example of processing on each field of the 3D program detail descriptor in the receiving apparatus 4;

FIG. 23 shows an example of processing on each field of the service descriptor in the receiving apparatus 4;

FIG. 24 shows an example of processing on each field of the service list descriptor in the receiving apparatus 4;

FIG. 25 shows an example of the structure view of the receiving apparatus according to the present invention;

FIG. 26 shows an example of an outlook view of a function block diagram inside a CPU, being the receiving apparatus according to the present invention;

FIG. 27 shows an example of a flowchart of a 2D/3D video displaying process upon basis of a fact that a next program is 3D contents or not;

FIG. 28 shows an example of a message display;

FIG. 29 shows an example of a message display;

FIG. 30 shows an example of a message display;

FIG. 31 shows an example of a message display;

FIG. 32 shows an example of a flowchart of a system controller portion when a next program starts;

FIG. 33 shows an example of a message display;

FIG. 34 shows an example of a message display;

FIG. 35 shows an example of a block diagram for showing an example of the configuration of a system;

FIG. 36 shows an example of a block diagram for showing an example of the configuration of a system;

FIGS. 37A and 37B are an explanatory view of an example of 3D reproducing/outputting/displaying process of the 3D contents;

FIG. 38 is an explanatory view of an example of 2D reproducing/outputting/displaying process of the 3D contents;

FIGS. 39A and 39B are an explanatory view of an example of 3D reproducing/outputting/displaying process of the 3D contents;

FIGS. 40A-40D are an explanatory view of an example of 2D reproducing/outputting/displaying process of the 3D contents;

FIG. 41 shows an example of a flowchart of a 2D/3D video displaying process upon basis of a fact that a present program is 3D contents or not;

FIG. 42 shows an example of a message display;

FIG. 43 shows an example of a flowchart for display processing after user selection;

FIG. 44 shows an example of a message display;

FIG. 45 shows an example of a flowchart of a 2D/3D video displaying process upon basis of a fact that a present program is 3D contents or not;

FIG. 46 shows an example of a message display;

FIG. 47 shows an example of a combination of streams when transmitting 3D video;

FIG. 48 shows an example of the structure of a content descriptor;

FIG. 49 shows an example of a code table about program genres;

FIG. 50 shows an example of a code table about program characteristics;

FIG. 51 shows an example of a code table about program characteristics;

FIG. 52 shows an example of the structure of transmission data in the transmitting apparatus 1 of caption/character super data;

FIG. 53A shows an example of data to be transmitted from the transmitting apparatus;

FIG. 53B shows an example of data to be transmitted from the transmitting apparatus;

FIG. 54 shows an example of data to be transmitted from the transmitting apparatus;

FIG. 55 shows an example of data to be transmitted from the transmitting apparatus;

FIG. 56A shows an example of data to be transmitted from the transmitting apparatus;

FIG. 56B shows an example of data to be transmitted from the transmitting apparatus;

FIG. 57 shows an example of data to be transmitted from the transmitting apparatus;

FIG. 58 shows an example of data to be transmitted from the transmitting apparatus;

FIG. 59A shows an example of data to be transmitted from the transmitting apparatus;

FIG. 59B shows an example of data to be transmitted from the transmitting apparatus;

FIG. 59C shows an example of data to be transmitted from the transmitting apparatus;

FIG. 59D shows an example of data to be transmitted from the transmitting apparatus;

FIG. 60A shows an example of code of the caption data;

FIG. 60B shows an example of expanding method of the caption data;

FIG. 61A shows an example of code and control thereof in relation to the caption data;

FIG. 61B shows an example of code and control thereof in relation to the caption data;

FIG. 61C shows an example of code in relation to the caption data;

FIG. 62A shows an example of code and control thereof in relation to the caption data;

FIG. 62B shows an example of code in relation to the caption data;

FIG. 63 shows an example of code in relation to the caption data;

FIG. 64 shows an example of code in relation to the caption data;

FIG. 65 shows an example of code in relation to the caption data;

FIG. 66 shows an example of code in relation to the caption data;

FIG. 67 shows an example of code in relation to the caption data;

FIG. 68 shows an example of a flowchart of processing when displaying the caption data, according to a one embodiment of the present invention;

FIG. 69A shows an example of a process of 3D displaying of the 3D contents, according to the one embodiment of the present invention;

FIG. 69B shows an example of a process of 3D displaying of the 3D contents, according to the one embodiment of the present invention;

FIG. 70 shows an example of a flowchart of processing when displaying the caption data, according to a one embodiment of the present invention;

FIG. 71 shows an example of a flowchart of processing when displaying the caption data, according to a one embodiment of the present invention;

FIG. 72A shows an example of data to be transmitted from the transmitting apparatus;

FIG. 72B shows an example of data to be transmitted from the transmitting apparatus;

FIG. 72C shows an example of data to be transmitted from the transmitting apparatus;

FIG. 72D shows an example of data to be transmitted from the transmitting apparatus;

FIG. 73A shows an example of data to be transmitted from the transmitting apparatus;

FIG. 73B shows an example of data to be transmitted from the transmitting apparatus;

FIG. 73C shows an example of data to be transmitted from the transmitting apparatus;

FIG. 74A shows an example of a process of 3D displaying of the 3D contents, according to the one embodiment of the present invention;

FIG. 74B shows an example of a process of 3D displaying of the 3D contents, according to the one embodiment of the present invention;

FIG. 75 shows an example of the configuration of apparatuses according to a one embodiment of the present invention;

FIG. 76A shows an example of a process of 3D displaying of the 3D contents, according to the one embodiment of the present invention; and

FIG. 76B shows an example of a process of 3D displaying of the 3D contents, according to the one embodiment of the present invention.

### DETAILED DESCRIPTION OF THE PREFERRED EMBODIMENTS

Hereinafter, explanation will be given fully on examples (i.e., embodiments) of preferable embodiments according to the present invention. However, the present invention should not be restricted only to the present embodiments, which will be mentioned below. The present embodiments will be explained in relation to a receiving apparatus, in particular, therefore being preferable to be embodied to be the receiving apparatus; however, should not be prevented from being applied to those other than the receiving apparatus. Also, it is not necessary for all of the constituent elements of the embodiments to be adopting, but they are selectable.

<System>

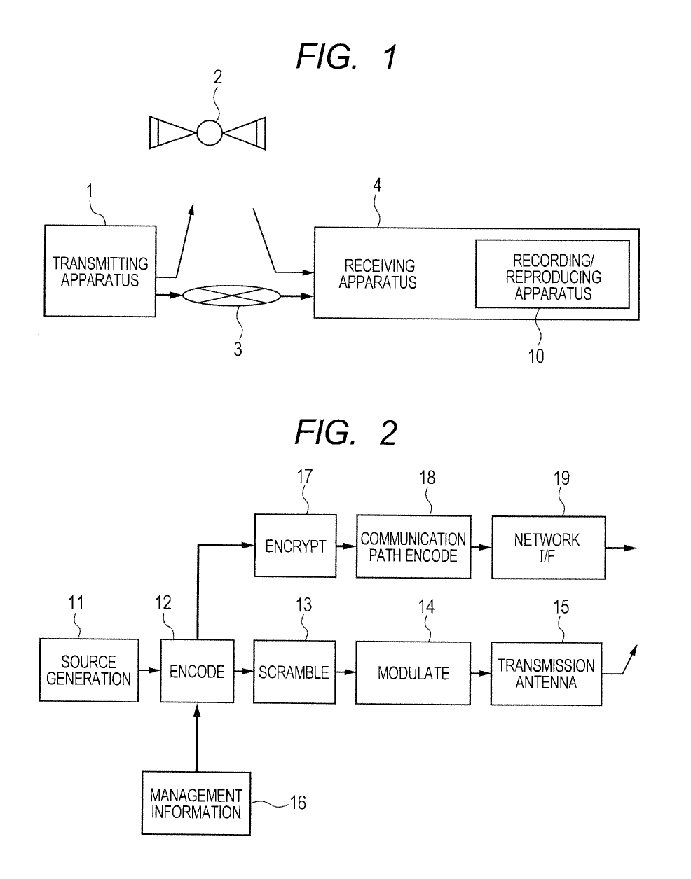

FIG. 1 is a block diagram for showing an example of the configuration of a system, according to the present embodiment. There is shown an example of the case where information is transmitted (sent/received) on an air (broadcasting) and is recorded/reproduced. However, the transmission should not be limited only to the broadcasting, but may be VOD through communication, and may be also called “distribution”, collectively.

A reference numeral 1 depicts a transmitting apparatus, which is installed in an information providing station, such as, a broadcast station, etc., 2 a relay apparatus, which is installed in a relay station or a satellite for use of broadcasting, etc., 3 a public (circuit) network for connecting between an ordinary household and the broadcast station, such as, the Internet, etc., and 4 a receiving apparatus, which is installed within a user's household, etc., and 10 a receiving recording/reproducing portion, which is built within the receiving apparatus 4, respectively. Within the receiving recording/reproducing portion 10, it is possible to record/reproduce the broadcasted information, or to reproduce the content from an external removable medium, etc.

The transmitting apparatus 1 transmits a modulated signal radio wave through the relay apparatus 2. Other than such transmission with using the satellite as is shown in the figure, for example, it is also possible to use the transmission with using a cable, the transmission with using a telephone line, the transmission with using a terrestrial broadcasting, and the transmission passing via a network, such as, the Internet, for example, through the public network. This signal radio wave received by the receiving apparatus 4, as will be mentioned later, after being demodulated into an information signal, will be recorded on a recording medium depending on a necessity thereof. Or, when being transmitted through the public network, it is converted into a format, such as, a data format (an IP packet) in accordance with a protocol suitable to the public network (for example, TCP/IP), etc., while the receiving apparatus 4 receiving the data mentioned above decodes it into the information signal, being a signal suitable to be recorded depending on a necessity thereof, and it is recorded on the recoding medium. Also, the user can view/listen the video/audio shown by the information signal, on a display if this display is built within the receiving apparatus 4, or by connecting a display not show in the figure to the receiving apparatus 4 if it is not built therein.

<Transmitting Apparatus>

FIG. 2 is a block diagram for showing an example of the structure of the transmitting apparatus among those of the system shown in FIG. 1.

A reference numeral 11 depicts a source generator portion, 12 an encode portion for conducting compression with using a method, such as, MPEG 2 or H.264, etc., and thereby adding program information or the like thereto, 13 a scramble portion, 14 a modulator portion, 15 a transmission antenna, and 16 a management data supply portion, respectively. The information, which generated in the source generator portion 11 composed of a camera and/or a recording/reproducing apparatus, such as, video/audio, etc., is treated with compression of the data volume thereof in the encode portion 12, so that it can be transmitted with occupying a less bandwidth. It is encrypted in the scramble portion 13 depending on a necessity thereof, so that it can be viewed/listened only for a specific viewer. After being modulated into a signal suitable to be transmitted, such as, OFDM, TC8PSK, QPSK, multi-value QAM, etc., within the modulator portion 14, it is transmitted as a radio wave directing to the relay apparatus 2 from the transmission antenna 15. In this instance, within the management information supply portion 16, it is supplied with program identification information, such as the property of the content, which is produced in the source generator portion 11 (for example, encoded information of video and/or audio, encoded information of audio, structure of program, if it is 3D video or not, etc.), and also is supplied with program arrangement information, which the broadcasting station produces (for example, the structure of a present program or a next program, a format of service, information of structures of programs for one (1) week, etc.). Hereinafter, the program identification information and the program arrangement information will be called “program information”, combining those together.

However, it is very often that plural numbers of information are multiplexed on one (1) radio wave, through a method, such as, time-sharing, spectrum dispersion, etc. Although not mentioned in FIG. 2, for the purpose of simplification, but in this case, there are plural numbers of systems of the source generator portion 11 and the encode portion 12, wherein a multiplex portion (e.g., a multiplexer) for multiplexing plural numbers of information is disposed between the encode portion 12 and the scramble portion 13.

Also, in the similar manner for the signal to be transmitted through the network 3 including the public network, the signal produced in the encode portion 12 is encrypted in an encryption portion 17 depending on a necessity thereof, so that it can be viewed/listened only for the specific viewer. After being encoded into a signal suitable to transmit through the public network 3 within a communication path coding portion 18, it is transmitted from a network I/F (Interface) portion 19 directing to the public network 3.

<3D Transmission Method>

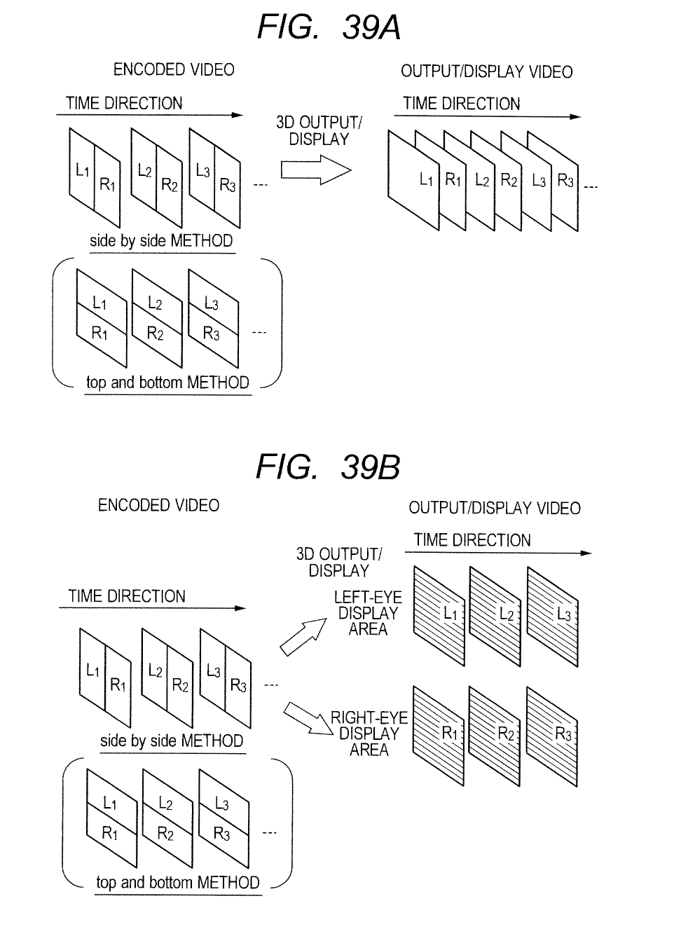

Roughly dividing the transmission methods for the 3D program to be transmitted from the transmitting apparatus 1, there are two (2) methods. One of them is a method of storing the videos for use of the left-side eye and for use of the right-side eye within one (1) piece of picture, with applying an existing broadcasting method for the 2D program effectively. In this method, the existing MPEG 2 (Moving Picture Experts Group 2) or H.264 AVC is utilized as a video compression method, and the characteristic thereof lies in that it has a compatibility with the existing broadcast, as well as, enabling to utilize an existing relay infrastructure, and it can be received by an existing receiver (such as, STB, etc.); however, it is transmission of the 3D video having a resolution of a half (½) of the highest resolution of the existing broadcast (in the vertical direction or the horizontal direction). For example, as is shown in FIG. 39A, there are the followings: a “Side-by-Side” method, i.e., diving one (1) piece of picture to the left and the right and storing them into a screen size of the 2D program, by reducing the video for use of the left-side eye (L) and the video for use of the right-side eye (R) down to about a half (½) of the 2D program in width of the horizontal direction, respectively, while keeping them to be equal thereto in width of the vertical direction, a “Top-and-Bottom” method, i.e., diving one (1) piece of picture up and down and storing them into the screen size equal to that of the 2D program, by keeping the video for use of the left-side eye (L) and the video for use of the right-side eye (R) to be equal thereto, respectively, while reducing them down to a half (½) of the 2D program in width of the vertical direction, and further others, such as, a “Field alternative” method of storing them with utilizing an interlace, a “Line alternative” method of storing the videos for use of the left-side eye and the right-side eye, alternately, for one (1) piece of scanning line, and a “Left+Depth” method of storing the 2D video (of one side) and depth (distance until an object) information for each pixel. Since those methods are such that each divides one (1) piece of picture into plural numbers of pictures and stores the pictures of plural numbers of viewpoints, the MPEG 2 or the H.264 AVC (excepting MVC), not a method for coding a multi-viewpoints picture, originally or inherently, can be applied as it is, as the coding method itself, and therefore there can be obtained a merit for enabling to carry out the 3D program broadcasting with applying the existing broadcasting method for the 2D program, effectively. Further, in case where it is possible to transmit the 2D program at a screen size of 1,920 dots in the maximum horizontal direction and of 1,080 lines in the vertical direction, for example, when carrying out the broadcasting of the 3D program with the “Side-by-Side” method, it is enough to divide one (1) piece of picture into the left and the right and to store the video for use of the left-side eye (L) and the video for use of the right-side eye (R) into a screen size of 960 dots in the horizontal direction and of 1,080 lines in the vertical direction, respectively, and thereby to transmit it. In the similar manner, in this case, when carrying out the 3D program broadcasting with the “Top-and-Bottom” method, it is enough to divide one (1) piece of picture up and down and to store the video for use of the left-side eye (L) and the video for use of the right-side eye (R) into a screen size of 1,920 dots in the horizontal direction and of 540 lines in the vertical direction, respectively, and thereby to transmit it.

As other method, there is already known a method of transmitting the video for use of the left-side eye and the video for use of the right-side eye by separate streams (ES), respectively. According to the present embodiment, that method will be called “3D 2-viewpoints separate ES transmission”. As an example of this method, there is a transmission method with using H.264 MVC, being a multi-viewpoints coding method, for example. The characteristic of that lies in that it can transmit the 3D video of high resolution. With using this method, there can be obtained an effect of enabling the transmission of the 3D video of high resolution. However, the multi-viewpoints coding method means a coding method, which is standardized for coding the video of multi-viewpoints, and with this, it is possible to encode the video of multi-viewpoints, without dividing one (1) piece of video into each viewpoint, i.e., for encoding other picture for each viewpoint.

In case when transmitting the 3D video with this method, it is enough to transmit the encoded picture of the viewpoint for use of the left-side eye as a main-viewpoint picture and the encoded picture of the viewpoint for use of the right-side eye as another viewpoint picture. With doing in this manner, for the main-viewpoint picture, it is possible to keep the compatibility with the existing broadcasting method of the 2D program. For example, when applying the H.264 MVC as the multi-viewpoints video coding method, for a base layer sub-bit stream of the H.264 MVC, the main-viewpoint picture can keep the compatibility with the 2D picture of the H.264 AVC, and the main-viewpoint picture can be displayed as the 2D picture.

Further, according to the embodiment of the present invention, the followings are included, as other examples of a “3D 2-viewpoints separated ES transmission method”.

As other example of the “3D 2-viewpoints separated ES transmission method” is included a method of encoding the encoded picture for use of the left-side eye as a main-viewpoint picture with the MPEG 2, while encoding the encoded picture for use of the right-side eye as the other viewpoint picture with the H.264 AVC, and thereby obtaining separate streams, respectively. With this method, the main-viewpoint picture is compatible with the MPEG 2, i.e., it can be displayed as the 2D picture, and therefore it is possible to keep the compatibility with the existing broadcasting method of 2D program, in which the pictures encoded by the MPEG 2 are widely spreading.

As other example of the “3D 2-viewpoints separated ES transmission method” is included a method of encoding the encoded picture for use of the left-side eye as a main-viewpoint picture with the MPEG 2, while encoding the encoded picture for use of the right-side eye as the other viewpoint picture with the MPEG 2, and thereby obtaining separate streams, respectively. With this method, since the main-viewpoint picture is compatible with the MPEG 2, i.e., it can be displayed as the 2D picture, and therefore it is possible to keep the compatibility with the existing broadcasting method of 2D program, in which the pictures encoded by the MPEG 2 are widely spreading.

As further other example of the “3D 2-viewpoints separated ES transmission method” may be a method of encoding the encoded picture for use of the left-side eye as a main-viewpoint picture with the H.264 AVC or the H.264 MVC, while encoding the encoded picture for use of the right-side eye as the other viewpoint picture with the MPEG.

However, separating from the “3D 2-viewpoints separated ES transmission method”, it is also possible to transmit the 3D, by producing the stream storing the video for use of the left-side eye and the video for use of the right-side eye, alternately, even with the encoding method, such as, the MPEG 2 or the H.264 AVC (excepting MVC), which is not regulated as the multi-viewpoints video encoding method, originally or inherently.

<Program Information>

Program identification information and program arrangement information are called “program information”.

The program identification information is also called “PSI (Program Specific Information), and is compose of four (4) tables; i.e., a PAT (Program Association Table), being information necessary for selecting a desired program and for designating a packet identifier of a TS packet for transmitting a PMT (Program Map Table) relating to a broadcast program, a NIT (Network Information Table) for designating a packet identifier of a TS packet for transmitting common information among the packet identifier of the TS packet for transmitting each of encoded signals making up a broadcast program and information relating to pay broadcasting, a NIT (Network Information Table) for transmitting information of a transmission path, such as, a frequency, etc., and information to be associated with, and a CAT (Conditional Access Table) for designating the packet identifier of a packet for transmitting individual information among information relating to the pay broadcasting, and is regulated by a regulation of MPEG 2. For example, it includes the information for encoding the video, the information for encoding the audio, and the structure of the program. According to the present invention, newly, information for indicating if being the 3D video or not, etc., is included therein. That PSI is added within the management information supply portion 16.

The program arrangement information may be also called “SI (Service Information)”, and is one of various types of information, which are regulated for the purpose of convenience when selecting a program; i.e., there is also included the PSI information of the MPEG 2 system regulation, and there are an EIT (Event Information Table), on which the information relating to programs is described, such as, a program name, broadcasting time, a program content, etc., and a SDT (Service Description Table), on which the information relating to organized channels (services) is described, such as, organized channel names, broadcasting provider names, etc.

The program arrangement information may be also called “SI (Service Information)”, and is one of various types of information, which are regulated for the purpose of convenience when selecting a program; i.e., there is also included the PSI information of the MPEG 2 system regulation, and there are an EIT (Event Information Table), on which the information relating to programs is described, such as, a program name, broadcasting time, a program content, etc., and a SDT (Service Description Table), on which the information relating to organized channels (services) is described, such as, organized channel names, broadcasting provider names, etc.

For example, it includes the structure, the format of service, or information indicating the structure information of the programs for one (1) week, etc., of the program broadcasted at present and/or the program to be broadcasted next, and is added within the management information supply portion 16.

As a way of using the tables PMT or EIT, respectively, for example, with the PMT, since it describes only the information of the program being broadcasted at present, therefore it is impossible to confirm the information of the program(s), which will be broadcasted in the future. However, since the time-period until completion of receiving is short because a short transmission frequency from the transmitting side, and since it is the information of the program being broadcasted at the present, it has a characteristic of being high in reliability thereof, in a sense that no change is made. On the other hand, with the EIT [schedule basic/schedule extended], it can obtain the information of programs up to seven (7) days in the future, other than that of the program being broadcasted at the present, it has the following demerits; i.e., the time-period until the completion of receiving is long because of a long transmission frequency from the transmitting comparing to that of PMT, needing much more memory regions for holding, and further being low in the sense of reliability in a sense of having a possibility of being changed because of being phenomena in the future. With EIT [following], it can obtain the information of the program of a next broadcasting to time.

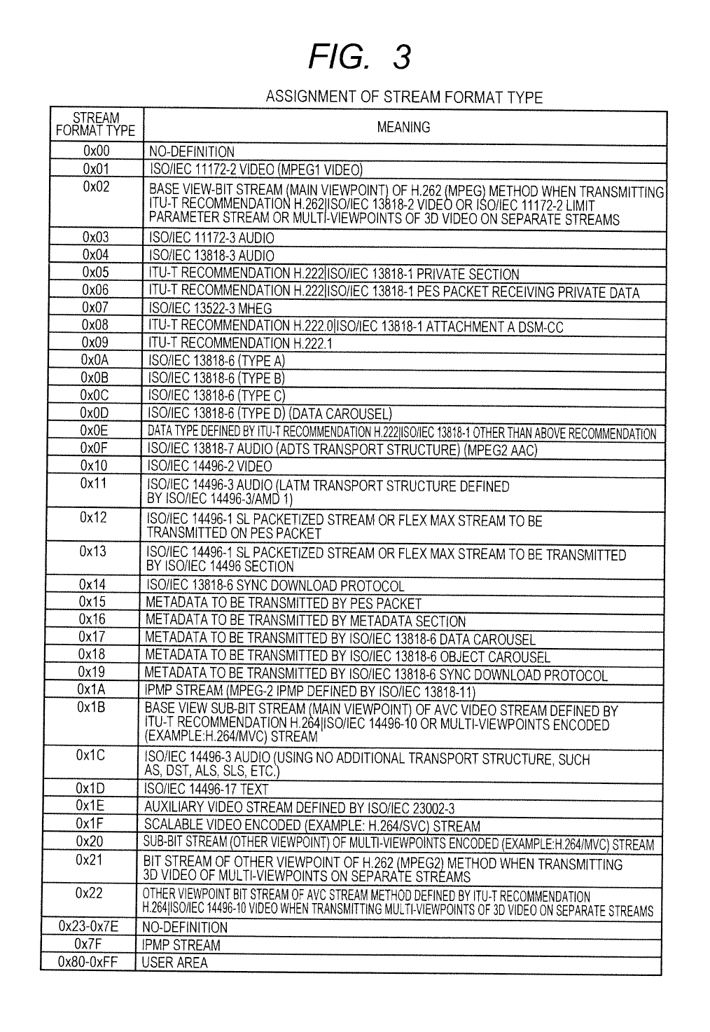

The PMT of the program identification information is able to show a format of ES of the program being broadcasted, with using the table structure, which is regulated in ISO/IEC 13818-1, e.g., by means of “stream_type (a type of stream format)”, being information of eight (8) bits, which is described in a 2^{nd} loop (e.g., a loop for each ES (Elementary Stream)) thereof. In the embodiment of the present invention, a number of formats of the ES more than that of the conventional one, for example, the formats of ES of the program to be broadcasted are assigned as is shown in FIG. 3.

First of all, with a base-view sub-bit stream (a main-viewpoint) of a multi-viewpoints video encoded (for example, H.264/MVC) stream, “0x1B” is assigned to, being same to that of the AVC video stream, which is regulated in the existing ITU-T recommendation H.264|ISO/IEC 14496-10 video. Next, to “0x20” is assigned a sub-bit stream (other viewpoint) of the multi-viewpoints video encoded stream (for example, the H.264 MVC), which can be applied into the 3D video program.

Also, with the base-view bit stream (e.g., the main-viewpoint) of the H.264 (MPEG 2) when being applied in the “3D 2 viewpoints separate ES transmission method”, with which plural numbers of viewpoints of 3D video are transmitted by streams separated, “0x02” is assigned to, being same to that of the existing ITU-T recommendation H.262ISO/IEC 13818-2 video. Herein, the base-view bit stream of the H.262 (MPEG 2), when transmitting the plural numbers of viewpoints of the 3D video by the streams separated, is a steam, only video of the main-viewpoint thereof being encoded with the H.262 (MPEG 2) method, among the videos of plural numbers of viewpoints of 3D videos.

Further, to “0x21” is assigned a bit stream of other viewpoint of the H.262 (MPEG 2) to be applied when transmitting the plural numbers of viewpoints of 3D video by the separated streams.

Further, to “0x22” is assigned a bit stream of other viewpoint bit stream of AVC stream method, which is regulated in the ITU-T recommendation H.264|ISO/IEC 14496-10 video to be applied when transmitting the plural numbers of viewpoints of 3D video by the separated streams.

However, in the explanation given herein, although it is mentioned that the sub-bit stream of the multi-viewpoints video encoded stream, which can be applied into the 3D video program, is assigned to “0x20”, that the bit stream of the other viewpoint of the H.262 (MPEG 2), to be applied when transmitting the plural numbers of viewpoints of 3D video by the separated streams, is assigned to “0x21”, and that the AVC stream regulated in the ITU-T recommendation H.264|ISO/IEC 14496-10 video, to be applied when transmitting the plural numbers of viewpoints of 3D video by the separated streams, is assigned to “0x22”; but each may be assigned to any one of “0x23” through “0x7E”. Also, the MVC video stream is only the example, but it may be a video stream other than the H.264/MVC, as far as it indicates the multi-viewpoints video encoded stream, which can be applied into the 3D video program.

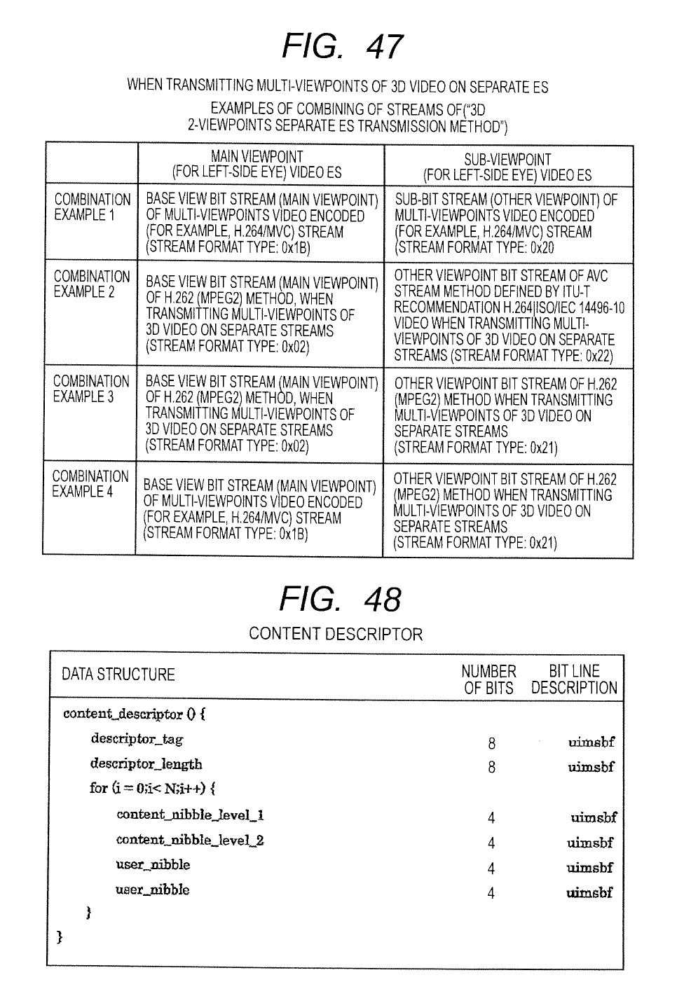

As was mentioned above, by assigning the bit of “stream_type (a type of stream format)”, according to the embodiment of the present invention, it is possible to make transmission with a combination of the streams as is shown in FIG. 47, for example, when the broadcasting provider on the side of the transmitting apparatus 1.

In an example 1 of the combination, as the main-viewpoint (for use of the left-side eye) video stream, the base-view sub-bit stream (the main-viewpoint (the type of stream format: “0x1B”) of the multi-viewpoints video encoded (for example; H.264/MVC) stream is transmitted, while as a sub-viewpoint (for use of the right-side eye), the sub-bit stream (the type of stream format: “0x20”) for use of other viewpoint of the multi-viewpoints video encoded (for example; H.264/MVC) stream is transmitted.

In this instance, both the main-viewpoint (for use of the left-side eye) and the sub-viewpoint (for use of the right side eye) are applied with the stream of the multi-viewpoints video encoded (for example; H.264/MVC) method. The multi-viewpoints video encoded (for example; H.264/MVC) method is basically a method for transmitting the multi-viewpoints video, and is able to transmit the 3D program with high efficiency, among those combinations shown in FIG. 47.

Also, when displaying (or outputting) a 3D program in 3D, the receiving apparatus is able to process both the main-viewpoint (for use of the left-side eye) video stream and the sub-viewpoint (for use of the right-side eye) video stream, and thereby to reproduce the 3D program.

When displaying (or outputting), the receiving apparatus is able to display (or output) the 3D program as the 2D program, if processing only the main-viewpoint (for use of the left-side eye) video stream.

Further, since there is compatibility between the base-view sub-bit stream of the multi-viewpoints video encoding method, H.264/MVC, and the existing video stream of H.264/AVC (excepting MVC), by assigning both of the stream format types to the same “0x1B”, there can be obtained the following effects. Namely, it is an effect of recognizing the main-viewpoint (for use of the left-side eye) video stream of that program as a stream being same to the video stream of the existing H.264/AVC (excepting MVC), and thereby enabling to display (or output) that as an ordinary 2D program, upon basis of the type of the stream format, even if the receiving apparatus, having no function of displaying (or outputting) the 3D program in 3D, receives the 3D program of the example 1 of combination, if there is provided a function of to displaying (or outputting) the video stream (the AVC video stream, which is regulated by the ITU-T recommendation H.264|ISO/IEC 14496-10 video) of the existing H.264/AVC (excepting MVC) within the receiving apparatus.

Furthermore, since the sub-viewpoint (for use of the right-side eye) is assigned with a type of stream format, which cannot be found, conventionally, then it is neglected in the existing receiving apparatus. With this, it is possible to prevent the sub-viewpoint (for use of the right-side eye) video stream from being displayed (or outputted), in a manner, which the broadcasting station side does not intend, on the existing receiving apparatus.

Therefore, if the broadcasting of 3D program of the combination example 1 is started, newly, it is possible to avoid such a situation that it cannot be displayed on the existing receiving apparatus having the function of displaying (or outputting) the video stream of the existing H.264/AVC (excepting MVC). With this, if the broadcasting of that 3D program is started, newly, by the broadcasting or the like, which is managed by an income of advertisement, such as, CM (commercial message), etc., since it can be viewed/listened even on the receiving apparatus not cope with the 3D displaying (or outputting) function, and therefore, it is possible to avoid lowering of an audience rate by such restriction of the function in the receiving apparatus, i.e., also being meritorious on the side of the broadcasting station.

With an example 2 of combination, as the main-viewpoint (for use of the left-side eye) video stream is transmitted the base-view bit stream (the main-viewpoint) (the stream format type: “0x02”) of the H.262 (MPEG 2), to be applied when transmitting plural numbers of the viewpoints of 3D video by the separated streams, while as the sub-viewpoint (for use of the right-side eye) video stream is transmitted the AVC stream (the stream format type: “0x22”), which is regulated by the ITU-T recommendation H.264|ISO/IEC 14496-10 video to be applied when transmitting plural numbers of the viewpoints of 3D video by the separated streams.

In the similar manner to the combination example 1, when displaying (or outputting) the 3D program in 3D, the receiving apparatus is able to reproduce the 3D program, by processing both the main-viewpoint (for use of the left-side eye) video stream and the sub-viewpoint (for use of the right-side eye) video stream, and also when displaying (or outputting) the 3D program in 2D, the receiving apparatus is able to display (or output) it as the 2D program if processing only the main-viewpoint (for use of the left-side eye) video stream.

Further, by bringing the base-view bit stream (the main-viewpoint) of the H.262 (MPEG 2), to be applied when transmitting plural numbers of the viewpoints of 3D video by the separated streams, into a stream having compatibly with the existing ITU-T recommendation H.262|ISO/IEC 13818-2 video stream, and assigning both the stream format types to the same “0x1B”, as is shown in FIG. 3, it is possible for the receiving apparatus, but as far as it has a function of displaying (or outputting) the existing ITU-T recommendation H.262|ISO/IEC 13818-2 video stream, to display (or output) it as the 2D program, even if the receiving apparatus has no 3D displaying (or outputting) function.

Also, in the similar manner to the combination example 1, since the sub-viewpoint (for use of the right-side eye) is assigned with a type of stream format, which cannot be found, conventionally, then it is neglected in the existing receiving apparatus. With this, it is possible to prevent the sub-viewpoint (for use of the right-side eye) video stream from being displayed (or outputted), in a manner, which the broadcasting station side does not intend, on the existing receiving apparatus.

Since the receiving apparatus having the displaying (or outputting) function regarding the existing ITU-T recommendation H.262|ISO/IEC 13818-2 video stream is spread, widely, it is possible to prevent the audience rate from being lowered due to the limitation of the receiving apparatus, and therefore the most preferable broadcasting for the broadcasting station can be achieved.

Further, modifying the sub-viewpoint (for use of the right-side eye) into the AVC stream (the stream format type: “0x22”), which is regulated by the ITU-T recommendation H.264|ISO/IEC 14496-10 video, enables transmission of the sub-viewpoint (for use of the right-side eye) at a high compression rate.

Thus, according to the combination example 2, it is possible to achieve both the commercial merit for the broadcasting station and the technical merit due to the transmission of high efficiency.

With the combination example 3, as the main-viewpoint (for use of the left-side eye) video stream is transmitted the base-view stream (the main-viewpoint) (the stream format type: “0x02”) of the H.262 (MPEG 2) to be applied when transmitting the plural numbers of viewpoints of 3D video by the separate streams, while as the sub-viewpoint (for use of the right-side eye) video stream is transmitted the bit stream (the stream format type: “0x21”) of other viewpoint of the H.262 (MPEG2) to be applied when transmitting the plural numbers of viewpoints of 3D video by the separate streams.

In this case, similar to the combination example 3, it is possible for the receiving apparatus, but as far as it has a function of displaying (or outputting) the existing ITU-T recommendation H.262|ISO/IEC 13818-2 video stream, to display (or output) it as the 2D program, even if the receiving apparatus has no 3D displaying (or outputting) function.

In addition to the commercial merit for the broadcasting station, i.e., preventing the audience rate from being lowered due to the restriction of functions of the receiving apparatus, it is also possible to simplify the hardware structure of a video decoding function within the receiving apparatus, by unifying the encoding methods of the main-viewpoint (for use of the left-side eye) video stream and the sub-viewpoint (for use of the right-side eye) video stream into the H.262 (MPEG 2).

However, as the combination example 4, it is also possible to transmit the base-view stream (the main-view) (the stream format type: “0x1B”) of the multi-viewpoints video encoded (for example: H.264/MVC) stream, as the main-viewpoint (for the left-side eye) video stream, while transmitting the bit stream of other viewpoint (the stream format type: “0x21”) of the H.262 (MPEG 2) method to be applied when transmitting the plural numbers of viewpoints of 3D video by the separate streams, as the sub-viewpoint (for use of the right-side eye).

However, in the combination shown in FIG. 47, the similar effect can be obtained if applying the AVC video stream (the stream format type: “0x1B”), which is regulated by the ITU-T recommendation H.264|ISO/IEC 14496-10 video, in the place of the base-view bit stream (the main-viewpoint) (the stream format type: “0x1B”) of the multi-viewpoints video encoded (for example: H.264/MVC) stream.

Also, in the combination shown in FIG. 47, the similar effect can be obtained if applying the ITU-T recommendation H.262|ISO/IEC 13818-2 video stream (the stream format type: “0x1B”), in the place of the base-view bit stream (the main-viewpoint) of the H.262 (MPEG 2) method to be applied when transmitting the plural numbers of viewpoints of 3D video by the separate streams.

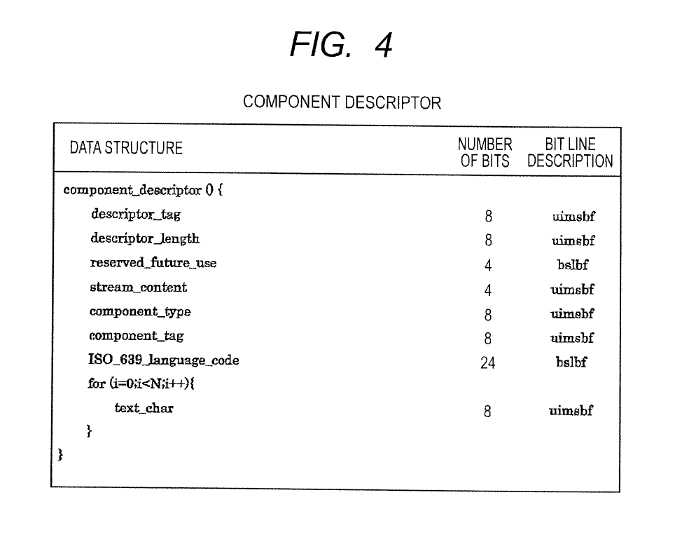

FIG. 4 shows an example of the structure of a component descriptor, as one of the program information. The component descriptor indicates a type of the component (an element building up the program. For example, video, audio, characters or letters, various kinds of data, etc.), and is also used for presenting the elementary stream by a letter format. This descriptor is disposed in PMT and/or EIT.

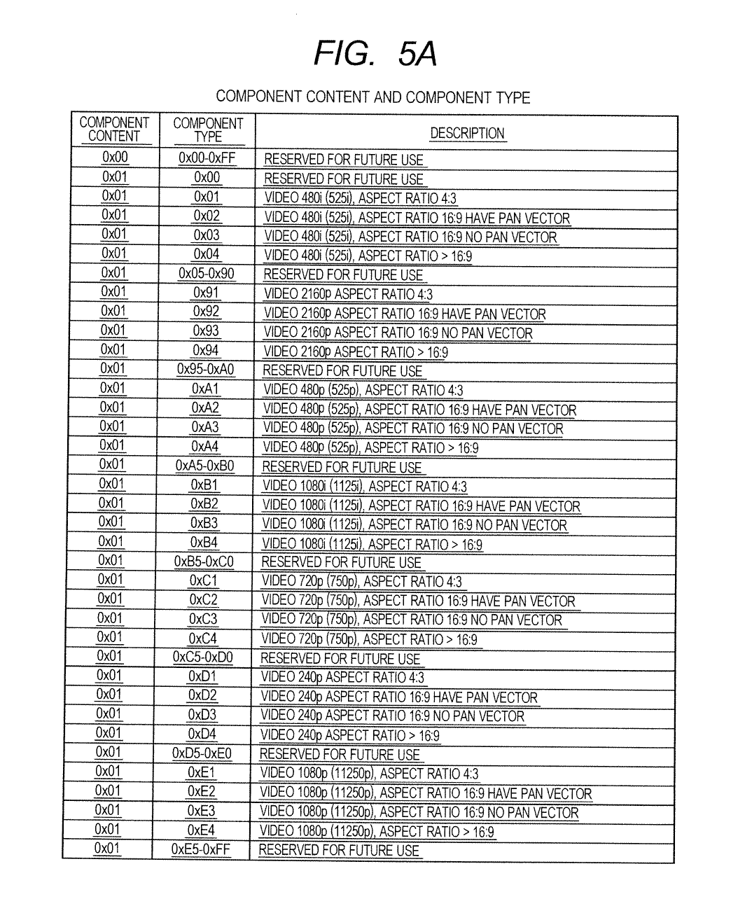

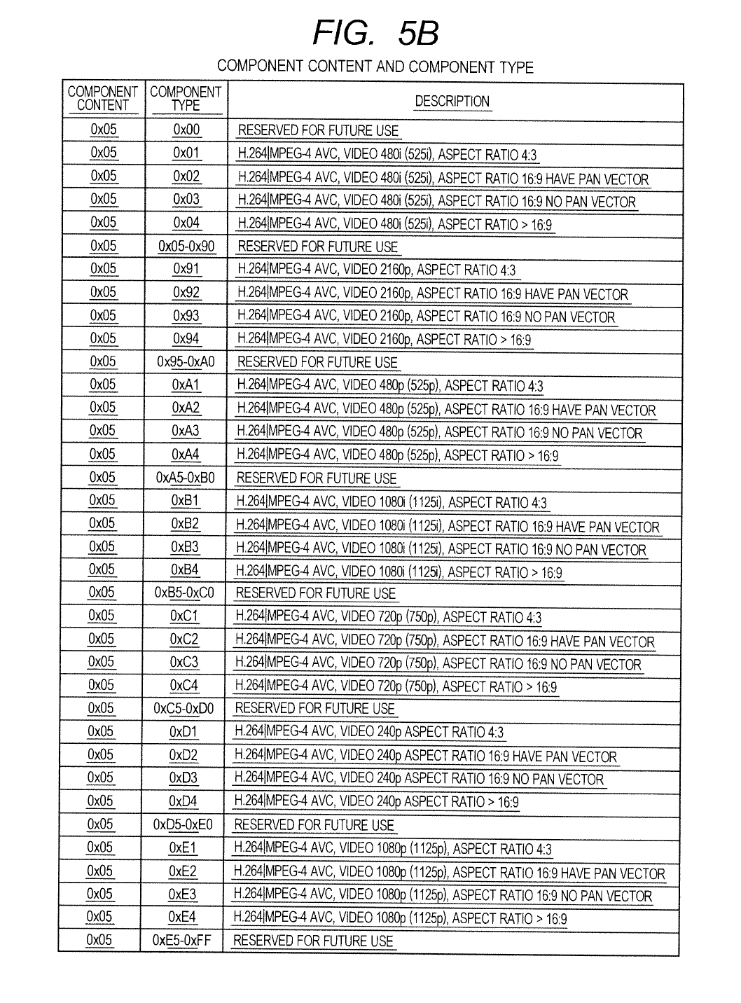

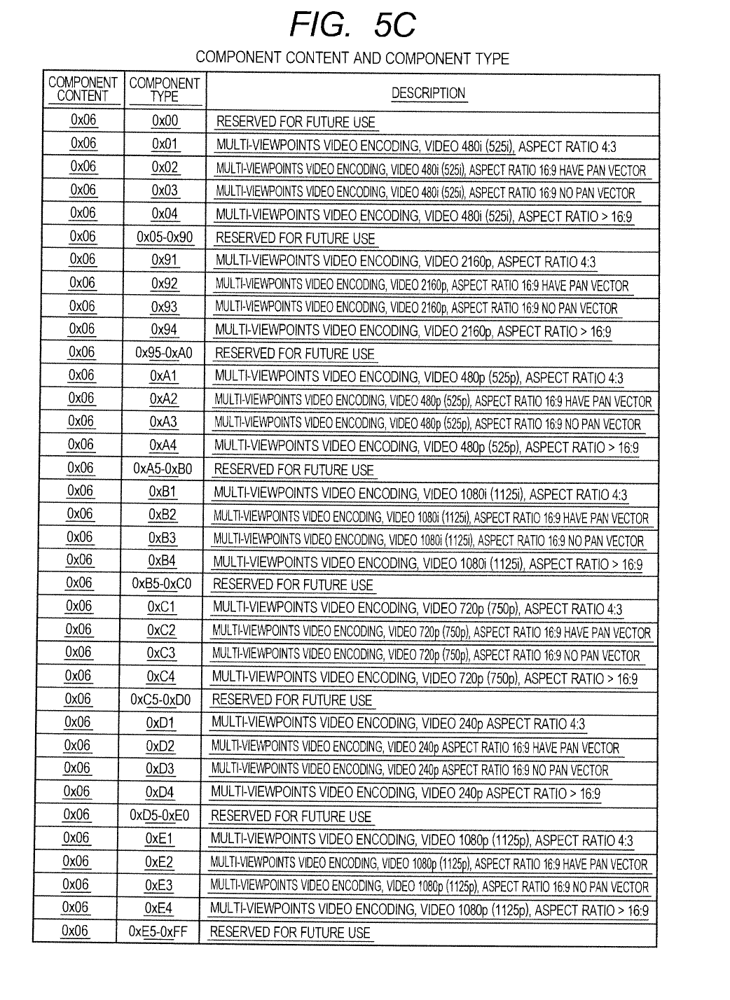

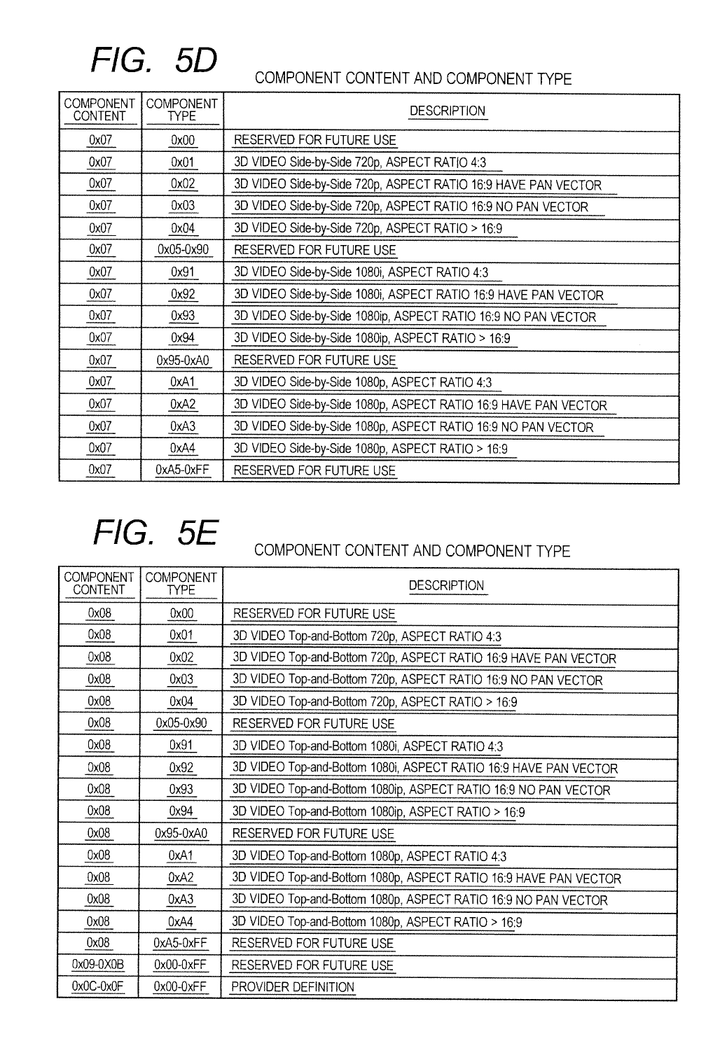

Meanings of the component descriptor are as follows. Thus, “descriptor_tag” is a field of 8 bits, into which is described such a value that this descriptor can be identified as the component descriptor. “descriptor_length” is a field of 8 bits, into which is described a size of this descriptor. “stream_component” (content of the component) is a field of 4 bits, presenting the type of the stream (e.g., video, audio and data), and is encoded in accordance with FIG. 4. “component_type” is a field of 8 bits, defining the type of the component, such as, video, audio and data, for example, and is encoded in accordance with FIG. 4. “component_tag” is a field of 8 bits. A component stream of service can be referred by means of this field of 8 bits, i.e., the described contents (FIG. 5) thereof, which are indicated by the component descriptor.

In program session, the value of the component tag, to be given to each of the components, should be different from one other. The component tag is a label for identifying the component stream, and has the same value to that of the component tag within a stream identification descriptor (but, only when the stream deification descriptor exists within PMT). A field of 24 bits of “ISO_{—}639_languate_code” (a language code) identifies the language of the component (audio or data) and the language of description of letters, which are included in this descriptor.

The language code is presented by a code of 3 alphabetical letters regulated in ISO 639-2 (22). Each letter is encoded in accordance with ISO 8859-1 (24), and is inserted into a field of 24 bits in that order. For example, Japanese language is “jpn” by the code of alphabetical 3 letters, and is encoded as follows. “0110 1010 0111 0000 0110 1110” “text_char” (component description) is a field of 8 bits. A field of a series of component descriptions regulates the description of letters of the component stream.

FIGS. 5A to 5E show example of “stream_contnet” (content of the component) and “component_type” (type of the component), being the constituent elements of the component descriptor. “0x01” of content of the component shown in FIG. 5A tells about various video formats of the video stream, being compressed in accordance with an MPEG 2 format.

“0x05” of the component content shown in FIG. 5B tells about various video formats of the video stream, being compressed in a H.264 AVC format. “0x06” of the component content shown in FIG. 5C tells about various video formats of the video stream, being compressed by the multi-viewpoints video encoding (for example, a H.264 MVC format).

“0x07” of the component content shown in FIG. 5D tells about various video formats of the stream of a “Side-by-Side” format of 3D video, being compressed in the format of MPEG 2 or H.264 AVC. In this example, although the same value is shown for the component contents in the MPEG 2 format and the H.264 AVC format, but different values may be set for the MPEG 2 and the H.264 AVC, respectively.

“0x08” of the component content shown in FIG. 5E tells about various video formats of a “Top-and Bottom” format of 3D video, being compressed in the format of MPEG 2 or H.264 AVC. In this example, although the same value is shown for the component contents in the MPEG 2 format and the H.264 AVC format, but different values may be set for the MPEG 2 and the H.264 AVC, respectively.

As is shown in FIG. 5D or FIG. 5E, with adopting the structure for indicating a combination of if being the 3D video or not, the method of 3D video, a resolution, and an aspect ratio, depending on the combination of “stream_content” (content of the component) and “component_type” (the component type), both being the constituent elements of the component descriptor, it is possible to transmit the information of various kinds of methods of the videos, including an identification of the 2D program or the 3D program, with a less volume of transmission, even if a combined broadcasting of 3D and 2D.

When transmitting a 3D video program, including the pictures of plural numbers of viewpoints within one (1) piece of picture of the “Side-by-Side” format or the “Top-and-Bottom” format, with using an encoding method, such as, the MPEG 2 or the H.264 AVC (except MVC), etc., which is not regulated as the multi-viewpoints video encoding method, originally, it is difficult to identify or discriminate if transmission is done, including pictures of plural numbers of viewpoints within one (1) picture for use of the 3D video program, or an ordinary picture of one (1) viewpoint, only with the “stream_type” (type of the stream format). Therefore, in this case, it is enough to execute the identification or discrimination on various kinds of video methods, including the identification of if that program is the 2D program or the 3D program, depending on the combination of the “stream_content” (content of the component) and the “component_type” (the component type). Or, due to distribution of the component descriptor relating to the program(s), which is/are broadcasted at present or will be broadcasted in future, by means of the EIT, it is possible to produce an EPG (a program table) within the receiving apparatus, by obtaining the EIT therein, and to produce if being the 3D video or not, the method of the 3D video, the resolution, and the aspect ratio, as information of the EPG. The receiving apparatus has a merit that it can display (or output) those information on the EPG.

As was explained in the above, since the receiving apparatus observes the “stream_content” and the “component_type”, therefore there can be obtained an effect of enabling to recognize that the program is the 3D program, which is received at present or will be received in future.

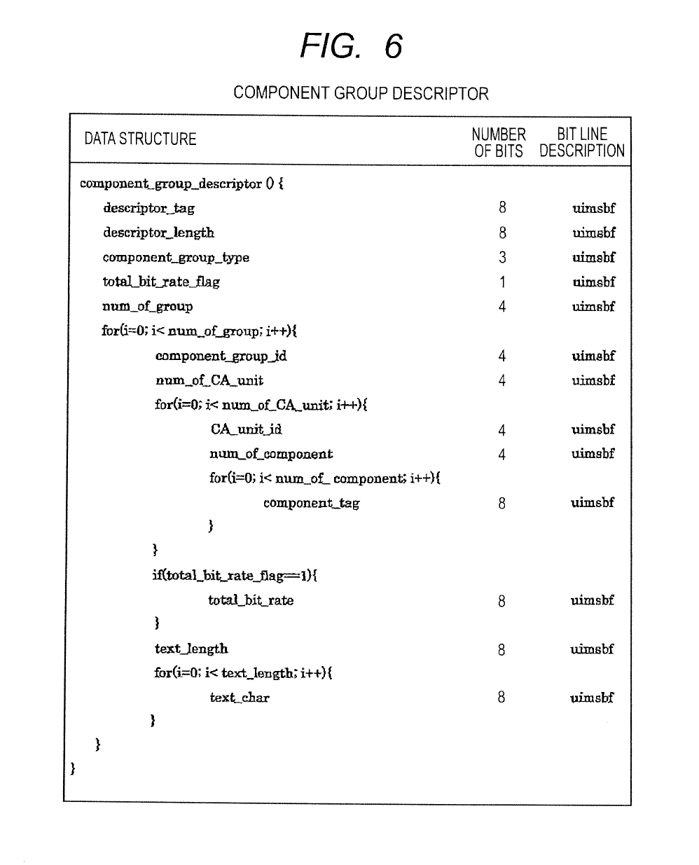

FIG. 6 shows an example of the structure of the component group descriptor, being one of the program information. The component group descriptor defines the combination of components within an event, and thereby identifying. In other words, it describes grouping information for plural numbers of the components. This descriptor is disposed in the EIT.

Meaning of the component group descriptor is as follows. Thus, “descriptor_tag” is a field of 8 bits, into which is described such a value that this descriptor can be identified as the component group descriptor. “descriptor_length” is a field of 8 bits, in which the size of this descriptor is described. “component_group_type” (type of the component group) is a field of 3 bits, and this presents the type of the group of components.

Herein, “001” presents a 3D TV service, and is distinguished from a multi-view TV service of “000”. Herein, the multi-view TV service a TV service for enabling to display the 2D video of multi-viewpoints by exchanging it for each viewpoint, respectively. There is a probability that, for example, it will be used, not only in the 3D video program in case where the transmission is made including the plural numbers of viewpoints into one (1) screen, in the multi-viewpoints video encoded video stream or the stream of an encoding method, which is not regulated as the multi-viewpoints video encoding method, originally, but also in the multi-view TV program. In this case, if the video of the multi-viewpoints in the stream, there may be also a possibility that identification cannot be made on if being the multi-view TV or not, only by the “stream_type” (type of the stream format) mentioned above. In such case, “component_group_type” (type of the component group) is effective. “total_bit_rate_flag” (flag of total bit rate) is a flag of 1 bit, and indicates a condition of description of the total bit rate within the component group among an event. When this bit is “0”, it indicates there is no total rate field within the component group in that descriptor. When this bit is “1”, it indicates that there is a total rate field within the component group in that descriptor. “num_of_group” (number of groups) is a field of 4 bits, and indicates a number of the component groups within the event.

“component_group_id” (identification of the component group) is a field of 4 bits, into which the identification of the component group is described, in accordance with FIG. 8. “num_of_CA_unit” (number of units of charging) is a field of 4 bits, and indicates a number of unit(s) of charging/non-charging within the component groups. “CA_unit_id” (identification of a unit of charging) is a field of 4 bits, into which the identification of a unit of charging is described, in accordance with FIG. 9.

“num_of_component” (number of components) is a field of 4 bits, and it belongs to that component group, and also indicates a number of components belonging to the unit of charging/non-charging, which is indicated by “CA_unit_id” just before. “component_tag” (component tag) is afield of 8 bits, and indicates a number of the component tag belonging to the component group.

“total_bit_rate” (total bit rate) is a field of 8 bits, into which a total bit rate of the components within the component group, while rounding the transmission rate of a transport stream packet by each ¼ Mbps. “text_length” (length of description of the component group) is a field of 8 bits, and indicates byte length of component group description following thereto. “text_char” (component group description) is a field of 8 bits. A series of the letter information fields describes an explanation in relation to the component group.

As was mentioned above, due to observation of the “component_group_type” by the receiving apparatus 4, there can be obtained an effect of enabling to identify a program, which is broadcasted at present or will be broadcasted in future, is the 3D program.

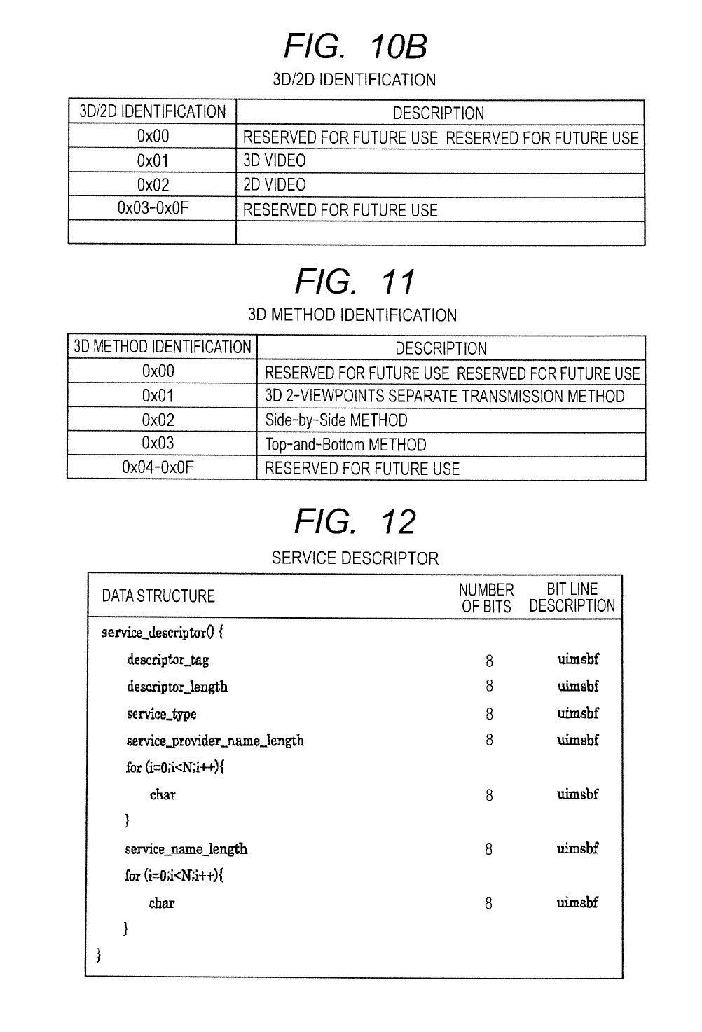

Next, explanation will be given on an example of applying a new descriptor, for showing the information in relation to the 3D program. FIG. 10A shows an example of the structure of a 3D program details descriptor, being one of the program information. The 3D program details descriptor shows detailed information in case where the program is the 3D program, and may be used for determining the 3D program within the receiving apparatus. This descriptor is disposed in the PMT and/or the EIT. The 3D program details descriptor may coexist together with the “stream_content” (content of the component) and the “component_type” (type of the component) for use of the 3D video program, which are shown in FIGS. 5C through 5E. However, if transmitting the 3D program details descriptor, there may be applied the structure of transmitting no “stream_content” (content of the component) nor “component_type” (type of the component). Meanings of the 3D program details descriptor are as follows. Next, “descriptor_tag” is a field of 8 bits, into which is described such a value (for example, “0xE1”) that this descriptor can be identified to be the 3D program details descriptor. “descriptor_length” is a field of 8 bits, into which is described the size of this descriptor.

“3d_{—}2d_type” (type of 3D/2D) is a field of 8 bits, and indicates a type of 3D video or 2D video within the 3D program, in accordance with FIG. 10E. This field is information for identifying of being the 3D video or the 2D video, in a 3D program being structured in such a manner that, for example, a main program is the 3D video, but a commercial advertisement, etc., to be inserted on the way thereof, is the 2D video, and is arranged for the purpose of protecting the receiving apparatus from an erroneous operation thereof (e.g., a problem of display (or output), being generated due to the fact that the broadcasted program is the 2D video in spite of 3D processing executed by the receiving apparatus). “0x01” indicates the 3D video, while “0x02” the 2D video, respectively.

“3d_method_type” (type of the 3D method) is a field of 8 bits, and indicates the type of the 3D method, in accordance with FIG. 11. “0x01” indicates the “3D 2-viewpoints separated ES transmission method”, “0x02” indicates the “Side-by-Side method”, and “0x03” indicates the “Top-and-Bottom method”, respectively. “stream_type” (type of the stream format) is a field of 8 bits, and indicates the type of ES of the program, in accordance with FIG. 3. However, it may be also possible to apply such structure that the 3D program details descriptor is transmitted only in case of the 3D video program, but not during the 2D video program. Thus, it is possible to identify if that program is the 2D video program or the 3D video program, only depending on presence/absence of the transmission of the 3D program details descriptor in relation to the program received.

“component_tag” (component tag) is a field of 8 bits. A component stream for the service can refer to the described content (in FIG. 5), which is indicated by the component descriptor, by means of this field of 8 bits. In program session, values of the component tags, being given to each stream, should be determined to be different from each other. The component tag is a label for identifying the component stream, and has the value same to that of the component tag(s) within a stream identification descriptor (however, only in a case where the stream identification descriptor exists within the PTM).

As was mentioned above, due to observation of the 3D program details descriptor by the receiving apparatus 4, there can be obtained an effect of enabling to identify that the program, which is received at present or will be received in future, is the 3D program, if this descriptor exists. In addition thereto, it is also possible to identify the type of the 3D transmission method, if the program is the 3D program, and if the 3D video and the 2D video exists, being mixed up with, to identify that fact.

Next, explanation will be given on an example of identifying the video of being the 3D video or the 2D video, by a unit of a service (e.g., a programmed channel). FIG. 12 shows an example of the structure of a service descriptor, being one of the program information. The service descriptor presents a name of the programmed channel and a name of the provider, by the letters/marks, together with the type of the service formats thereof. This descriptor is disposed in the SDT.

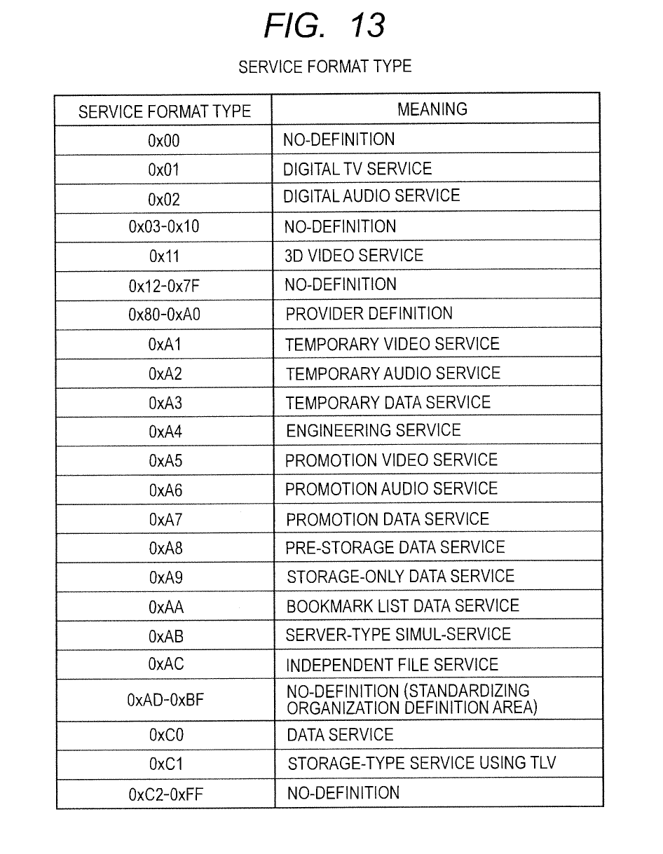

Meanings of the service descriptor are as follows. Namely, “service_type” (type of the service format) is a field of 8 bits, and indicates a type of the service in accordance with FIG. 13. “0x01” presents the 3D video service. A field of “service_provider_name_length” (name of the provider) of 8 bits presents byte length of the provider's name following thereto. “char” (letters/marks) is a field of 8 bits. A series of letter information fields presents the provider's name or the service name. “service_name_length” (length of the service name) is a field of 8 bits, and presents byte length of the service name following thereto.

As was mentioned above, due to observation of the “service_type” by the receiving apparatus 4, there can be obtained an effect of enabling to identify the service (e.g., the programmed channel) to be a channel of the 3D program. In this manner, if possible to identify the service (e.g., the programmed channel) to be a channel of the 3D program, it is possible to display a notice that the service is a 3D video program broadcasting service, etc., for example, through an EPG display, etc. However, in spite of the service of mainly broadcasting the 3D video program, there may be a case that it must broadcast the 2D video, such as, in case where a source of an advertisement video is only the 2D video, etc. Therefore, for identifying the 3D video service by means of the “service_type” (type of the service format) of that descriptor, it is preferable to apply the identification of the 3D video program by combining the “stream_component” (content of the component) and the “component_type” (type of the component), the identification of the 3D video program by means of the “component_group_type” (type of the component group), or the identification of the 3D video program by means of the 3D program details descriptor, which are already explained previously, in common therewith. When identifying by combining plural numbers of information, it is possible to make such identification that, the program is the 3D video broadcasting service, but a part thereof is the 2D video, etc. In case where such identification can be made, for the receiving apparatus, it is possible to expressly indicate that the service is the “3D video broadcasting service”, for example, on the EPG, and also to exchange display controlling, etc., between the 3D video program and the 2D video program, when receiving the program and so on, even if the 2D video program is mixed into that service, other than the 3D video program.

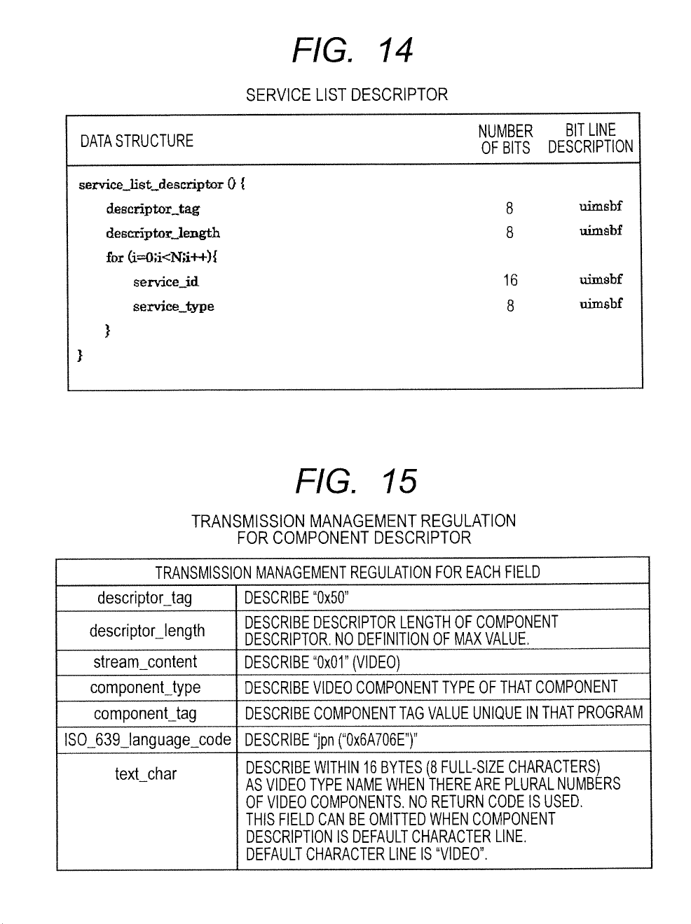

FIG. 14 shows an example of the structure of a service list descriptor, being one of the program information. The service list descriptor provides service a list of services, upon basis of service identification and service format type. Thus, it describes therein a list of the programmed channels and the types of them. This descriptor is disposed in the NIT.

Meanings of the service list descriptor are as follows. Namely, “service_id” (identification of the service) is a field of 16 bits, and identifies an information service within that transport stream, uniquely. The service identification is equal or equivalent to the identification of broadcast program numbers within a corresponding program map session. “service_type” (type of the service format) is a field of 8 bits, and presents the type of the service, in accordance with FIG. 12.

With such “service_type” (type of the service format), since it is possible to identify if the service is the “3D video broadcasting service” or not, therefore, for example, it is possible to conduct the display for grouping only the “3D video broadcasting service” on the EPG display, etc., with using the list of the programmed channels and the types thereof, which are shown in that service list descriptor.

As was mentioned above, due to observation of the “service_type” by the receiving apparatus 4, there can be obtained an effect of enabling to identify a program, if the channel is that of the 3D program or not.

In the examples explained in the above, description was made only the representative members, but there can be considered the followings: i.e., to have a member(s) other than those, to combine plural numbers of the members into one, and to divide one (1) member into plural numbers of members, each having detailed information thereof.

<Example of Transmission Management Regulation of Program Information>

The component descriptor, the component group descriptor, the 3D program details descriptor, the service descriptor, and the service list descriptor of the program information, which are explained in the above, are the information, to be produced and added in the management information supply portion 16, for example, and stored in PSI (for example, the PMT, etc.) or in SI (for example, the EIT, SDT or NIT, etc.) of MPEG-TS, and thereby to be transmitted from the transmitting apparatus 1.

Hereinafter, explanation will be given on an example of management regulation for transmitting the program information within the transmitting apparatus 1.

FIG. 15 shows an example of the transmission management regulation of the component descriptors within the transmitting apparatus 1. In “descriptor_tag” is described “0x50”, which means the component descriptor. In “descriptor_length” is described the descriptor length of the component descriptor. The maximum value of the descriptor length is not regulated. In “stream_component” is described “0x01” (video).

In “component_type” is described the video component type of that component. With the component type, it is determined from among those shown in FIG. 5. In “component_tag” is described such a value of the component tag to be unique in said program. In “ISO_{—}639_language_code” is described “jpn (“0x6A706E”)”.

In “text_char” is described characters less than 16 bytes (or, 8 full-size characters) as a name of the video type when there are plural numbers of video components. No line feed code can be used. This field can be omitted when the component description is made by a letter (or character) string of default.

However, it must be transmitted by only one (1) thereof, necessarily, to all the video components, each having the “component_tag” values of “0x00” to “0x0F”, which are included in an event (e.g., the program).

With such transmission management within the transmitting apparatus 1, the receiving apparatus 4 can observe the “stream_component” and the “component_type”, and therefore there can be obtained an effect of enabling recognition that the program, which is received at present or will be received in future, is the 3D program.

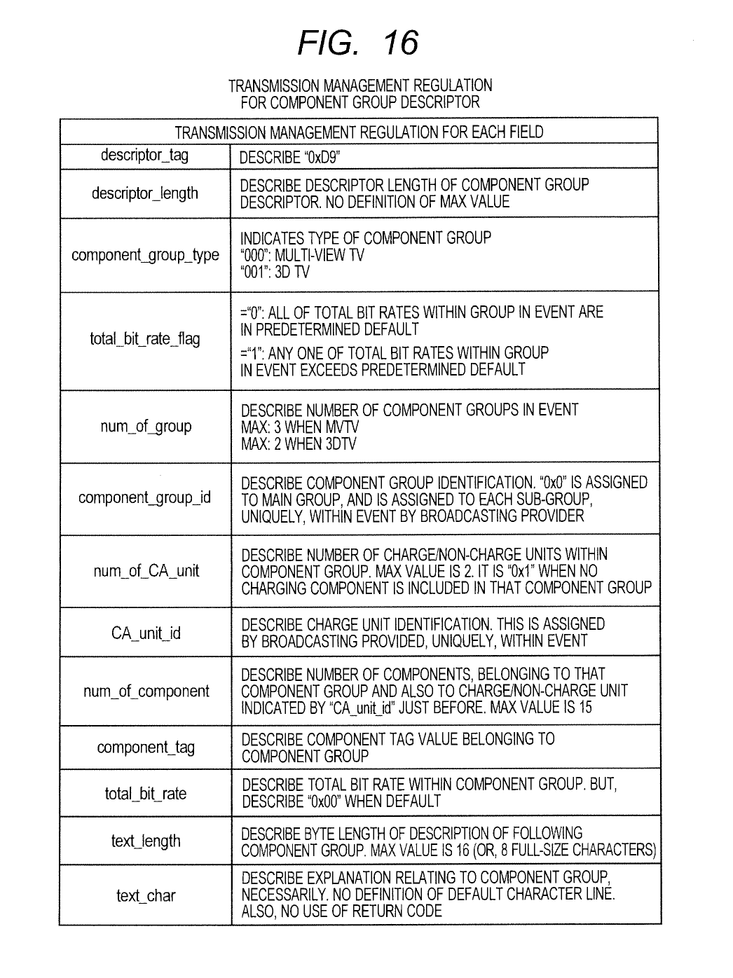

FIG. 16 shows an example of the transmission process of the component group within the transmitting apparatus 1.

In “descriptor_tag” is described “0xD9”, which means the component group descriptor. In “descriptor_length” is described the descriptor length of the component group descriptor. No regulation is made on the maximum value of the descriptor length. “000” indicates a multi-view TV and “001” a 3D TV, respectively.

“total_bit_rate_flag” indicates “0” when all of the total bit rates within a group in an event are at the default value, which is regulated, or “1” when any one of the total bit rates within a group in an event is exceeds the regulated default value.

In “num_of_group” is described a number of the component group(s) in an event. In case of the multi-view TV (MVTV), it is assumed to be three (3) at the maximum, while two (2) at the maximum in case of the 3D TV (3DTV).

In “component_group_id” is described an identification of the component group. “0x0” is assigned when it is a main group, and in case of each sub-group, IDs are assigned in such a manner that broadcasting providers can be identified, uniquely.

In “num_of_CA_unit” is described a number of unit(s) of charging/non-charging within the component group. It is assumed that the maximum value is two (2). It is “0x1” when no charging component is included within that component group, completely.

In “CA_unit_id” is described an identification of unit of charging. Assignment is made in such a manner that broadcasting providers can be identified, uniquely. “num_of_component” belongs to that component group, and also it describes a number of the components belonging to the charging/non-charging unit, which are included in “CA_unit_id” just before. It is assumed that the maximum value is fifteen (15).

In “component_tag” is described a component tag value, which belongs to the component group. In “total_bit_rate” is described a total bit rate within the component group. However, “0x00” is described therein, when it is the default value.

In “text_length” is described a byte length of description of a component group following thereto. It is assumed that the maximum value is 16 (or, 8 full-size characters). In “text_char” must be described an explanation, necessarily, in relation to the component group. No regulation is made on a default letter (or character) string.

However, when executing the multi-view TV service, transmission must be made after turning the “component_group_type” into “000”, necessarily.

With such transmission management within the transmitting apparatus 1, the receiving apparatus 4 can observe the “component_group_type”, and therefore there can be obtained an effect of enabling recognition that the program, which is received at present or will be received in future, is the 3D program.

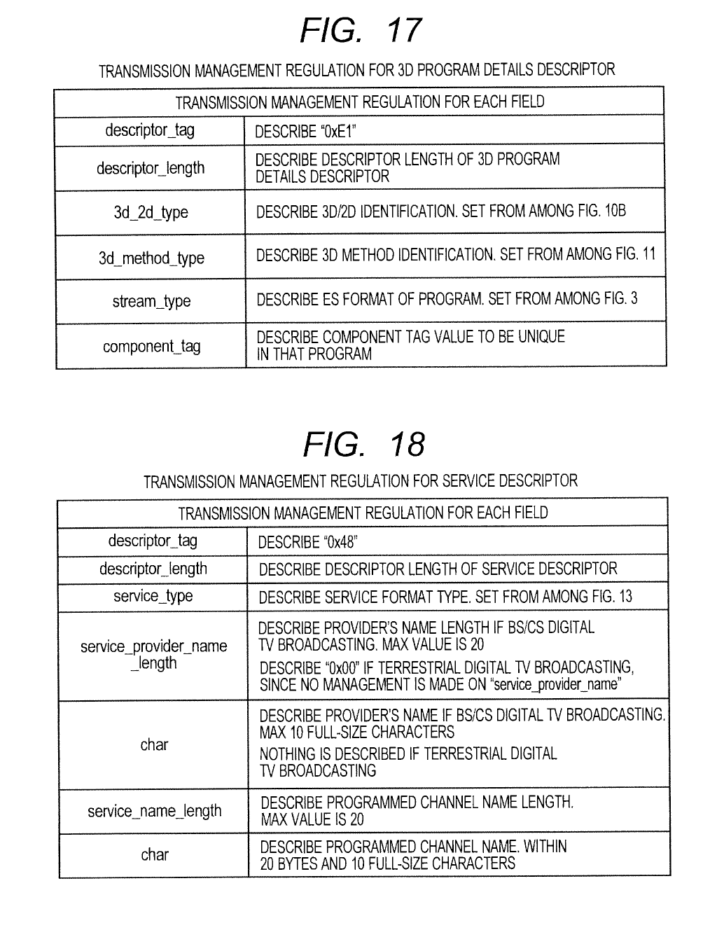

FIG. 17 shows an example of the transmission process of the 3D program details descriptor within the transmitting apparatus 1. In “descriptor_tag” is described “0xE1”, which means the 3D program details descriptor. In “descriptor_length” is described the descriptor length of the 3D program details descriptor. It is determined from among those shown in FIG. 10B. In “3d_method_type” is described the type of the 3D method. It is determined from among those shown in FIG. 11. In “stream_type” is described a format of ES of the program. It is determined from among those shown in FIG. 3. In “component_tag” is described such a value of component tag that it can be identified uniquely within that program.

With such transmission management within the transmitting apparatus 1, the receiving apparatus 4 can observe the 3D program details descriptor, and therefore, if this descriptor exists, there can be obtained an effect of enabling recognition that the program, which is received at present or will be received in future, is the 3D program.

FIG. 18 shows an example of the transmission process of the service descriptor within the transmitting apparatus 1. In “descriptor_tag” is described “0x48”, which means the service descriptor. In “descriptor_length” is described the descriptor length of the service descriptor.

With the service format type, it is determined from among those shown in FIG. 13. In “service_provider_name_length” is described a name of the service provider, if the service is a BS/CS digital TV broadcasting. It is assumed that the maximum value is 20. Since no “service_provider_name_length” is managed in the terrestrial digital TV broadcasting, “0x00” is described therein.

In “char” is described the provider's name when the service is the BS/CS digital TV broadcasting. It is 10 full-size characters at maximum. Nothing is described therein in case of the terrestrial digital TV broadcasting. In “service_name_length” is described name length of a programmed channel. It is assumed the maximum value is 20. In “char” is described a name of the programmed channel. It can be written within 20 bytes or within 10 full-size characters. However, only one (1) piece is disposed for a programmed channel targeted.

With such transmission management within the transmitting apparatus 1, the receiving apparatus 4 can observe the “service_type”, and therefore there can be obtained an effect of enabling recognition that the programmed channel is the channel of 3D program.

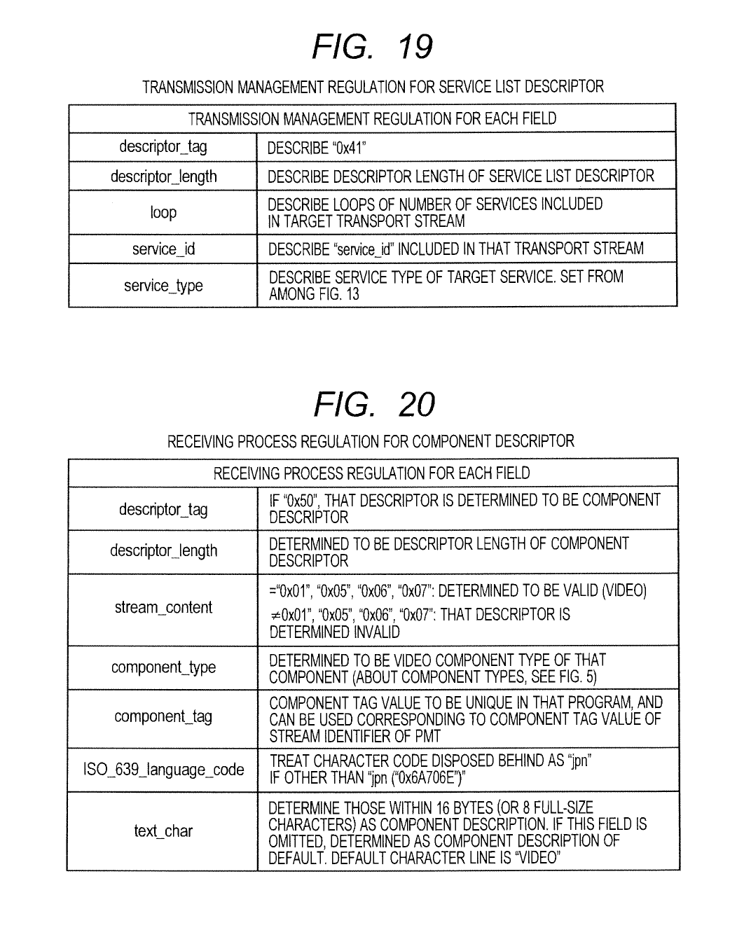

FIG. 19 shows an example of the transmission process of the service list descriptor within the transmitting apparatus 1. In “descriptor_tag” is described “0x41”, which means the service list descriptor. In “descriptor_length” is described the descriptor length of the service list descriptor. In “loop” is described a loop of the number of services, which are included within the transport stream targeted.

In “service_id” is described the “service_id”, which is included in that transport stream. In “service_type” is described the service type of an object service. It is determined from among those shown in FIG. 13. However, it must be disposed for a TS loop within NIT, necessarily.

With such transmission management within the transmitting apparatus 1, the receiving apparatus 4 can observe the “service_type”, and therefore there can be obtained an effect of enabling recognition that the programmed channel is the channel of 3D program.

As was mentioned above, although the explanation was made on the example of transmitting the program information within the transmitting apparatus 1; however, if transmitting the video produced by the transmitting apparatus 1 with inserting a notice, such as, “3D program will start from now”, “please wear glasses for use of 3D view/listen when viewing/listening 3D display”, “recommend to enjoy of viewing/listening 2D display if eyes are tired or physical condition is not good”, or “long time viewing/listening of 3D program may bring about tiredness of eyes or bad physical condition”, etc., with using a telop (or, an on-screen title), for example, there can be obtained an effect for enabling to make an attention or a warning about viewing/listening the 3D program to the user who is viewing/listening the 3D program, on the receiving apparatus 4.

<Hardware Structure of Apparatus>

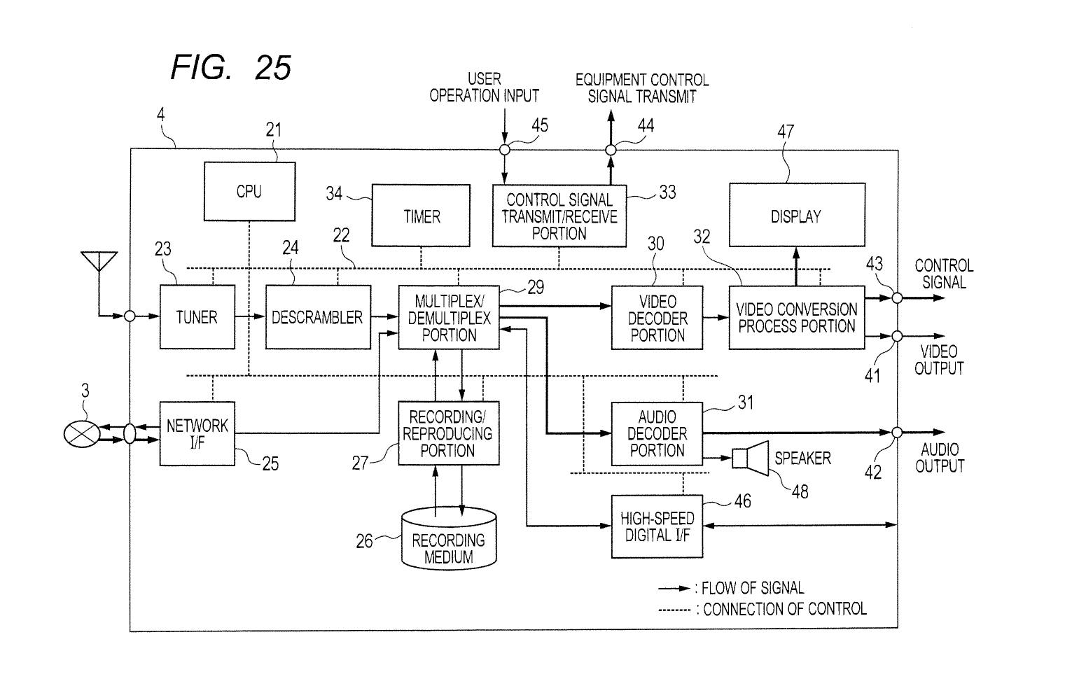

FIG. 25 is a hardware structure view for showing an example of the structure of the receiving apparatus 4, among the system shown in FIG. 1. A reference numeral 21 depicts a CPU (Central Processing Unit) for controlling the receiver as a whole, 22 a common bus for transmitting control and information between the CPU 2 and each portion within the receiving apparatus, 23 a tuner for receiving a radio signal broadcasted from the transmitting apparatus 1 through a broadcast transmission network, such as, a radio wave (satellite, terrestrial), a cable, etc., for example, to execute selection at a specific frequency, demodulation, an error correction process, etc., and thereby outputting a multiplexed packet, such as, MPEG2-Tranport Stream (hereinafter, also may be called “TS”), 24 a descrambler for decoding a scramble made by a scrambler portion 13, 25 a network I/F (Interface) for transmitting/receiving information between the network, and thereby transmitting/receiving various kinds of infarction and MPEG2-TS between the Internet and the receiving apparatus, 26 a recording medium, such as, a HDD (Hard Disk Drive) or a flash memory, which is built within the receiving apparatus, or a removable HDD, disc-type recording medium, or flash memory, etc., 27 a recording/reproducing portion for controlling the recording medium 26, and thereby controlling the recording of a signal onto the recording medium 26 and/or the reproduction of a signal from the recording medium 26, and 29 a multiplex/demultiplx portion for separating the signals multiplexed into a form, such as, MPEG2-TS, etc., into a video ES (Elementary Stream), an audio ES, program information, etc. Herein, ES means each of the video/audio data being compressed/encoded, respectively. A reference numeral 30 depicts a video decoder portion for decoding the video ES into the video signal, 31 an audio decoder portion for decoding the audio ES into the audio signal, and thereby outputting it to a speaker 48 or outputting it from an audio output 42, 32 a video conversion processor portion, executing a process for converting the video signal decoded in the video decoder portion 30, or the video signal of 3D or 2D through a converting process, which will be mentioned later, into a predetermined format, in accordance with an instruction of the CPU mentioned above, and/or a process for multiplexing a display, such as, on OSD (On Screen Display), etc., which is produced by the CPU 21, onto the video signal, etc., and thereby outputting the video signal after processing to a display 47 or a video signal output portion 41 while outputting a synchronization signal and/or a control signal (to be used in control of equipment) corresponding to the video signal after processing from the video signal output portion 41 and a control signal output portion 43, 33 a control signal transmitter portion for receiving an operation input from a user operation input portion 45 (for example, a key code from a remote controller generating IR (Infrared Radiation)), and also for transmitting an equipment control signal (for example, IR) to an external equipment, which is produced by the CPU 21 or the video conversion processor portion, from an equipment control signal transmit portion 44, 34 a timer having a counter in an inside thereof, and also holding a present time therein, 46 a high-speed digital I/F, for outputting TS to an outside after executing a process necessary for encoding, etc., upon the TS, which is restructured in the multiplex/demultiplex portion mentioned above, or for inputting TS into the multiplex/demultiplex portion 29 after decoding the TS received from the outside, 47 a display for displaying the 3D video and the 2D video, which are decoded by the video decoder portion 30 and converted by the video conversion processor portion 32, and 48 a speaker for outputting sounds upon basis of the audio signal decoded by the audio decoder portion, respectively, wherein the receiving apparatus 4 is built up, mainly, with those devices. When displaying 3D on the display, if necessary, the synchronization signal and/or the control signal are outputted from the control signal output portion 43 and/or the equipment control signal transmit terminal 44.

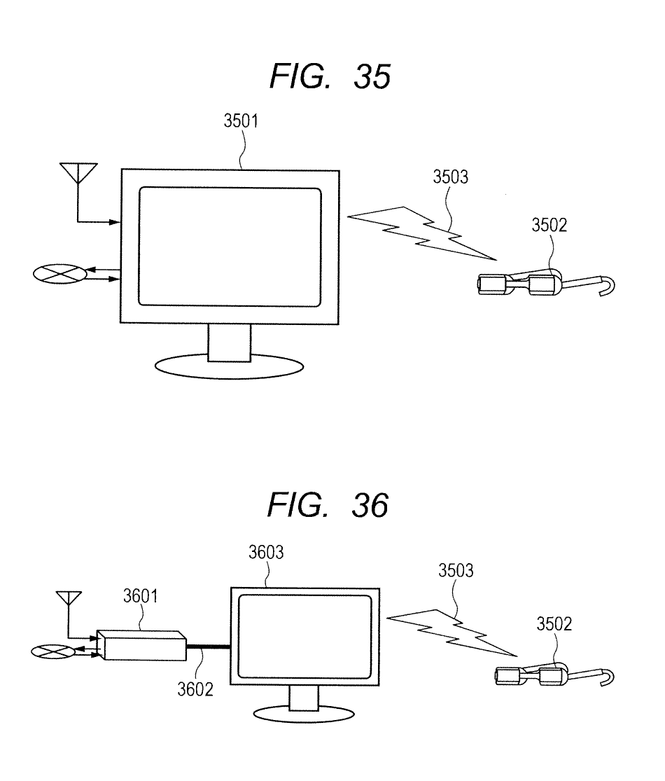

The system structure or configuration, including therein the receiving apparatus and a viewing/listening device and also a 3D view/listen assisting device (for example, 3D glasses), will be shown by referring to FIGS. 35 and 36. FIG. 35 shows an example of the system configuration when the receiving apparatus and the viewing/listening device are unified into one body, while FIG. 36 shows an example of the structure when the receiving apparatus and the viewing/listening device are separated in the structures.

In FIG. 35, a reference numeral 3501 depicts a display device, including the structure of the receiving apparatus 4 mentioned above therein and being able to display the 3D video and to output the audio, 3503 a 3D view/listen assisting device control signal (for example, IR), being outputted from the display device 3501 mentioned above, and 3502 the 3D view/listen assisting device, respectively. In the example shown in FIG. 35, the video signal is outputted from a video display, being equipped on the display apparatus 3501 mentioned above, while the audio signal is outputted from a speaker, being equipped on the display device 3501 mentioned above. Also, in the similar manner, the display device 3501 is equipped with an output terminal for outputting the equipment control signal 44 or the 3D view/listen assisting device control signal, which is outputted from the output portion for the control signal 43.

However, in the explanation given in the above, the explanation was made upon an assumption of the example, wherein the display is made by the display device 3501, and the 3D view/listen assisting device 3502, as well, make the display through an active shutter method, which will be mentioned later which are shown in FIG. 35; but in case where the display device 3501 and the 3D view/listen assisting device 3502 shown in FIG. 35 make the 3D display through a polarization separation, which will be mentioned later, the 3D view/listen assisting device 3502 may be such a one of being able to achieve the polarization separation, so as to enter different pictures into the left-side eye and the right-side eye, but it is not necessary to output the equipment control signal 44 from the display device 3501 or the 3D view/listen assisting device control signal 3503, which is outputted from the output portion to the 3D view/listen assisting device 3502.

Also, in FIG. 36, a reference numeral 3601 depicts a video/audio output device including the structure of the receiving apparatus 4 mentioned above, 3602 a transmission path (for example, a HDMI cable) for transmitting a video/audio/control signal, and 3603 a display for displaying/outputting the video signal and/or the audio signal, which are inputted from the outside.

In this case, the video signal and the audio signal, which are outputted from the video output 41 and the audio output 42 of the video/audio output device 3601 (e.g., the receiving apparatus 4), and also the control signal, which is outputted from the control signal output portion 43, are converted into transmission signals, each being of a form in conformity with a format, which is regulated for the transmission path 3602 (for example, the format regulated by the HDMI standard), and they are inputted into the display 3603 passing through the transmission path 3602. The display 3603 decodes the above-mentioned transmission signals received thereon into the video signal, the audio signal and the control signal, and outputs the video and the audio therefrom, as well as, outputting the 3D view/listen assisting device control signal 3503 to the 3D view/listen assisting device 3502.

However, in the explanation given in the above, the explanation was made upon an assumption that the display device 3603 and the 3D view/listen assisting device 3502 shown in FIG. 36 do displaying through the active shutter method, which will be mentioned later, but in case where the display device 3603 and the 3D view/listen assisting device 3502 shown in FIG. 36 apply the method for displaying the 3D video through the polarization separation, the 3D view/listen assisting device 3502 may be such a one of being able to achieve the polarization separation, so as to enter different pictures into the left-side eye and the right-side eye, but it is not necessary to output the 3D view/listen assisting device control signal 3503 from the display device 3603 to the 3D view/listen assisting device 3502.

However, a part of each of the constituent element shown by 21 to 46 in FIG. 25 may be constructed with one (1) or plural numbers of LSI(s). Or, such a structure may be adopted that the function of a part of each of the constituent element shown by 21 to 46 in FIG. 25 can be achieved in the form of software.

<Function Block Diagram of Apparatus>

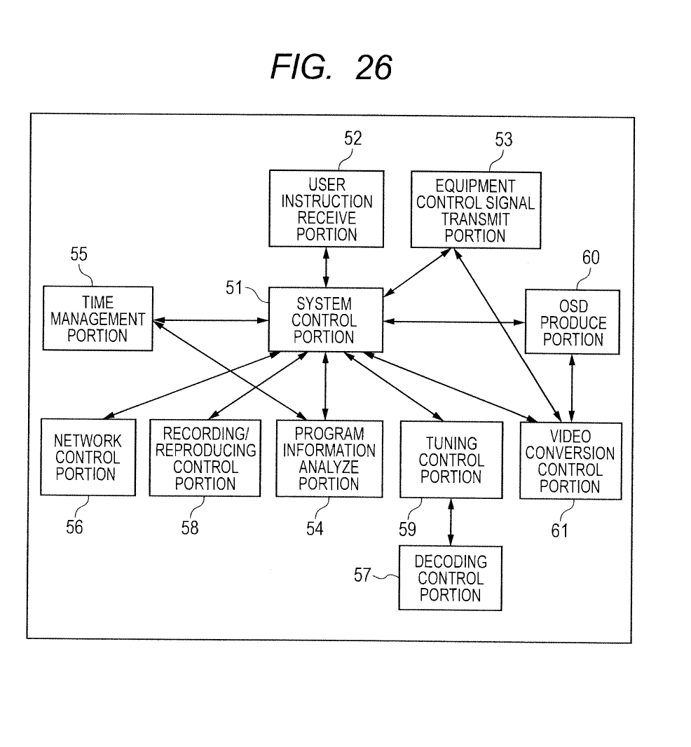

FIG. 26 shows an example of the function block structure of processing in an inside of the CPU 21. Herein, each function block exists, for example, in the form of a module of software to be executed by the CPU 21, wherein delivery of information and/or data and an instruction of control are conducted by any means, between the respective modules (for example, a message passing, a function call, an event transmission, etc.).

Also, each module also executes transmission/receiving hardware of information between each of hardwires within the receiving apparatus 4 through the common buss 22. Also, relation lines (e.g., arrows) are drawn in the figure, mainly, for the portions relating to the explanation of this time; however, there is processing necessitating communication means and/or communication even between other modules. For example, a tuning control portion 59 obtains the program information necessary for tuning from a program information analyzer portion 54, appropriately.

Next, explanation will be given on the function of each function block. A system control portion 51 manages a condition of each module and/or a condition of instruction made by the user, etc., and also gives a control instruction to each module. A user instruction receiver potion 52 receives and interprets an input signal of a user operation, which the control signal transmitter portion 33 receives, and transmits an instruction of the user to the system control portion 51. An equipment control signal transmitter portion 53 instructs the control signal transmitter portion 33 to transmit an equipment control signal, in accordance with an instruction from the system control portion 51 or other module(s).

The program information analyzer portion 54 obtains the program information from the multiplex/demultiplex portion 29, to analyze it, and provides necessary information to each module. A time management portion 55 obtains time correction information (TOT: Time offset table), which is included in TS, from the program information analyzer portion 54, thereby managing the present time, and it also gives a notice of an alarm (noticing an arrival of the time designated) and/or a one-shot timer (noticing an elapse of a preset time), in accordance with request(s) of each module, with using the counter that the time 34 has.

A network control portion 56 controls the network I/F 25, and thereby obtains various kinds of information from a specific URL (Unique Resource Locator) and/or IP (Internet Protocol) address. A decode control portion 57 controls the video decoder portion 30 and the audio decoder portion 31, and conducts start or stop of decoding, obtaining the information included in the stream, etc.

A recording/reproducing control portion 58 controls the record/reproduce portion 27, so as to read out a signal from a recoding medium 26, from a specific position of a specific content, and in an arbitrary readout format (normal reproduce, fast-forward, rewind, a pause). It also executes a control for recording the signal inputted into the record/reproduce portion 27 onto the recording medium 26.

A tuning control portion 59 controls the tuner 23, the descrambler 24, the multiplex/demultiplex portion 29 and the decode control portion 57, and thereby conducts receiving of broadcast and recording of the broadcast signal. Or, it conducts reproducing from the recording medium, and also controlling until when the video signal and the audio signal are outputted. Details of the operation of broadcast receiving and the recording operation of the broadcast signal and the reproducing operation from the recording medium will be given later.

An OSD produce portion 60 produces OSD data, including a specific message therein, and instructs a video conversion control portion 61 to pile up or superimpose that OSD data produced on the video data, thereby to be outputted. Herein, the a video conversion control portion 61 produces the OSD data for use of the left-side eye and for use of the right-side eye, having parallax therebetween, and requests the video conversion control portion 61 to do the 3D display upon basis of the OSD data for use of the left-side eye and for use of the right-side eye, and thereby executing display of the message in 3D.

The video conversion control portion 61 controls the video conversion processor portion 32, and superimpose the video, which is converted into 3D or 2D in accordance with the instruction from the system control portion 51 mentioned above, and the OSD inputted from the OSD produce portion 61, onto the video signal, which is inputted into the video conversion processor portion 32 from the video decoder portion 30, and further processes the video (for example, scaling or PinP, 3D display, etc.) depending on the necessity thereof; thereby displaying it on the display 47 or outputting it to an outside. Details of the converting method of the 2D video into a predetermined format will be mentioned later. Each function block provides such function as those.

<Broadcast Receiving>

Herein, explanation will be given on a control process and a flow of signals when receiving the broadcast. First of all, the system control portion 51, receiving an instruction of the user indicating to receive broadcast at a specific channel (CH) (for example, pushdown of a CH button on the remote controller) from the user instruction receiver potion 52 instructs tuning at the CH, which the user instructs (hereinafter, “designated CH”), to the tuning control portion 59.

The tuning control portion 59 receiving the instruction mentioned above instructs a control for receiving the designated CH (e.g., a tuning at designated frequency band, a process for demodulating the broadcast signal, an error correction process) to the tuner, so that it output TS to the descrambler 24.

Next, the tuning control portion 59 instructs the descrambler 24 to descramble the TS mentioned above and to output it to the multiplex/denultiplex 29, while it instructs the multiplex/demultiplex 29 to demultiplex of the TS inputted and to output the video ES demultiplexed to the video decoder portion 30, and also to output the audio ES to the audio decoder portion 31.

Also, the tuning control portion 59 instructs the decode control portion 57 to decode the video ES and the audio ES, which are inputted into the video decoder portion 30 and the audio decoder portion 31. The decode control portion 57 controls the video decoder portion 30 to output the video signal decoded into the video conversion processor portion 32, and controls the audio decoder portion 31 to output the audio signal decoded to the speaker 48 or the audio output 42. In this manner is executed the control of outputting the video and the audio of the CH, which the user designates.

Also, for displaying a CH banner (e.g., an OSD for displaying a CH number, a program name and/or the program information, etc.), the system control portion 51 instructs the OSD produce portion 60 to produce and output the CH banner. The OSD produce portion 60 receiving the instruction mentioned above transmits the data of the banner produced to the video conversion control portion 61, and the video conversion control portion 61 receiving the data mentioned above superimposes the CH banner on the video signal, and thereby to output it. In this manner is executed the display of the message when tuning, etc.

<Recording of Broadcast Signal>

Next, explanation will be given on a recording control of the broadcast signal and a flow of signals. When recording a specific CH, the system control portion 51 instructs the tuning control portion 59 to tune up to the specific CH and to output a signal to the record/reproduce portion 27.

The tuning control portion 59 receiving the instruction mentioned above, similar to the broadcast receiving process mentioned above, instructs the tuner 23 to receive the designated CH, instructs the descrambler 24 to descramble the MPEG2-TS received from the tuner 23, and further instructs the multiplex/demultiplex portion 29 to output the input from the descrambler 24 to the record/reproduce portion 27.

Also, the system control portion 51 instructs the recording/reproducing control portion 58 to record the input TS into the record/reproduce portion 27. The record/reproduce control portion 58 receiving the instruction mentioned above executes a necessary process, such as, an encoding, etc., on the signal (TS) inputted into the record/reproduce portion 27, and after executing production of additional information necessary when recording/reproducing (e.g., the program information of a recoding CH, content information, such as, a bit rate, etc.) and recording into management data (e.g., an ID of recording content, a recording position on the recording medium 26, a recording format, encryption information, etc.), it executes a process for writing the management data onto the recording medium 26. In this manner is executed the recording of broadcast signal.

<Reproducing from Recording Medium>

Explanation will be given on a process for reproducing from the recoding medium. When doing reproduction of a specific program, the system control portion 51 instructs the recording/reproducing control portion 58 to reproduce the specific program. As an instruction in this instance are given an ID of the content and a reproduction starting position (for example, at the top of program, at the position of 10 minutes from the top, continuation from the previous time, at the position of 100 Mbytes from the top, etc.) The recording/reproducing control portion 58 receiving the instruction mentioned above controls the record/reproduce portion 27, and thereby executes processing so as to read out the signal (TS) from the recording medium 26 with using the additional information and/or the management information, and after treating a necessary process thereon, such as, decryption of encryption, etc., to output the TS to the multiplex/demultiplex portion 29.

Also, the system control portion 51 instructs the tuning control portion 59 to output the video/audio of the reproduced signal. The tuning control portion 59 receiving the instruction mentioned above controls the input from the record/reproduce portion 27 to be outputted into the multiplex/demultiplex portion 29, and instructs the multiplex/demultiplex portion 29 to demultiplex the TS inputted, and to output the video ES demultiplexed to the video decoder portion 30, and also to output the audio ES demultiplexed to the audio decoder portion 31.

Also, the tuning control portion 59 instructs the decode control portion 57 to decode the video ES and the audio ES, which are inputted into the video decoder portion 30 and the audio decoder portion 31. The decode control portion 57 receiving the decode instruction mentioned above controls the video decoder portion 30 to output the video signal decoded to the video conversion processor portion 32, and controls the audio decoder portion 31 to output the audio signal decoded to the speaker 48 or the audio output 42. In this manner is executed the process for reproducing the signal from the recording medium.

<Display Method of 3D Video>

As a method for displaying the 3D video, into which the present invention can be applied, there are several ones; i.e., producing videos, for use of the left-side eye and for use of the right-side eye, so that the left-side eye and the right-side eye can feel the parallax, and thereby inducing a person to perceive as if there exists a 3D object.

As one method thereof is known an active shutter method of generating the parallax on the pictures appearing on the left and right eyes, by conducting the light shielding on the left-side and the right-side glasses with using a liquid crystal shutters, on the glasses, which the user wears, and also displaying the videos for use of the left-side eye and for use of the right-side eye in synchronism with that.

In this case, the receiving apparatus 4 outputs the sync signal and the control signal, from the control signal output portion 43 and the equipment control signal 44 to the glasses of the active shutter method, which the user wears. Also, the video signal is outputted from the video signal output portion 41 to the external 3D video display device, so as to display the video for use of the left-side eye and the video for use of the right-side eye, alternately. Or, the similar 3D display is conducted on the display 47, which the receiving apparatus 4 has. With doing in this manner, for the user wearing the glasses of the active shutter method, it is possible to view/listen the 3D video on that 3D video display device or the display 47 that the receiving apparatus 4 has.

Also, as other method thereof is already known a polarization light method of generating the parallax between the left-side eye and the right-side eye, by separating the videos entering into the left-side eye and the right-side eye, respectively, depending on the polarizing condition, with sticking films crossing at a right angle in liner polarization thereof or treating liner polarization coat, or sticking films having opposite rotation directions in rotating direction of a polarization axis in circular polarization or treating circular polarization coat on the left-side and right-side glasses, on a pair of glasses that the user wears, while outputting the video for use of the left-side eye and the video for use of the right-side eye, simultaneously, of polarized lights differing from each other, corresponding to the polarizations of the left-side and the right-side glasses, respectively.

In this case, the receiving apparatus 4 outputs the video signal from the video signal output portion 41 to the external 3D video display device, and that 3D video display device displays the video for use of the left-side eye and the video for use of the right-side eye under the different polarization conditions. Or, the similar display is conducted by the display 47, which the receiving apparatus 4 has. With doing in this manner, for the user wearing the glasses of the polarization method, it is possible to view/listen the 3D video on that 3D video display device or the display 47 that the receiving apparatus 4 has. However, with the polarization method, since it is possible to view/listen the 3D video, without transmitting the sync signal and the control signal from the receiving apparatus 4, there is no necessity of outputting the sync signal and the control signal from the control signal output portion 43 and the equipment control signal 44.

Also, other that this, a color separation method may be applied of separating the videos for the left-side and the right-side eyes depending on the color. Or may be applied a parallax barrier method of producing the 3D video with utilizing the parallax barrier, which can be viewed by naked eyes.

However, the 3D display method according to the present invention should not be restricted to a specific method.

<Example of Detailed Determining Method of 3D Program Using Program Information>

As an example of a method for determining the 3D program, if obtaining the information for determining on whether being a 3D program newly included or not, from the various kinds of tables and/or the descriptors included in the program information of the broadcast signal and the reproduce signal, which are already explained, it is possible to determine on whether being the 3D program or not.

Determination is made on whether being the 3D or not, by confirming the information for determining on whether being the 3D program or not, which is newly included in the component descriptor and/or the component group descriptor, described in the table, such as, PTM and/or EIT [schedule basic/schedule extended/present/following], or confirming the 3D program details descriptor, being a new descriptor for use of determining the 3D program, or by confirming the information for determining on whether being the 3D program or not, which is newly included in the service descriptor and/or the service list descriptor, etc., described in the table, such as, NIT and/or SDT, and so on. Those information are supplied or added to the broadcast signal in the transmitting apparatus mentioned previously, and are transmitted therefrom. In the transmitting apparatus, those information are added to the broadcast signal by the management information supply portion 16.

As proper uses of the respective tables, for example, regarding the PMT, since it describes therein only the information of present programs, the information of future programs cannot be confirmed, but it has a characteristic that the reliability thereof is high. On the other hand, regarding the EIT [schedule basic/schedule extended], although possible to obtain the information of, not only the present programs, but also the information of future programs therefrom; however, it takes a long time until completion of receipt thereof, and needs a large memory area or region for holding it, and has a demerit that the reliability thereof is low because of phenomenon in future. Regarding the EIT [following], since possible to obtain the information of programs of next coming broadcast hour(s), it is preferable to be applied into the present embodiment. Also, regarding the EIT [present], it can be used to obtain the present program information, and the information differing from the PMT can be obtained therefrom.

Next, explanation will be given on detailed example of the process within the receiving apparatus 4, relating to the program information explained in FIGS. 4, 6, 10, 12 and 14, which is transmitted from the transmitting apparatus 1.

FIG. 20 shows an example of the process for each field of the component descriptor within the receiving apparatus 4.

When “descriptor_tag” is “0x50”, it is determined that the said descriptor is the component descriptor. By “descriptor_length”, it is determined to be the descriptor length of the component descriptor. If “stream_content” is “0x01”, “0x05”, “0x06” or “0x07”, then it is determined that the said descriptor is valid (e.g., the video). When other than “0x01”, “0x05”, “0x06” and “0x07”, it is determined that the said descriptor is invalid. When “stream_content” is “0x01”, “0x05”, “0x06” or “0x07”, the following processes will be executed.

“component_type” is determined to be the component type of that component. With this component type, it is assigned with any value shown in FIG. 5. Depending on this content, it is possible to determine on whether that component is the component of the 3D video program or not.

“component_tag” is a component tag value to be unique within that program, and can be used by corresponding it to the component tag value of the stream descriptor of PMT.

“ISO_{—}639_language_code” treats the letter codes being disposed following thereto as “jpn”, even if they are other than “jpn(“0x6A706E”)”.

With “text_char”, if being within 16 bytes (or, 8 full-size characters), it is determined to be the component description. If this field is omitted, it is determined to be the component description of the default. The default character string is “video”.

As was explained in the above, with an aid of the component descriptor, it is possible to determined the type of the video component, which builds up the event (e.g., the program), and the component description can be used when selecting the video component in the receiver.

However, only a video component, determined the “component_tag” value thereof at the value from “0x00” to “0x0F”, is a target of the selection, alone. The video component determined the “component_tag” value thereof at other value is not the target of the selection, alone, nor a target of the function of component selection, etc.

Also, due to mode change during the event (e.g., the program), there is a possibility that the component description does not agree with an actual component. (“component_type” of the component descriptor describes only the representative component types of that component, but it is hardly done to change this value in real time responding to the mode change during the program.)

Also, “component_type” described by the component descriptor is referred to when determining a default “maximum_bit_rate” in case where a digital copy control descriptor, being the information for controlling a copy generation and the description of the maximum transmission rate within digital recording equipment, is omitted therefrom, for that event (e.g., the program).

In this manner, with doing the process upon each field of the present descriptor, in the receiving apparatus 4, the receiving apparatus 4 can observe the “stream_type” and the “component_type”, and therefore there can be obtained an effect of enabling to recognize that the program, which is received at present, or which will be received in future, be the 3D program.

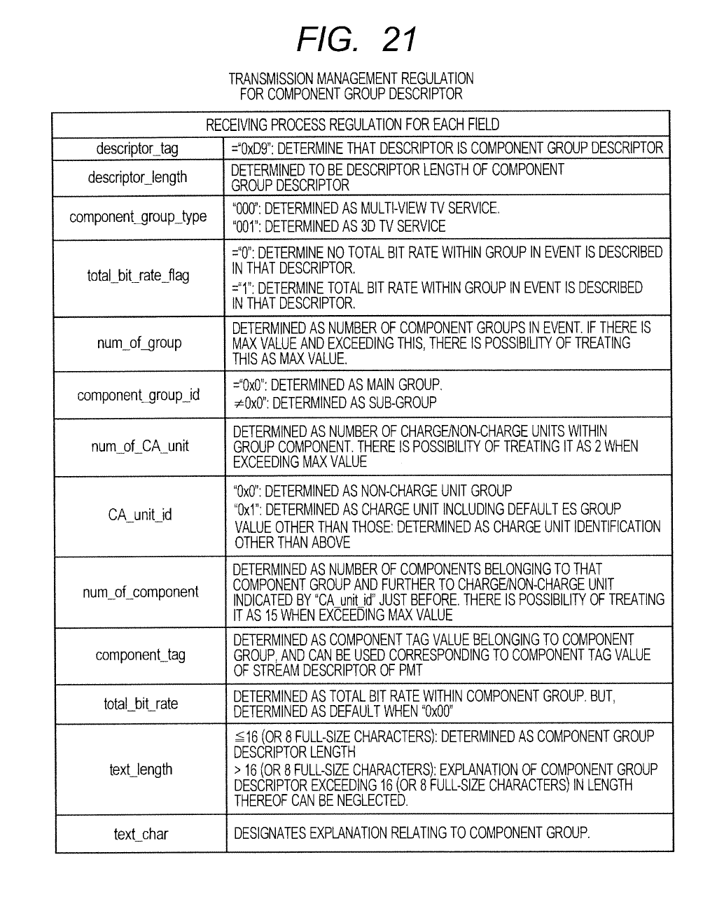

FIG. 21 shows an example of a process upon each field of the component group descriptor, in the receiving apparatus 4.

If “descriptor_tag” is “0xD9”, it is determined that the said descriptor is the component group descriptor. By the “descriptor_length”, it is determined to have the descriptor length of the component group descriptor.

If “component_group_type” is “000”, it is determined to be the multi-view TV service, on the other hand if “001”, it is determined to be the 3D TV service.

If “total_bit_rate_flag” is “0”, it is determined that the total bit rate within the group of an event (e.g., the program) is not described in that descriptor. On the other hand, if “1”, it is determined the total bit rate within the group of an event (e.g., the program) is described in that descriptor.

“num_of_group” is determined to be a number of the component group(s) within an event (e.g., the program). While there is the maximum number, and if the number exceeds that maximum number, then there is a possibility of treating it as the maximum value. If “component_group_id” is “0x0”, it is determined to be a main group. If it is other than “0x0”, it is determined to be a sub-group.

“num_of_CA_unit” is determined to be a number of charging/non-charging units within the component group. If exceeding the maximum value, there is a possibility of treating it to be “2”.

If “CA_unit_id” is “0x0”, it is determined to be the non-charing unit group. If “0x1”, it is determined to be the charging unit including a default ES group therein. If other than “0x0” and “0x1”, it is determined to be a charging unit identification of other(s) than those mentioned above.

“num_of_compoent” belongs to that component group, and is determined to be a number of the component(s) belonging to the charging/non-charging unit, which indicated by the “CA_unit_id” just before. If exceeding the maximum value, there is a possibility of treating it to be “15”.

“component_tag” is determined to be a component tag value belonging to the component group, and this can be used by corresponding it to the component tag value of the stream descriptor of PMT. “total_tag_rate” is determined to be the total bit rate within the component group. However, when it is “0x00”, it is determined to be default.

If “text_length” is equal to or less than 16 (or, 8 full-size characters), it is determined to be the component group description length, and if being larger than 16 (or, 8 full-size characters), the explanation exceeding 16 (or, 8 full-size characters) may be neglected.

“text_char” indicates an explanation in relation to the component group. However, with determining that the multi-view TV service be provided in that event (e.g., the program), depending on an arrangement of the component group descriptor(s) of “component_group_type”=“000”, this can be used in a process for each component group.

Also, with determining that the 3D TV service be provided in that event (e.g., the program) depending on an arrangement of the component group descriptor(s) of “component_group_type”=“001”, this can be used in a process for each component group.

Further, the default ES group for each group is described, necessarily, within the component loop, which is arranged at a top of “CA_unit” loop.

In the main group (“component_group_id=0x0”), the following are determined:
If the default ES group of the group is a target of the non-charging, “free_CA_mode” is set to “0” (“free_CA_mode=0”), and no setting up of the component group of “CA_unit_id=0x1” is allowed.
If the default ES group of the group is a target of the charging, “free_CA_mode” is set to “1” (free_CA_mode=1), and the component group of “CA_unit_id=0x1” must be set up to be described.

Also, in the sub-group (“component_group_id>0x0”), the following are determined:
For the sub-group, only the charging unit, which is same to that of the main group, or non-charging unit can be set up.
If the default ES group of the group is a target of the non-charging, a component group of “CA_unit_id=0x0” is set up, to be described.
If the default ES group of the group is a target of the charging, a component group of “CA_unit_id=0x1” is set up, to be described.

In this manner, with doing the process upon each field of the present descriptor, in the receiving apparatus 4, the receiving apparatus 4 can observe the “component_group_type”, and therefore there can be obtained an effect of enabling to recognize that the program, which is received at present, or which will be received in future, be the 3D program.

FIG. 22 shows an example of a process for each field of the 3D program details descriptor, within the receiving apparatus 4.

If “descriptor_tag” is “0xE1”, it is determined that the said descriptor is the 3D program details descriptor. By the “descriptor_tag”, it is determined to have the descriptor length of the 3D program details descriptor. “3d_{—}2d_type” is determined to be 3D/2D identification in that 3D program. This is designated from among of those shown in FIG. 10B. “3d_method_type” is determined to be the identification of 3D method in that 3D program. This is designated from among of those shown in FIG. 11.

“stream_type” is determined to be a format of the ES of that 3D program. This is designated from among of those shown in FIG. 3. “component_tag” is determined to be the component tag value, to be unique within that 3D program. This can be used by responding it to the component tag value of the stream identifier of PMT.

Further, it is also possible to adopt such structure that determination can be made on whether that program is the 3D video program or not, depending on existence/absence of the 3D program details descriptor itself. Thus, in this case, if there is no 3D program details descriptor, it is determined to the 2D video program, on the other hand if there is the 3D program details descriptor, it is determined to be the 3D video program.

In this manner, through observation of the 3D program details descriptor by the receiving apparatus 4 by executing the process on each field of the present descriptor, there can be obtained an effect of enabling to recognize that the program, which is received at present, or which will be received in future is the 3D program, if there exists this descriptor.

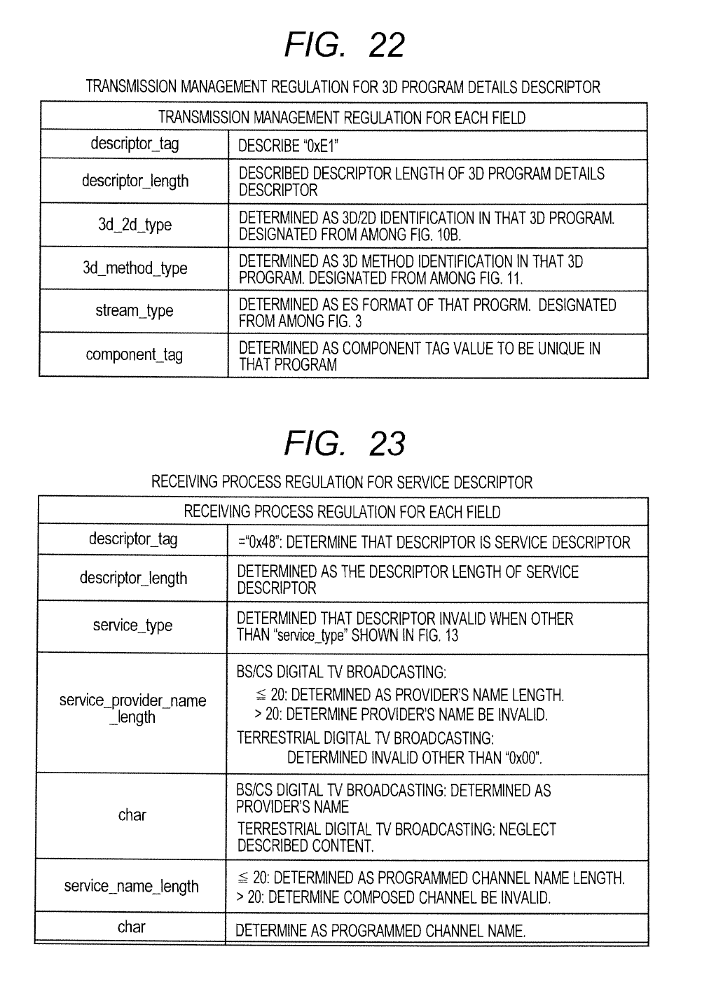

FIG. 23 shows an example of a process upon each field of the service descriptor, within the receiving apparatus 4. If “descriptor_tag” is “0x48”, it is determined that the said descriptor is the service descriptor. By “descriptor_length” it is determined to be the description length of the service descriptor. If “service_type” is other than those shown in FIG. 13, said is descriptor is determined invalid.

“service_provider_name_length” is determined to be a name length of the provider, when receiving the BS/CS digital TV broadcast, if it is equal to or less than 20, and if it is greater than 20, the provider name is determined to be invalid. On the other hand, when receiving the terrestrial digital TV broadcast, those other than “0x00” are determined to be invalid.

“char” is determined to be a provider name, when receiving the BS/CS digital TV broadcast. On the other hand, when receiving the terrestrial digital TV broadcast, the content described therein is neglected. If “service_name_length” is equal to or less than 20, it is determined to be the name length of the programmed channel, and if greater than 20, the programmed channel name is determined invalid.

“char” is determined to be a programmed channel name. However, if impossible to receive SDT, in which the descriptors are arranged or disposed in accordance with the transmission management regulation explained in FIG. 18 mentioned above, basic information of a target service is determined to be invalid.

With conducting the process upon each field of the present descriptor, in this manner, within the receiving apparatus 4, the receiving apparatus 4 can observe the “service_type”, and there can be obtained an effect of enabling to recognize that the programmed channel is the channel of the 3D program.

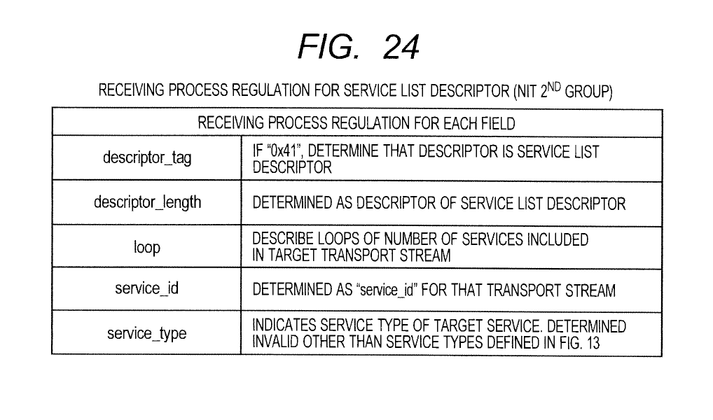

FIG. 24 shows an example of a process upon each field of the service list descriptor, within the receiving apparatus 4. If “descriptor_tag” is “0x41”, it is determined that said descriptor is the service list descriptor. By “descriptor_length”, it is determined to be the description length of the service list descriptor.

In “loop” is described a loop of the number of services, which are included in the target transport stream. “service_id” is determined as “service_id” to that transport stream. “service_type” indicates a type of service of the target service. Other(s) than those defined in FIG. 13 is/are determined to be invalid.

As was explained in the above, the service list descriptor can be determined to be the information of the transport stream included within the target network.

With conducting the process upon each field of the present descriptor, in this manner, within the receiving apparatus 4, the receiving apparatus 4 can observe the “service_type”, and there can be obtained an effect of enabling to recognize that the programmed channel is the channel of the 3D program.

Next, explanation will be given about the details of the descriptor within each table. First of all, depending on the type of data within the “service_type”, which is described in a 2nd loop (a loop for each ES) of PMT, it is possible to determine the format of ES, as was explained in FIG. 3 mentioned above; however, if there is the description indicating that the stream being broadcasted at present is the 3D video, then that program is determined to be the 3D program (for example, if there is “0x1F” indicating the sub-bit stream (e.g., other viewpoint) of the multi-viewpoints video encoded (for example, H.264/MVC) stream in the “stream_type”, that program is determined to be the 3D program).

Also, other than the “stream_type”, it is also possible to assign a 2D/3D identification bit, newly, for identifying the 2D program or the 3D program, in relation to an area or region that is made “reserved” at present within the PMT, and thereby to determine in that area or region.

With the EIT, it is also possible to assign the 2D/3D identification bit, newly, and to determine.

When determining the 3D program by the component descriptor, which is disposed or arranged in the PMT and/or the EIT, as was explained in FIGS. 4 and 5 in the above, the type for indicating the 3D video is assigned to the “component_type” of the component descriptor (for example, in FIGS. 5C to 5E), and if there is any one, “component_type” of which indicates the 3D, then it is possible to determine that program to be the 3D program. (For example, with assigning that shown in FIGS. 5C to 5E, etc., it is confirmed that said value exists in the program information of the target program.)

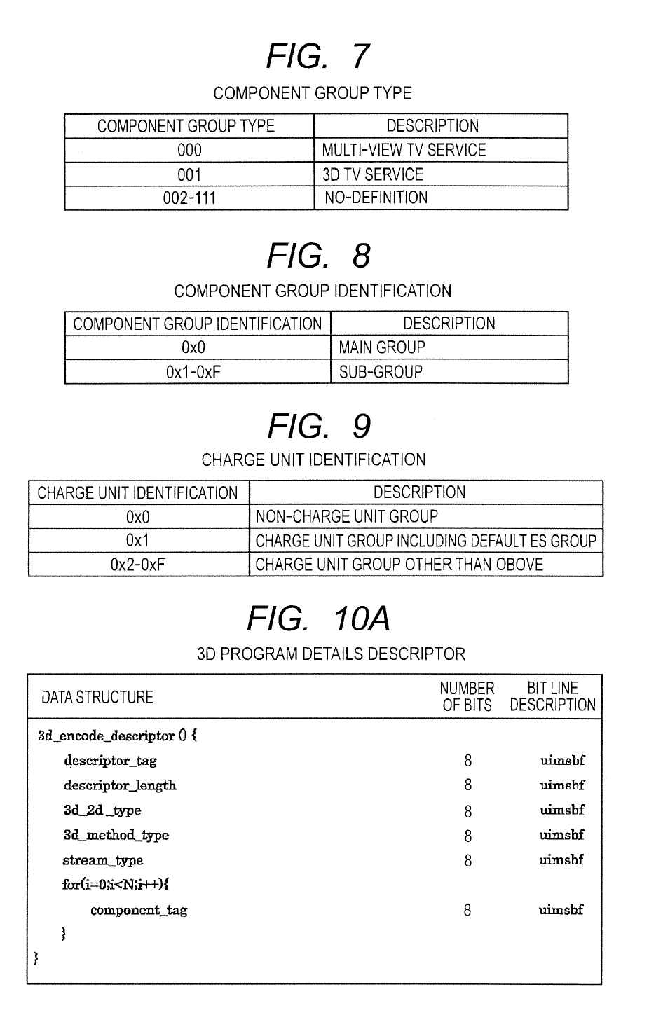

As a method for determining by means of the component group descriptor, which is arranged in the EIT, as was explained in FIGS. 6 and 7 mentioned above, the description for indicating the 3D service is assigned to the value of the “service_group_type”, and if the value of the “component_group_type” indicates the 3D service, then it is possible to determine it is the 3D program. (For example, while assigning “001” of the bit field to the 3D TV service, etc., it is confirmed that said value exists in the program information of the target program.)

As a method for determining by means of the 3D program details descriptor, which is arranged in the PMT and/or the EIT, as was explained in FIGS. 10 and 11 mentioned above, when determining whether the target program is the 3D program or not, it is possible to determine depending on the content of the “2d_{—}3d_type” (the 3D/2D type) within the 3D program details descriptor. Also, if the 3D program details descriptor about the receiving program, it is determined to be the 2D program. Also, there can be considered a method for determining the next coming program be the 3D program if it is such 3D method, that the receiving apparatus can deal with the 3D method type (i.e., the “3d_method_type” mentioned above) thereof, which is included in the descriptor mentioned above. In that case, although a process for analyzing the descriptor becomes complicated, but it is possible to stop the operation of conducting the message display process and/or the recording process upon the 3D program, with which the receiving apparatus cannot deal with.

In the information of “service_type”, which is included in the service descriptor disposed in the SDT and/or the service list descriptor disposed in the NIT, with assigning the 3D video service to “0x01”, as was explained in FIGS. 12, 13 and 14 mentioned above, it is possible to determine to be the 3D program, when that descriptor obtain a certain program information. In this case, determination is made, not by a unit of the program, but by a unit of service (e.g., CH: the programmed channel), although determination of the 3D program cannot be made on the next coming program within the same programmed channel, but there is also a merit of being easy because the obtaining of the information is not the unit of program.

Also, with the program information, there is also a method of obtaining it through a communication path for exclusive use thereof (e.g., the broadcast signal, or the Internet). In such case, it is possible to make the 3D program determination, in the similar manner, if there is the descriptor for indication that said program is the 3D program.

In the explanation given in the above, the explanation was given on various kinds of information (i.e., the information included in the table and/or the descriptor) for determining if being the 3D video or not, by the unit of the service (CH) or the program; however, all of those are not necessarily needed to be transmitted, according to the present invention. It is enough to transmit the information necessary fitting to configuration of the broadcasting. Among those information, it is enough to determine if being the 3D video or not, upon a unit of the service (CH) or the program, by confirming a single information, respectively, or to determine if being the 3D video or not, upon a unit of the service (CH) or the program, by combining plural numbers of information. When making the determination by combining the plural numbers of information, it is also possible to make the determination, such as, that it is the 3D video broadcasting service, but a part of the program is the 2D video, etc. In case where such determination can be made, for the receiving apparatus, it is possible to indicate clearly, for example, that said service is “3D video broadcasting service” on the EPG, and also, if the 2D video program is mixed with in said service, other than the 3D video program, it is possible to exchange the display control between the 3D video program and the 2D video program when receiving the program.

However, in the case where determination is made to be the 3D program, in accordance with such determining method as was mentioned above, the 3D components, which are designated in FIGS. 5C to 5E, for example, are processed (e.g., reproduced, displayed and/or outputted) in 3D, if they can be processed (e.g., reproduced, displayed and/or outputted), appropriately, within the receiving apparatus 4; however, if they cannot be processed (e.g., reproduced, displayed and/or outputted), appropriately, within the receiving apparatus 4 (for example, in case where there is no function of reproducing the 3D video for dealing with the 3D transmitting method, which is designated), they may be processed (e.g., reproduced, displayed and/or outputted) in 2D. In this instance, there may be displayed that said 3D video program cannot be displayed in 3D or outputted in 3D, appropriately, on the receiving apparatus, together with the display and the output of the 2D video. With doing so, for the user, it is possible to grasp if the program is broadcasted as the 2D video program, or it displays the 2D video because the receiving apparatus cannot deal with, appropriately, although it is the program being broadcasted as the 3D video program.

<3D Reproducing/Outputting/Displaying Process of 3D Content of 3D 2-Viewpoints Separate ES Transmission Method>

Next, explanation will be given on a process when reproducing 3D content (i.e., digital content including the 3D video). Herein, first of all, the explanation will be given on a reproducing process in case of the 3D 2-viewpoints separate ES transmission method, in which a main viewpoint video ES and a sub-viewpoint video ES exist in one (1) TS, as is shown in FIG. 47. First of all, when the user executes an instruction for exchanging to 3D output/display (for example, pushing down “3D” key on the remote controller), etc., the user instruction receive portion 52, receiving the key code mentioned above, instructs the system control portion 51 to exchange to the 3D video (however, in the processing given hereinafter, a similar process will be done, for the content of the 3D 2-viewpoints separate ES transmission method, even when exchanging to the 3D output/display under the condition other than that the user instructs to exchange into 3D display/output of the 3D content). Next, the system control portion 51 determines if the present program is the 3D program or not, in accordance with the method mentioned above.

When the present program is the 3D program, the system control portion 51 firstly instructs the tuning control portion 59 to output the 3D video. The tuning control portion 59 upon receipt of the instruction mentioned above, first of all, obtains PID (packet ID) and an encoding method (for example, H.264/MVC, MPEG 2, H.264/AVC, etc.), for each of the main viewpoint video ES and the sub-viewpoint video ES mentioned above, from the program information analyze portion 54, and next, makes a control on the multiplex/demultiplex portion 29 to demultiplex the main viewpoint video ES and the sub-viewpoint video ES, thereby to output them to the video decoder portion 30.

Herein, the multiplex/demultiplex portion 29 is controlled, so that, for example, the main viewpoint video ES mentioned above is inputted into a first input of the video decode portion while the sub-viewpoint video ES mentioned above into a second input thereof. Thereafter, the tuning control portion 59 instructs the is decode control portion 57 to transmit information indicating that the first input of the video decode portion 30 is the main viewpoint video ES while the second input thereof is the sub-viewpoint video ES and the respective encoding methods thereof, and also to decode those ES.

As a combining example 2 and/or a combining example 4 of the 3D 2-viewpoints separate ES transmission method shown in FIG. 47, in order to decode the 3D programs being different in the encoding methods thereof between the main viewpoint video ES and the sub-viewpoint video ES, it is enough that the video decode portion 30 is constructed to have plural numbers of decoding functions, corresponding to the encoding methods, respectively.

As a combining example 1 and a combining example 3 of the 3D 2-viewpoints separate ES transmission method shown in FIG. 47, in order to decode the 3D programs being same in the encoding methods thereof between the main viewpoint video ES and the sub-viewpoint video ES, it does not matter with if the video decode portion 30 is constructed to have only a decoding function corresponding to a single encoding method. In this case, the video decode portion 30 can be constructed, cheaply.

The decode control portion 57 receiving the instruction mentioned above executes decoding on the main viewpoint video ES and the sub-viewpoint video ES, respectively, and outputs the video signals for use of the left-side eye and for use of the right-side eye to the video conversion processor portion 32. Herein, the system control portion 51 instructs the video conversion control portion 61 to execute the 3D outputting process. The video conversion control portion 61 receiving the instruction mentioned above controls the video conversion processor portion 32, thereby to output the 3D video from the video output 41, or to display it on the display 47, which is equipped with the receiving apparatus 4.

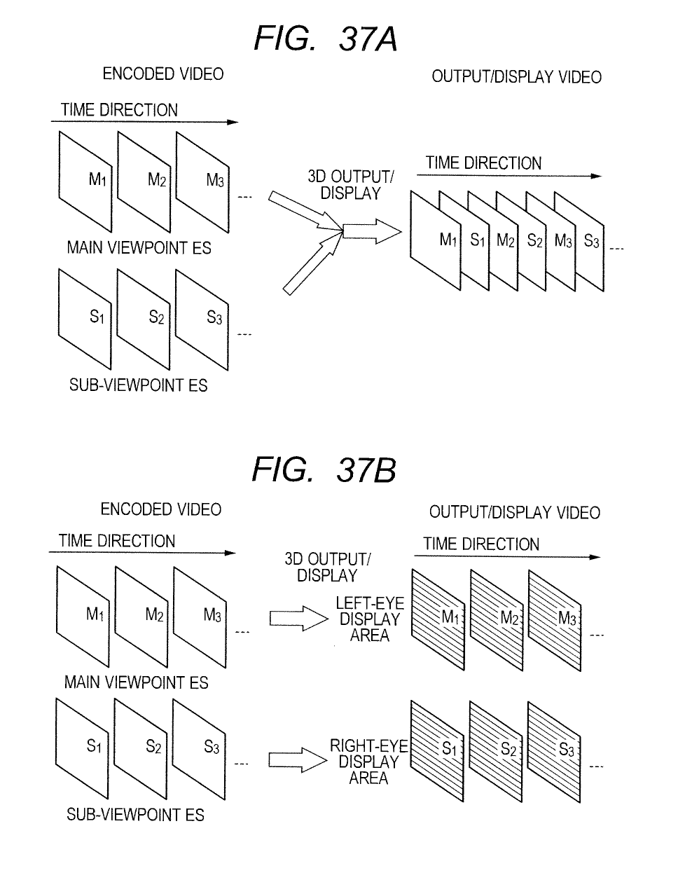

About that 3D reproducing/outputting/displaying method will be given explanation, by referring to FIGS. 37A and 37B.

FIG. 37A is a view for explaining the reproducing/outputting/displaying method for dealing with output and display of a frame sequential method, which alternately displays and outputs the videos of the left and the right viewpoints of the 3D content of the 3D 2-viewpoints separate ES transmission method. Frame lines (M1, M2, M3 . . . ) in the left-side upper portion of the figure present plural numbers of frames, which are included in the main viewpoint (for use of the left-side eye) ES of the content of the 3D 2-viewpoints separate ES transmission method, frame lines (S1, S2, S3 . . . ) in the left-side lower portion of the figure present plural numbers of frames, which are included in the sub-viewpoint (for use of the right-side eye) ES of the content of the 3D 2-viewpoints separate ES transmission method, respectively. The video conversion processor portion 32 outputs/displays each frame of the main viewpoint (for use of the left-side eye)/sub-viewpoint (for use of the right-side eye) video signals inputted, as the video signals, alternately, as is shown by frame lines (m1, S1, M2, S2, M3, S3 . . . ) on the right side in the figure. With such outputting/displaying method, it is possible to utilize a resolution at the maximum, at which each viewpoint can be displayed on the display, i.e., enabling the 3D display of high resolution.

In case where the method shown in FIG. 37A is applied in the system configuration shown in FIG. 36, as well as, outputting the video signals mentioned above, sync signals are outputted from the control signal 43, for enabling the video signals to be identified as that for use of the main viewpoint (for use of the left-side eye) and that for use of the sub-viewpoint (for use of the right-side eye), respectively. An external video outputting device receiving the video signals and the sync signals mentioned above outputs the videos of the main viewpoint (for use of the left-side eye) and the sub-viewpoint (for use of the right-side eye) by fitting the video signals with the sync signals, and also transmits the sync signals to the 3D view/listen assisting device, thereby enabling the 3D display. However, the sync signals to be outputted from the external video outputting device may be produced within that external video outputting device.

Also, when displaying the video signals mentioned above on the display 47, which is equipped with the receiving apparatus 4, with applying the method shown in FIG. 37A, in the system configuration shown in FIG. 35, the sync signals mentioned above are outputted from the equipment control signal transmit terminal 44, passing through the equipment control signal transmitter portion 53 and the control signal transmitter portion 33, so as to make the control (for example, exchanging light shutoff of the active shutter) on the external 3D view/listen assisting device; thereby conducting the 3D display.

FIG. 37B is a view for explaining the reproducing/outputting/displaying method for dealing with output and display of a method for displaying the videos of the left and the right viewpoints of the 3D content of the 3D 2-viewpoints separate ES transmission method in different areas or regions of the display. With said method, the streams of the 3D 2-viewpoints separate ES transmission method are decoded in the video decode portion 30, and thereby executing the video conversion process in the video conversion processor portion 32. Herein, for the purpose of displaying the videos in the different areas or regions, there is a method of, for example, displaying them with using odd number lines and even number lines of the display as display areas or regions for use of the main viewpoint (the left-side eye) and to for use of the sub-viewpoint (the right-side eye), respectively, and so on. Or, the display areas or regions may not be a unit of the line, for example, in the case of the display having different pixels for each viewpoint, a combination of plural numbers of pixels for use of the main viewpoint (the left-side eye) and a combination of plural numbers of pixels for use of the sub-viewpoint (the right-side eye) may be used as the display areas or regions, respectively. For example, with the display device of the polarization light method mentioned above, it is enough to output the videos having the polarization conditions, different from each other, corresponding to the respective polarization conditions of the left-side eye and the right-side eye of the 3D view/listen assisting device, from the different areas or regions mentioned above. With such outputting/displaying method, the resolution at which each viewpoint can be displayed on the display comes to be less than that of the method shown in FIG. 37A; however the video for use of the main viewpoint (the left-side eye) and the video for use of the sub-viewpoint (the right-side eye) can be outputted/displayed at the same time, and there is no necessity of displaying them alternately. With this, it is possible to obtain the 3D display having fewer flickers than those with the method shown in FIG. 37A.

However, in any system configuration shown in FIG. 35 or 36, the 3D view/listen assisting device may be polarization separation glasses, when applying the method shown in FIG. 37B, and there is no necessity, in particular, for executing an electronic control. In this case, the 3D view/listen assisting device can be supplied, with a price much cheaper.

<2D Outputting/Displaying Process of 3D Content of 3D 2-Viewpoints Separate ES Transmission Method>

Operations when executing 2D output/display on the 3D content of the 3D 2-viewpoints separate ES transmission method will be explained hereinafter. When the user gives an instruction to exchange to the 2D video (for example, pushing down “2D” button on the remote controller), the user instruction receive portion 52, receiving the key code mentioned above, instructs the system control portion 51 to exchange the signal to the 2D video (however, in the processing given hereinafter, a similar process will be done, even when exchanging into the 2D output/display under the condition other than that the user instructs to exchange into 2D display/output of the 3D content of the 3D 2-viewpoints separate ES transmission method). Next, the system control portion 51 gives an instruction to the tuning control portion 59, at first, to output the 2D video therefrom.

The tuning control portion 59 receiving the instruction mentioned above, firstly obtains PID of the ES for use of the 2D video (i.e., the main viewpoint ES mentioned above, or an ES having a default tag) from the program information analyze portion 54, and controls the multiplex/demultiplex portion 29 to output the ES mentioned above towards the video decoder portion 30. Thereafter, the tuning control portion 59 instructs the decode control portion 57 to decode the ES mentioned above. Thus, with the 3D 2-viewpoints separate ES transmission method, because the sub-stream or ES differs from, between the main viewpoint and the sub-viewpoint, it is enough to decode only the sub-stream or ES of the main viewpoint.

The decode control portion 57 receiving the instruction mentioned above control the video decoder portion 30, so as to decode the ES mentioned above, and outputs the video signal to the video conversion processor portion 32. Herein, the system control portion 51 controls the video conversion control portion 61 to make the 2D output of the video. The video conversion control portion 61 receiving the above-mentioned instruction for the system control portion 51 outputs the 2D video signal from the video output terminal 41 towards the video conversion processor portion 32, or executes such a control on the display 47 that it displays the 2D video thereon.

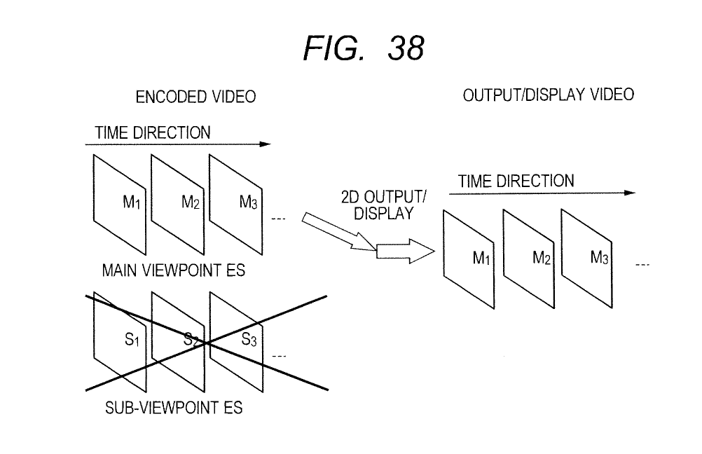

Explanation will be give about said 2D outputting/displaying method, by referring to FIG. 38. Although the configuration of the encoded video is same to that shown in FIG. 37, however since the second ES (i.e., the sub-viewpoint ES) is not decoded in the video decoder portion 30, as was explained in the above, the video signal of one side, which is decoded in the video conversion processor portion 32, is converted into the 2D video signal, as is shown by the frame lines (M1, M2, M3 . . . ) on the right-hand side in the figure, to be outputted. In this manner is executed the outputting/displaying of the 2D.

Herein, although the description is made about the method of not executing the decoding on the ES for use of the right-side eye as the method for outputting/displaying 2D; however, the 2D display may be executed, by decoding both the ES for use of the left-side eye and the ES for use of the right-side, and by executing a process of culling or thinning out in the video conversion processor portion 32. In that case, since no process for decoding and/or no process for exchanging the demultiplexing process are needed, there can be expected an effect of reducing the exchanging time and/or simplification of software processing, etc.

<3D Outputting/Displaying Process of 3D Content of Side-by-Side Method/Top-and-Bottom Method>

Next, explanation will be made on a process for reproducing the 3D content when the video for use of the left-side eye and the video for use of the right-side eye in one (1) video ES (for example, in case where the video for use of the left-side eye and the video for use of the right-side eye are stored in one (1) 2D screen, like the Side-by-Side method or the Top-and-Bottom method). Similar to that mentioned above, when the user gives an instruction to exchange into the 3D video, the user instruction receive portion 52 receiving the key code mentioned above instructs the system control portion 51 to exchange into the 3D video (however, in the processing given hereinafter, a similar process will be done, even when exchanging into the 2D output/display under the condition other than that the user instructs to exchange into 2D output/display of the 3D content of the Side-by-Side method or the Top-and-Bottom method). Next, the system control portion 51 determines, similarly with the method mentioned above, if the present program is the 3D program or not.

If the present program is the 3D program, the system control portion 51 firstly instructs the tuning control portion 59 to output the 3D video therefrom. The tuning control portion 59 receiving the instruction mentioned above obtains PID (e.g., packet ID) of the 3D video ES, including the 3D video therein, and the encoding method (for example, MPEG 2, H.264/AVC, etc.) from the program information analyze portion 54, and next it controls the multiplex/demultiplex portion 29 to demultiplex the above-mentioned 3D video ES, thereby to output it towards the video decoder portion 30, and also controls the video decoder portion 30 to execute the decoding process corresponding to the encoding method, thereby to output the video signal decoded towards the video conversion processor portion 32.

Herein, the system control portion 51 instructs the video conversion control portion 61 to execute the 3D outputting process. The video conversion control portion 61, receiving the instruction mentioned above from the system control portion 51, instructs the video conversation processor portion 32 to divide the video signal inputted into the video for use of the left-side eye and the video for use of the right-side eye and to treat a process, such as, scaling, etc. (details will be mentioned later). The video conversation processor portion 32 outputs the video signal converted from the video output portion 41, or displays the video on the display, which is equipped with the receiving apparatus 4.

Explanation will be given about said reproducing/outputting/displaying method of the 3D video, by referring to FIGS. 39A and 39B.

FIG. 39A is a view for explaining the reproducing/outputting/displaying method for dealing with the output and the display of the frame sequential method, which displays and outputs, alternately, the videos of the left and the right viewpoints of the 3D content of the Side-by-Side method or the Top-and-Bottom method. Although illustration is given together with the explanation of the Side-by-Side method and the Top-and-Bottom method, as the encoded videos; however, since an aspect differing from between the both lies only in that, the arrangement of the video for use of the left-side eye and the video for use of the right-side eye within the video, therefore in the explanation, which will be given hereinafter, the explanation will be made by using the Side-by-Side method, but the explanation of the Top-and-Bottom method be omitted. The frame line (L1/R1, L2/R2, L3/R3 . . . ) shown on the left-hand side in the figure presents the video signal of the Side-by-Side method, in which the videos for use of the left-side eye and for use of the right-side eye are arranged on the left side/the right side of one (1) frame. In the video decoder portion 30 are decoded the video signals of the Side-by-Side method, under the condition of being disposed on the left side/the right side of one (1) frame of the videos for use of the left-side eye and for use of the right-side eye, and in the video conversion processor portion 32, each frame of the decoded video signals of the Side-by-Side method mentioned above is divided to be the video for use of the left-side eye or the video for use of the right-side eye, and is further treated with the scaling (i.e., carrying out extension/interpolation so as to fit to the horizontal size of an output video, or compression/thinning, etc.). Further, as is shown by the frame line (L1, R1, L2, R2, L3, R3 . . . ) on the right-hand side in the figure, the frames are outputted, alternately, as the video signals.

In FIG. 39A, since the process after converting the frames, alternately, into output/display signals to be outputted/displayed, and the outputting of the sync signal and/or the control signal, etc., is same to the 3D reproducing/outputting/displaying process of the 3D content of the 3D 2-viewpoints separate ES transmission method, which was already explained in FIG. 37A, previously, therefore the explanation thereof will be omitted here.

FIG. 39B is a view for explaining a reproducing/outputting/displaying method for dealing with the output and/or display of a method of displaying the videos having the left/right viewpoints of the 3D content, of the Side-by-Side method or the Top-and-Bottom method, in the different areas or regions on the display. In similar as is shown in FIG. 39A, although there is described and illustrated the explanation of the Side-by-Side method and the Top-and-Bottom method, together with, as the encoded video; however, since an aspect differing from between the both lies only in the arrangement of the video for use of the left-side eye and the video for use of the right-side eye within the video, therefore in the explanation, which will be given hereinafter, the explanation will be given with using the Side-by-Side method, but the explanation of the Top-and-Bottom method be omitted. The frame line (L1/R1, L2/R2, L3/R3 . . . ) shown on the left-hand side in the figure presents the video signal of the Side-by-Side method, in which the videos for use of the left-side eye and for use of the right-side eye are arranged or disposed on the left side/the right side of one (1) frame. In the video decoder portion 30 are decoded the video signals of the Side-by-Side method, under the condition of being disposed on the left side/the right side of one (1) frame of the videos for use of the left-side eye and for use of the right-side eye, and in the video conversion processor portion 32, each frame of the decoded video signals of the Side-by-Side method mentioned above is divided to be the video for use of the left-side eye or the video for use of the right-side eye, and is further treated with the scaling (i.e., carrying out extension/interpolation so as to fit to the horizontal size of an output video, or compression/thinning, etc.). Further, the video for use of the left-side eye and the video for use of the right-side eye, on which the scaling is treated, are outputted or displayed in the different areas or regions. Similar to the explanation given in FIG. 37B, herein, for the purpose of displaying the videos in the different areas or regions, there is a method of, for example, displaying them with using odd number lines and even number lines of the display as display areas or regions for use of the main viewpoint (the left-side eye) and for use of the sub-viewpoint (the right-side eye), respectively, and so on. As other than that, but the process for displaying in the different regions and the method for displaying on the display device of the polarization light method are similar to the 3D reproducing/outputting/displaying process for the 3D content of the 3D 2-viewpoints separated ES transmission method, which was explained in FIG. 37B, and therefore the explanation thereof will be omitted herein.

With the method shown in FIG. 39B, there is a case where the respective vertical resolutions must be reduced, when outputting or displaying the video for use of the left-side eye and the video for use of the right-side eye on the odd-numbered lines and the even-numbered of the respective displays, even if the vertical resolution of the display is equal to the vertical resolution of the input video; however, in such case, it is also enough to execute the thinning corresponding to the display regions for the video for use of the left-side eye and the video for use of the right-side eye, in the scaling process mentioned above.

<2D Output/Display Process for 3D Content of Side-by-Side Method/Top-and-Bottom Method>

Explanation will be given about the operations of each portion when displaying the 3D content of the Side-by-Side method or the Top-and-Bottom method, below. When the user instructs to exchange into the 2D video (for example, pushing down “2D” key on the remote controller, the user instruction receive portion 52 receiving the key code mentioned above instructs the system control portion 51 to exchange the signal into the 2D video (however, in processing given hereinafter, a similar process will be done, even when exchanging into the 2D output/display under the condition other than that the user instructs to exchange into 2D output/display of the 3D content of the Side-by-Side method or the Top-and-Bottom method). The system control portion 51 receiving the instruction mentioned above instructs the video conversion control portion 61 to output the 2D video therefrom. The video conversion control portion 61, receiving the instruct ion mentioned above from the system control portion 51, controls the video conversion processor portion 32 to output the 2D video responding to the inputted video signal mentioned above.

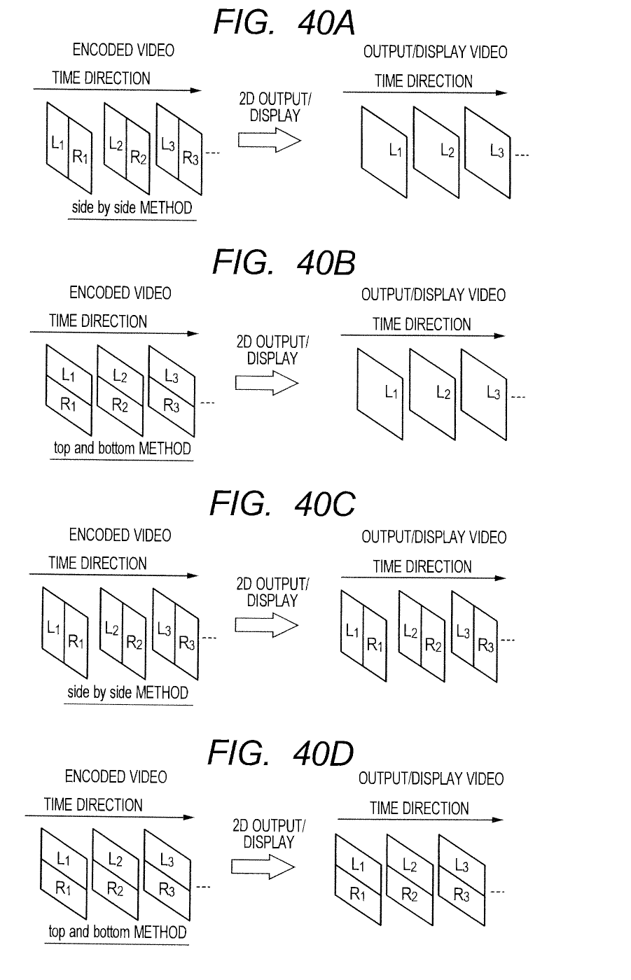

Explanation will be given on the existing 2D output/display method, by referring to FIGS. 40A through 40D. FIG. 40A illustrates the explanation of the Side-by-Side method, while FIG. 40B the Top-and-Bottom method; however, in either of them, the difference lies only in the arrangements of the video for use of the left-side eye and the video for use of the right-side eye within the video, and therefore the explanation will be made by referring to the Side-by-Side method shown in FIG. 40A. The frame line (L1/R1, L2/R2, L3/R3 . . . ) shown on the left-hand side in the figure presents the video signal of the Side-by-Side method, in which the video signals for use of the left-side eye and for use of the right-side eye are disposed on the left side/the right side of one (1) frame. The video conversion processor portion 32 divides each frame of the above-mentioned video signal of the Side-by-Side method, which is inputted, into each frame of the video for use of the left-side eye or the video for use of the right-side eye, and thereafter treats the scaling only upon a portion of the main viewpoint video (e.g., the video for use of the left-side eye); thereby outputting only the main viewpoint video (e.g., the video for use of the left-side eye) as the video signal, as is shown by the frame line (L1, L2, L3 . . . ) on the right-hand side in the figure.

The video conversion processor portion 32 outputs the video signal, being conducted with the process mentioned above, as the 2D video from the video output portion 41, and also outputs the control signal from the control signal output portion 43. In this manner, the 2D output/display is conducted.

However, there is an example of doing the 2D output/display while keeping the 3D content of the Side-by-Side method or the Top-and-Bottom method, as it is, i.e., storing 2 viewpoints in one (1) screen, and such a case will be shown in FIGS. 40C and 40D. For example, as is shown in FIG. 36, in case where the receiving apparatus and the viewing/listening device are separated in the structures thereof, etc., the video may be outputted from the receiving apparatus, while keeping to store the videos of the 2 viewpoints of Side-by-Side method or the Top-and-Bottom method in one (1) screen, and the conversion for the 3D display may be conducted in the viewing/listening device.

<Example of 2D/3D Video Display Process Upon Basis of if Present Program is 3D Content or not>

Next, explanation will be given about an output/display process of the content, in particular, when the present program is 3D content, or the present program becomes the 3D content. In regard with viewing/listening of the 3D content when the present program is the 3D content program or when it becomes the 3D content program, if the display of the 3D content is done, unconditionally, then the user cannot view/listen that content; i.e., there is a possibility of spoiling the convenience for the user. On the contrary to this, if doing the processing, which will be shown blow; it is possible to improve the convenience for the user.

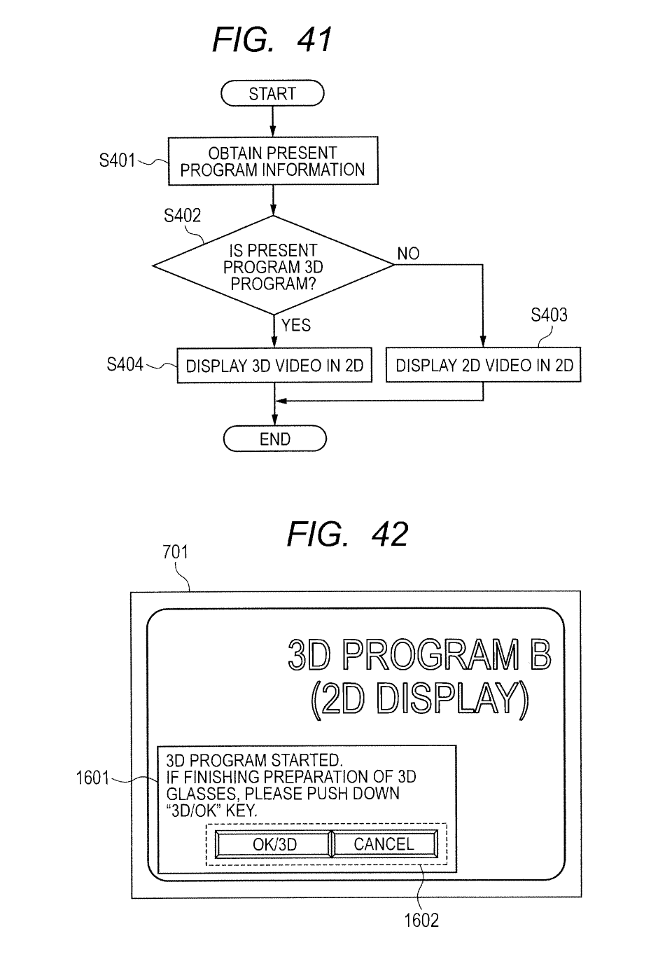

FIG. 41 shows an example of a flow of processes of the system control portion 51, which is executed at an opportunity, such as, change of the present program and/or the program information at the time when the program is exchanged. The example shown in FIG. 41 is a flow for executing the 2D display, at first, of one viewpoint (for example, the main viewpoint), even if being the 2D program or the 3D program.

The system control portion 51 obtains the program information of the present program from the program information analyze portion 54, so as to determine if the present program is the 3D program or not, with the method for determining the 3D program mentioned above, and further obtain the 3D method type of the present program (for example, determined from the 3D method type, which is described in the 3D program details descriptor, such as, 2-viewpoints separate ES transmission method/Side-by-Side method, etc.), from the program information analyze portion 54 (S401). However, the program information of the present program may be obtained, periodically, not limited to the time when the program is exchanged.

As a result of determination, if the present program is not the 3D program (“no” in S402), such a control is conducted that the video of 2D is displayed in 2D (S403).

If the present program is the 3D program (“yes” in S402), the system control portion 51 executes such a control that one viewpoint (for example, the main viewpoint) of the 3D video signal is displayed in 2D, in the format corresponding to the respective 3D method type, with the methods, which are explained in FIGS. 38 and 40A and 40B (S404). In this instance, a display indicative of being the 3D program may be displayed on the 2D display video of the program, superimposing it thereon. In this manner, when the present program is the 3D program, the video of the one viewpoint (for example, the main viewpoint) is displayed in 2D.

Further, also when the present program is change due to conduction of the tuning operation, such flow as was mentioned above shall be executed in the system control portion 51.

In this manner, when the present program is the 3D program, for the time being, the video of one viewpoint (for example, the main viewpoint) is displayed in 2D. With doing so, for the time being, the user can view/listen it, in the similar manner to that when being the 2D program, if the user is not ready for the 3D viewing/listening, such as, the user does not wear the 3D view/listen assisting device, etc. In particular, in case of the 3D content of the Side-by-Side method or the Top-and-Bottom method, not outputting the video as it is, i.e., storing 2 views in one (1) screen, as is shown in FIGS. 40C and 40D, but outputting/displaying the video of one viewpoint in 2D, as is shown in FIGS. 40A and 40B, it is possible, for the user, to view/listen the 3D program, in the similar manner to that of the 2D program, ordinarily, but without giving an instruction to display the video of one viewpoint between those of the two (2) viewpoints stored in one (1) screen, by the user, manually, through the remote controller, etc.

Next, FIG. 42 shows an example of a message, the video of which is displayed in 2D in the step S404 and is displayed by the system control portion 51 through the OSP produce portion 60. With this, a message is displayed for informing the user that the 3D program is started, and further an object 1602 (hereinafter, being called “a user response receiving object; for example, a button in the OSD) for the user to make a response thereto, is displayed thereon, so as to let her/him to select the operation thereafter.

Upon display of the message 1601, for example, when the user pushes down an “OK” button on the remote controller, the user instruction receive portion 52 inform the system control portion 51 that the “OK” is pushed down.

As an example of a method for determining the user selection on the screen display shown in FIG. 42, for example, when the user, operating the remote controller, pushes down a <3D> button on the remote controller through operation by the user on the remote controller, or when she/he pushes down the <OK> button on the remote controller while fitting a cursor to “OK/3D” on the screen, the user selection is determined as “exchange to 3D”.

Also, when the user pushes down a <cancel> button or a <return> button on the remote controller, or when she/he pushes down the <OK> while fitting the cursor to “cancel” on the screen, the user selection is determined is “other than exchange to 3D”. Other than those, for example, when such an operation is made that it brings the condition indicative of, if preparation is completed or not, by the user, for the 3D viewing/listening (i.e., 3D view/listen preparation condition), into “OK” (for example, wearing the 3D glasses), then the user selection comes to “exchange to 3D”.

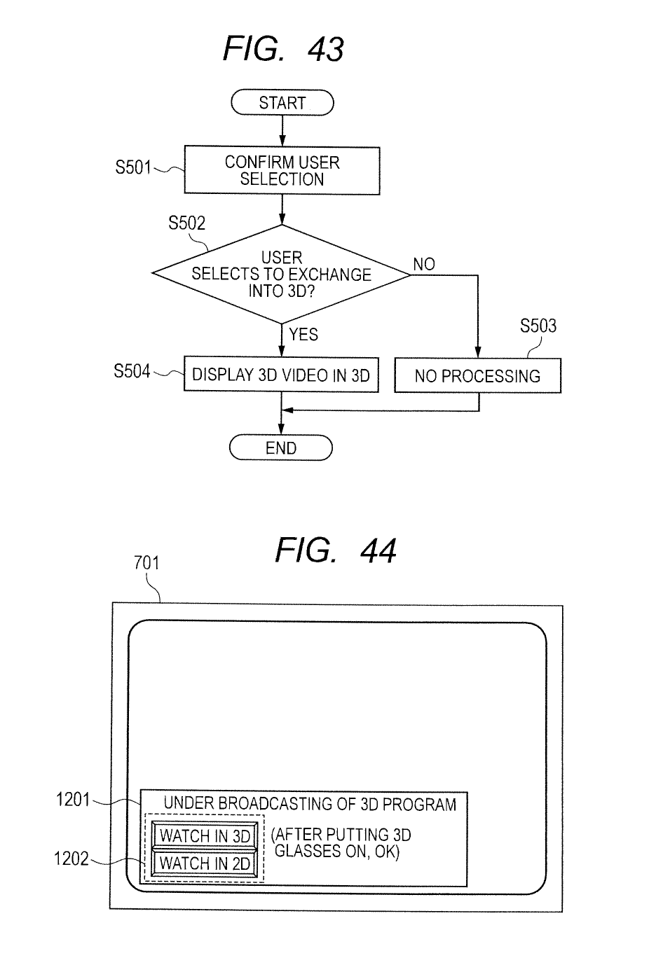

A flow of processes in the system control portion 51, to be executed after the user selects is shown in FIG. 43. The system control portion 51 obtains a result of the user select from the user instruction receive portion 52 (S501). If the user select is not “exchange to 3D” (“no” in S502), then the video ends while being displayed in 2D, no particular process is executed.

If the user select is “exchange to 3D” (“yes” in S502), the video is displayed in 3D in accordance with the 3D displaying method mentioned above.

With the flow mentioned above, when the 3D program starts, it is possible for the user to view/listen the video in 3D by outputting/displaying the 3D video, when she/he wishes to do the 3D viewing/listening, such as, when the user has done the operations and/or preparation for 3D viewing/listening, while outputting/displaying the video of the one viewpoint.

However, in the example of display shown in FIG. 42, although the object is displayed for the user to respond; however, it may be only that of displaying a letter, or a logo or a mark, etc., only for indicating that said program is that enabled with “3D view/listen”, such as, simply, “3D program”, etc. In this case, for the user recognizing that the program is enabled with “3D view/listen”, it is enough to push down the “3D” key on the remote controller, so as to exchange from the 2D display into the 3D display at an opportunity of a notice from the user instruction receive portion 52, which receives the signal from that remote controller, to the system control portion 51.

Further, as other example of the message display to be displayed in the step S404, there may be considered a method, displaying only “OK”, simply, but also clearly indicating or asking if the method for displaying the program should be that for the 2D video or for the 3D video. Examples of the message and the user response receiving object in that case are shown in FIG. 44.

With doing so, comparing to such display “OK” as is shown in FIG. 42, other than for the user it is possible to decide the movement after pushing down the button, easily, it is possible to instruct to display in 2D, in a clear manner, etc. (i.e., the user 3D view/listen preparation condition is determined “NG” when pushing down “watch in 2D” described by 1202,), the convenience can be increased.

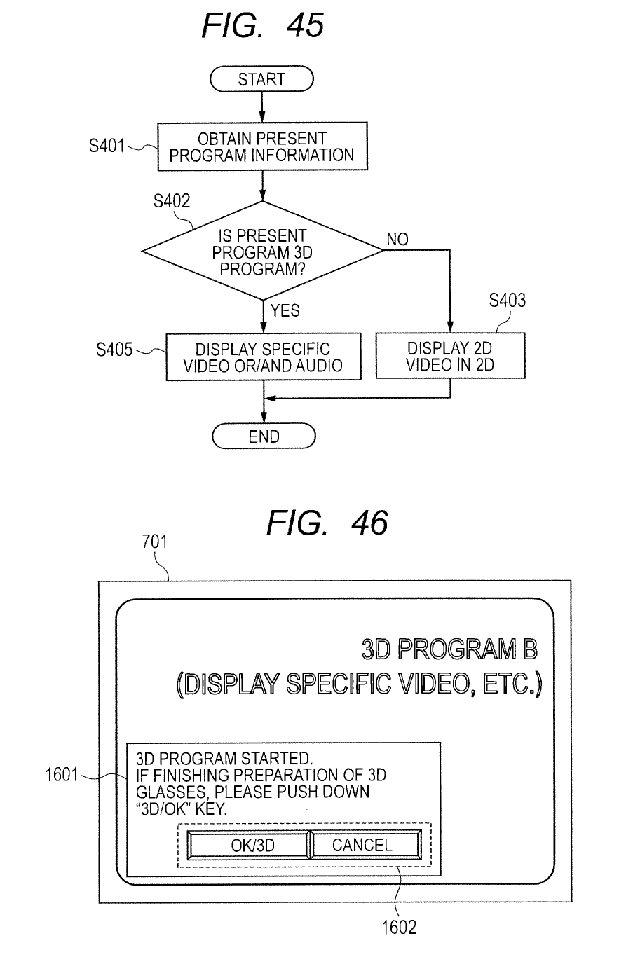

Next, in relation to the 3D content, explanation will be given on an example of outputting a specific video/audio or muting the video/audio (e.g., a black screen display/stop of display and stop of audio output), when starting the 3D program view/listen. This is because there is a possibility of losing the convenience for the user, since the user cannot view/listen the that content if starting the display of the 3D content, unconditionally, when the user starts the view/listen of the 3D program. On the contrary to this, by executing the processing, which will be shown below, it is possible to improve the convenience of the user. A processing flow executed in the system control portion 51 when the 3D program starts is shown in FIG. 45. An aspect differing from the processing flow shown in FIG. 41 lies in that a step for outputting a specific video/audio (S405) is added, in the place of the processing of S404.

As the specific video/audio mentioned herein can be listed up, if it is the video, a message of paying an attention to preparation of 3D, a black screen, s still picture of the program, etc., while as the audio can be listed up a silence, or music of fixed pattern (e.g., an ambient music), etc. With displaying a video of fixed pattern (e.g., a message or an ambient picture, or the 3D video, etc.), it can be achieved by reading out the data thereof, from the inside of the video decoder portion 30 or the ROM not shown in the figure or the recording medium 26, thereby to be outputted after being decoded. With outputting the black screen, it can be achieved by, for example, the video decoder portion 30 outputting the video of signals indicating only a black color, or the video conversion processor portion 32 outputting the mute or the black video as the output signal.

With displaying a video of fixed pattern (e.g., a message or an ambient picture, or the 3D video, etc.), it can be achieved by reading out the data thereof, from the inside of the video decoder portion 30 or the ROM not shown in the figure or the recording medium 26, thereby to be outputted after being decoded. With outputting the black screen, it can be achieved by, for example, the video decoder portion 30 outputting the video of signals indicating only a black color, or the video conversion processor portion 32 outputting the mute or the black video as the output signal.

Also, incase of the audio of fixed pattern (e.g., the silence or the ambient music), in the similar manner, it can be achieved by reading out the data, for example, within the audio decoder potion 31 or from the ROM or the recording medium 26, thereby to be outputted after being decoded, or by muting the output signal, etc.

With outputting of the still picture of the program video, it can be achieved by giving an instruction of a pause of the reproduction of program or the video, from the system control portion 51 to the recording/reproducing control portion 58. The processing in the system control portion 51, after execution of the user selection, will be carried out, in the similar manner mentioned above, as was shown in FIG. 43.

With this, it is possible to achieve no output of the video and the audio of the program, during the time period until when the user completes the preparation for 3D view/listen.

In the similar manner to the example mentioned above, as the message display to be displayed in the step S405, it is as shown in FIG. 46. An aspect differing from those shown in FIG. 42 lies only in the video and the audio, which are displayed; but, the configurations of the message and/or the user response receiving object to be displayed and the operation of the user response receiving object are same to those.

Regarding display of the message, not only displaying “OK”, simply, as was shown in FIG. 46, but there can be considered a manner of clearly indication or asking if the display method of the program should be the 2D video or the 3D video. Examples of the message and the user response receiving object in that case can be displayed, similar to those shown in FIG. 44, and if doing so, comparing to such display of “OK” as was mentioned above, in addition to that the user can easily decide the operation(s) after pushing down the button, she/he can instruct the display in 2D, clearly, etc.; i.e., the convenience is increased, in the similar manner to that of the example mentioned above.

<Example of Processing Flow for Displaying 2D/3D Video Upon Basis of if Next Program is 3D Content or not>

Next, explanation will be given on an outputting/displaying process for the content when the next program is the 3D content. In relation to the view/listen of the 3D content program, i.e., to being said next program when the next coming program is the 3D content, there is a possibility of losing the convenience for the user, since the user cannot view/listen that content under the best condition, if display of the 3D content starts, irrespective of the fact that the user is not in the condition of enabling to view/listen the 3D content. On the contrary to this, with doing such processing as will be shown blow, it is possible to improve the convenience for the user.

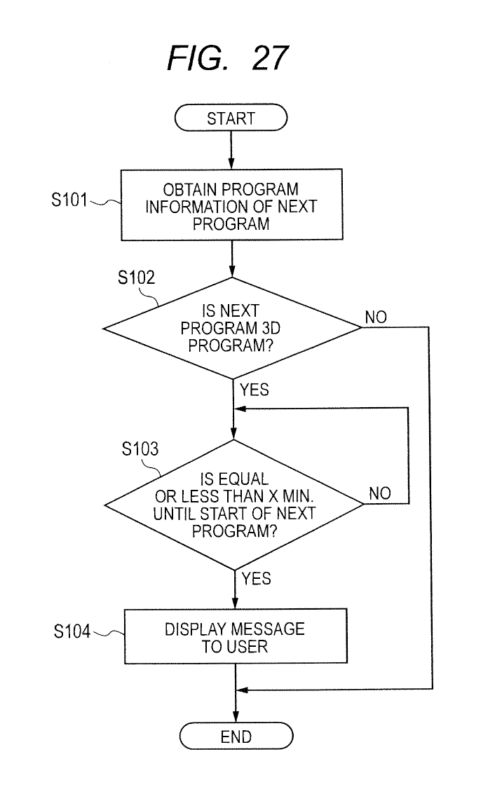

FIG. 27 shows an example of a flow to be executed in the system control portion 51, when the time-period until starting of the next program is changed due to the tuning process or the like, or when it is determined that the time of starting of the next program is changed, because of the staring time of the next program, which is included in the EIT of the program information transmitted from the broadcasting station, or the information of ending time of the present program, etc. First of all, the system control portion 51 obtains the program information of the next coming program from the program information analyze portion 54 (S101), and determines if the next program is the 3D program or not, in accordance with the determining method of the 3D program mentioned above.

When the next coming program is not the 3D program (“no” in S102), the process is ended, but without doing any particular processing. When the next coming program is the 3D program (“yes” in S102), calculation is done on the time-period until when the next program starts. In more details, the starting time of the next program or the ending time of the present program is obtained from the EIT of the obtained program information mentioned above, while obtaining the present time from the time management portion 55, and thereby calculating the difference between them.

When the time-period until the next program starts is equal to or less than “X” minutes (“no” in S103), waiting is made until when it comes to “X” minutes before the next program start, without doing any particular processing. If it is equal to or less than “X” minutes until when the next program starts (“yes” in S103), a message is displayed indicating that a 3D program will begin soon, to the user (S104).

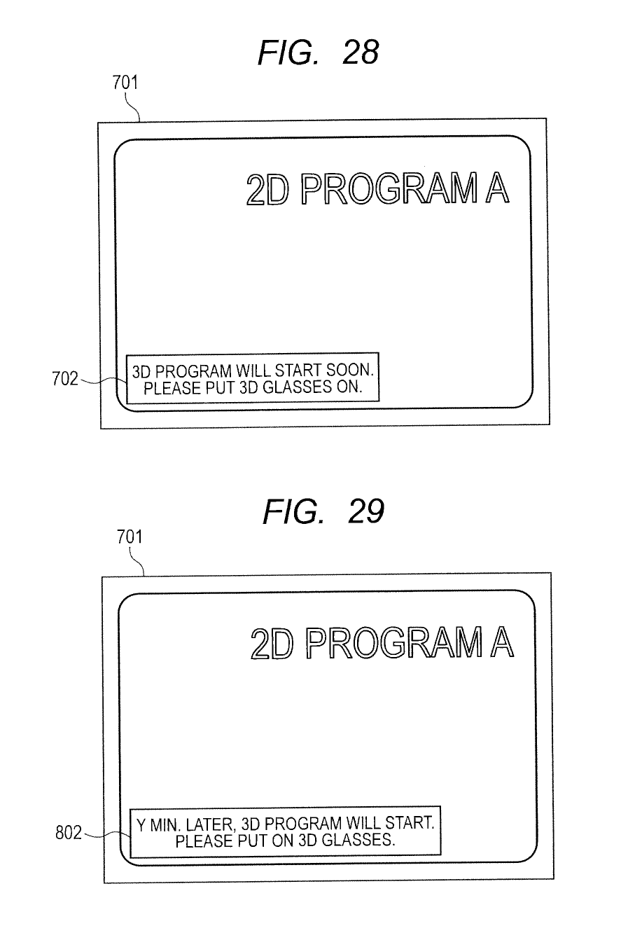

FIG. 28 shows an example of the message to be shown in that instance. A reference numeral 701 depicts the entire of screen that the apparatus displays, and 702 the message itself that the apparatus displays, respectively. In this manner, it is possible to call an attention for the preparation of the 3D view/listen assisting device to the user, before the 3D program starts.

Regarding the above-mentioned time “X” for determination until the time when the program starts, if it is made small, there is a possibility of not being in time for preparation of the 3D view/listen by the user until starting of the program. Or, if making it large, then there is brought about demerits, such as, preventing the message display for a long time, and also generating a pause after completion of the preparation; therefore, it must be adjusted at an appropriate time-period.

Also, the starting time of the next coming program may be displayed, in the details thereof, when displaying the message to the user. An example of the screen display in that case is shown in FIG. 29. A reference numeral 802 is the message displaying the time until when the 3D program starts. Herein, although the time is described by a unit of minute, however it may be described by a unit of second. In that case, although the user is able to know the starting time of the next program, in more details thereof, but there is also a demerit of increasing a processing load.

However, although the example is shown in FIG. 29, of displaying the time-period until the 3D program starts, but in the thereof may be displayed a time when the 3D program starts. In case where the 3D program is started at 9:00 PM, there may be displayed a message, such as, “3D program will starts from 9:00 PM. Please wear 3D glasses.” for example.

With making displaying of such message, for the user, it is possible to know the starting time of the next coming program, in details thereof, and thereby to make the preparation for 3D view/listen at an appropriate pace.

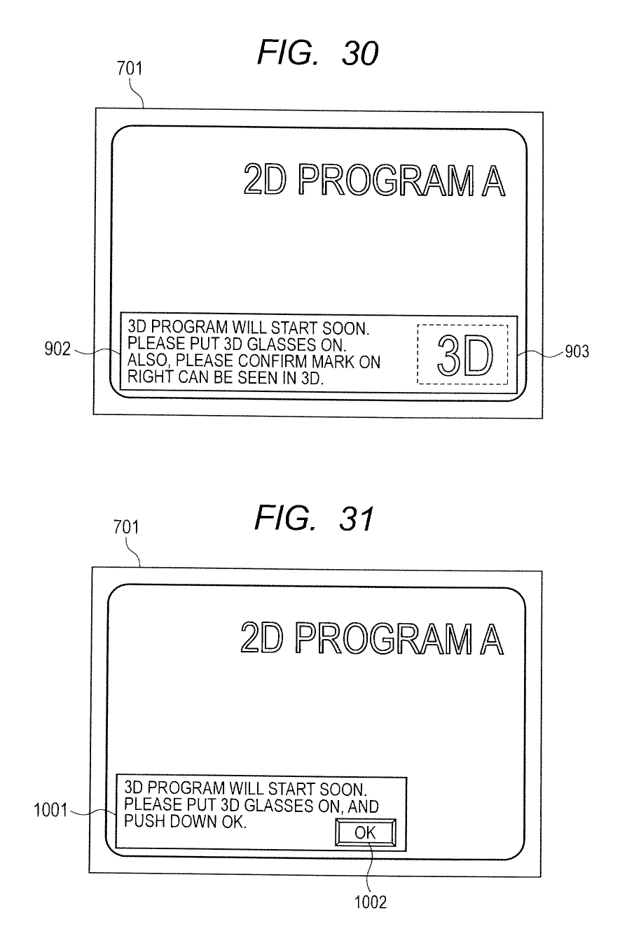

Also, as is shown in FIG. 30, when using the 3D view/listen assisting device, it can be considered to add a mark (e.g., a 3D checkmark), which can be seen three-dimensionally. A reference numeral 902 depicts the message for alerting the start of the 3D program, and 903 the mark, which can be seen three-dimensionally when the user uses the 3D view/listen assisting device. With this, for the user, it is possible to confirm a normal operation of the 3D view/listen assisting device, before the 3D program starts. It is also possible, for example, to do a countermeasure, such as, mending or replacing, etc., until starting of the program, if malfunctioning (for example, shortage of a battery, a trouble, etc.) is generated in the 3D view/listen assisting device.

Next, explanation will be given about a method for exchanging the video of the 3D program into the 2D display or the 3D display, by determining the condition of whether the 3D view/listen preparation by the user is completed or not (3D view/listen preparation condition), after noticing that the next coming program is the 3D to the user.

In relation to the method for noticing to the user that the next coming program is the 3D, it is as was mentioned above. However, in relation to the message to be displayed for the user in the step S104, it differs from in that there is displayed the object, to which the user makes a response (hereinafter, being called a “user response receiving object: for example, a button on the OSD). An example of this message is shown in FIG. 31.

A reference numeral 1001 depicts an entire of the message, and 1002 a button for the user to make the response, respectively. In case where the user pushes down the “OK” button of the remote controller, for example, when displaying the message 1001 shown in FIG. 31, the user instruction receive portion 52 notices to the system control portion 51 that the “OK” is pushed down.

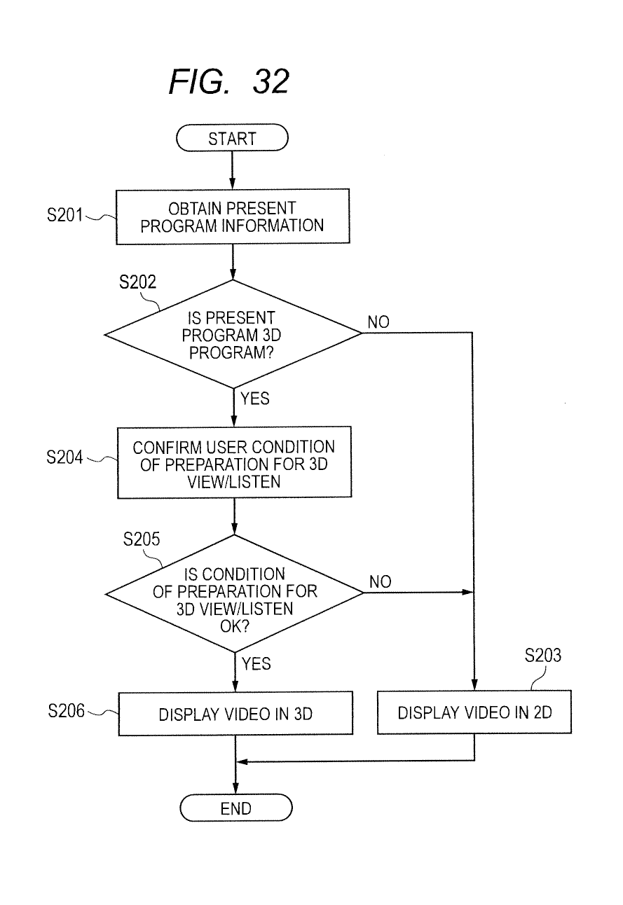

The system control portion 51 receiving the notice mentioned above stores the fact that the 3D view/listen preparation condition is “OK”, as a condition. Next, explanation will be given on a processing flow in the system control portion when the present program changes to the 3D program, after an elapse of time, by referring to FIG. 32.

The system control portion 51 obtains the program information of the present program from the program information analyze portion 54 (S201), and determines if the present program is the 3D program or not, in accordance with the method mentioned above, for determining the 3D program. When the present program is not the 3D program (“no” in S202), such a control is executed that the video is displayed in 2D in accordance with the method mentioned above (S203).

When the present program is the 3D program (“yes” in S202), next, confirmation is made on the 3D view/listen preparation condition of the user (S204). When the 3D view/listen preparation condition stored by the system control portion 51 is not “OK” (“no” in S205), as is similar to the above, the control is made so as to display the video in 2D (S203).

When the 3D view/listen preparation condition mentioned above is “OK” (“yes” in S205), the control is made so as to display the video in 3D, in accordance with the method mentioned above (S206). In this manner, the 3D display of the video is executed, when it can be confirmed that the present program is the 3D program and that the 3D view/listen preparation is completed.

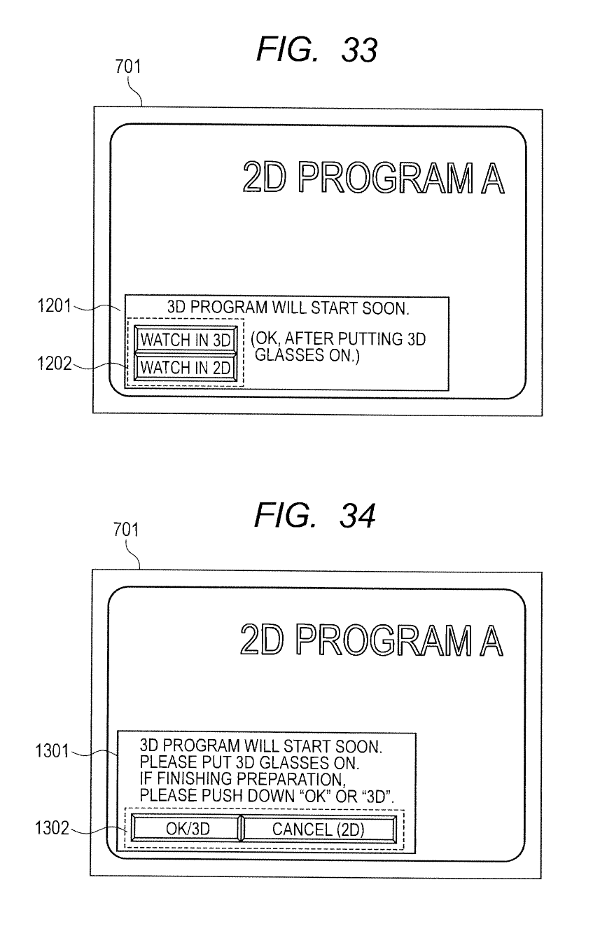

As the message display to be displayed in the step S104, there can be considered, not only displaying “OK” simply, as is shown in FIG. 41, but also clearly indication or asking if the display method of the next coming program should be the 2D video or the 3D video. Examples of the message and the user response receiving object in that case are shown in FIGS. 33 and 34.

With doing so, comparing to the display of only “OK” mentioned above, other than that the user can easily decide the operation(s) after pushing down of the button, she/he can instruct clearly, in 2D, etc. (the user 3D view/listen preparation condition is determined “NG”, when the “watch in 2D” shown by 1202 is pushed down); increasing the convenience.

Also, though explaining that the determination on the 3D view/listen preparation condition of the user is made upon the operation on the menu by the user through the remote controller, herein; however, other than that may be applied a method of determining the 3D view/listen preparation condition mentioned above, upon basis of a user wearing completion signal, which the 3D view/listen assisting device generates, or a method of determining that she/he wears the 3D view/listen assisting device, by photographing a viewing/listening condition of the user by an image pickup or photographing device, so as to make an image recognition or a face recognition of the user from the result of photographing.

With making the determining in this manner, it is possible to eliminate a trouble, such as, the user makes any operation to the receiving apparatus, and further it is also possible to avoid her/him from mischievously setting up between the 2D video view/listen and the 3D video view/listen through an erroneous operation.

Also, as other method, there is a method of determining the 3D view/listen preparation condition be “OK” when the user pushes down the <3D> button of the remote controller, or a method of determining the 3D view/listen preparation condition be “OK” when the user pushes down a <2D> button or a <return> button or a <chancel> button of the remote controller. In this case, for the user, it is possible to notice the condition of herself/himself, clearly and easily, to the apparatus; however, there can be considered a demerit, such as, transmission of the condition caused due to an error or misunderstanding, etc.

Also, in the example mentioned above, it can be considered to execute the processing while making the determination only on the program information of the next coming program, which is obtained previously, without obtaining the information of the present program. In this case, in the step S201 shown in FIG. 32, there can be considered a method of using the program information, which is obtained previously (for example, in the step S101 shown in FIG. 27), without make determination of whether the present program is the 3D program or not. In this case, there can be considered a merit, such as, the processing configuration becomes simple, etc.; however, there is a demerit, such as, a possibility that the 3D video exchange process is executed even in the case where the next coming program is not the 3D program, due to a sudden change of the program configuration.

With the message display to each user, which was explained in the present embodiment, it is desirable to delete it after the user operation. In that case, there is a merit that the user can view/listen the video, easily, after making the operation. Also, after elapsing of a certain time-period, on an assumption that the user already recognized the information of the message, in the similar manner to the above, deleting the message, i.e., bringing the user into a condition she/he can view/listen the video, easily, increases the convenience for the user.

With the embodiment explained in the above, for the user, it is possible to view/listen the 3D program under the condition much better, in particular, in a starting part of the 3D program; i.e., the user can complete the 3D view/listen preparation, in advance, or can display the video, again, after completing the preparation for viewing/listening the 3D program by the user, is with using the recording/reproducing function, when she/he is not in time for starting of the 3D program. Also, it is possible to increase the convenience for the user; i.e., automatically exchanging the video display into that of a display method, which can be considered desirable or preferable for the user (e.g., the 3D video display when she/he wishes to view/listen the 3D video or the contrary thereto). Also, there can be expected a similar effect, when the program is changed into the 3D program through tuning, or when reproduction of the 3D program recorded starts, etc.

In the above, the explanation was given on the example of transmitting the 3D program details descriptor, which was explained in FIG. 10A, while disposing it in the table, such as, the PMT (Program Map Table) or the EIT (Event Information Table), etc. In the place of this, or in addition to this, it is also possible to transmit the information, which is included in said 3D program details descriptor, while storing it in a user data area or an additional information area, to be encoded together with the video when the video is encoded. In this case, those information are included within the video ES of the program.

As an example of the information to be stored, there can be listed up: the “3d_{—}3d_type” (type of 2D/3D) information, which is explained in FIG. 10B, and the “3d_method_type” (type of the 3D method) information, which is explained in FIG. 11. However, when storing, the “3d_{—}3d_type” (type of 2D/3D) information and the “3d_method_type” (type of the 3D method) information may be separated, but it is also possible to build up information to identify if being the 3D video or the 2D video and to identify which 3D method that 3D program has, together.

In more details, when the video encoding method is the MPEG 2 method, encoding may be executed thereon, including the 3D/2 type information and the 3D method type information mentioned above in the user data area following “Picture Head” and “Picture Coding Extension”.

Also, when the video encoding method is the H.264/AVC, encoding may be executed thereon, including the 3D/2 type information and the 3D method type information mentioned above in the addition information (e.g., supplement enhancement information) area, which is included in an access unit.

In this manner, with transmitting the information indicating the type of the 3D video/2D video and the information indicating the type of the 3D method, on an encoding layer within the ES, there is an effect of enabling to identify the video upon basis of a frame (or, picture) unit.

In this case, since the identification mentioned above can be made by using a unit shorter than that when storing it in the PMT (Program Map Table), it is possible to improve or increase a speed of the receiver responding to the exchanging between the 3D video/2D video in the video to be transmitted, and also to suppress noises, much more, which can be generated when exchanging between the 3D video/2D video.

Also, when storing the information mentioned above on the video encoding layer to be encoded, together with the video, when encoding the video, but without disposing the 3D program details descriptor mentioned above on the PMT (Program Map Table), the broadcast station side may be constructed, for example, only the encode portion 12 in the transmitting apparatus 1 shown in FIG. 2 is renewed to be enabled with a 2D/3D mixed broadcasting; there is no necessity of chaining the structure of the PMT (Program Map Table) to be added in the management information supply portion 16, and therefore it is possible to start the 2D/3D mixed broadcasting with a lower cost.

However, if 3D related information (in particular, the information for identifying 3D/2D), such as, the “3d_{—}2d_type” (type of 3D/2D) information and/or the “3d_method_type” (type of the 3D method) information, for example, is not stored within the predetermined area or region, such as, the user data area and/or the additional information area, etc., which is/are to be encoded together with the video when encoding the video, the receiver may be constructed in such manner that it determines said video is the 2D video. In this case, for the broadcasting station, it is also possible to omit storing of those information when it processes the encoding, and therefore enabling to reduce a number of the processes in broadcasting.

In the explanation in the above, as an example of disposing or arranging the identification information for identifying the 3D video, upon basis of the program (the event) unit or the service unit, the explanation was given on the example of including it within the program information, such as, the component descriptor, the component group descriptor, the service descriptor, and the service list descriptor, etc., or the example of newly providing the 3D program details descriptor. Also, those descriptors are explained to be transmitted, being included in the table(s), such as, PMT, EIT [schedule basic/schedule extended/present/following], NIT, and SDT, etc.

Herein, as a further other example, explanation will be given on an example of disposing the identification information of the 3D program (the event) in the content descriptor shown in FIG. 48.

FIG. 48 shows an example of the structure of the content descriptor, as one of the program information. This descriptor is disposed in the EIT. In the content descriptor can be described the information indicative of program characteristics, other than genre information of the event (the program).

The structure or configuration of the content descriptor is as follows. “descriptor_tag” is a field of 8 bits for identifying the descriptor itself, in which a value “0x54” is described so that this descriptor can be identified as the content descriptor. “descriptor_length” is a field of 8 bits, in which a size of this descriptor is described.

“content_nibble_level_{—}1” (genre 1) is a field of 4 bits, and this presents a first stage grouping or classification of the content identification. In more details, there is described a large group of the program genre. When indicating the program characterstics, “0xE” is designated.

“content_nibble_level_{—}2” (genre 2) is a field of 4 bits, and this presents a second stage grouping or classification of the content identification, in more details thereof comparing to the “content_nibble_level_{—}1” (genre 1). In more details, a middle grouping of the program genre is described therein. When the “content_nibble_level_{—}1”=“0xE”, a sort or type of a program characteristic code table.

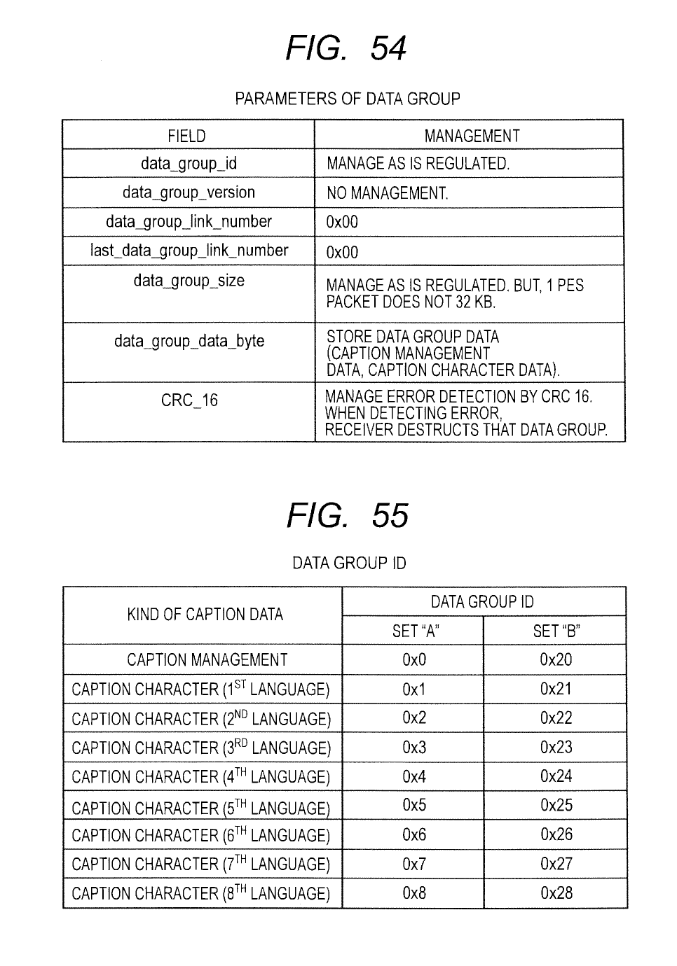

“user_nibble” (user genre) is a field of 4 bits, in which the program characteristics are described only when “content_nibble_level_{—}1”=“0xE”. In other cases, it should be “0xFF” (not-defined). As is shown in FIG. 54, the field of 4 bits of the “user_nibble” can be disposed by two (2) pieces thereof, and upon combination of the values of two (2) pieces of “user_nibble” (hereinafter, bits disposed in front being called “first user_nibble” bits, while bits disposed in the rear “second user_nibble”) bits, it is possible to define the program characteristics.

The receiver receiving that content describer determines that said described is the content describer when the “descriptor_tag” is “0x54”. Also, upon the “descriptor_length” it can decide an end of the data, which is described within this describer. Further, it determine the description, being equal to or shorter than the length presented by the “descriptor_length”, to be valid, while neglecting a portion exceeding that, and thereby executing the process.

Also, the receiver determines“content_nibble_level_{—}1” if the value thereof is “0xE” or not, and determines as the large group of the program genre, when it is not “0xE”. When being “0xE”, determination is not made that it is the genre, but any one of the program characteristics is designated by the “user_nibble” following thereto.

The receiver determines the “content_nibble_level_{—}2” to be the middle group of the program genre when the value of the “content_nibble_level_{—}1” mentioned above is not “0xE”, and uses it in searching, displaying, etc., together with the large group of the program genre. When the “content_nibble_level_{—}1” mentioned above is “0xE”, the receiver determines it indicates the sort of the program characteristic code table, which is defined upon the combination of the “first user_nibble” bits and the “second user_nibble” bits.

The receiver determines the bits to be that indicating the program characteristics upon the basis of the “first user_nibble” bits and the “second user_nibble” bits, when the “content_nibble_level_{—}1” mentioned above is “0xE”. In case where the value of the “content_nibble_level_{—}1” is “0xE”, they are neglected even if any value is inserted in the “first user_nibble” bits and the “second user_nibble” bits.

Therefore, the broadcasting station can transmit the genre information of a target event (the program) to the receiver, by using combination of the value of “content_nibble_level_{—}1” and the value of “content_nibble_level_{—}2”, in case where it does not set the “content_nibble_level_{—}1” to “0xE”.

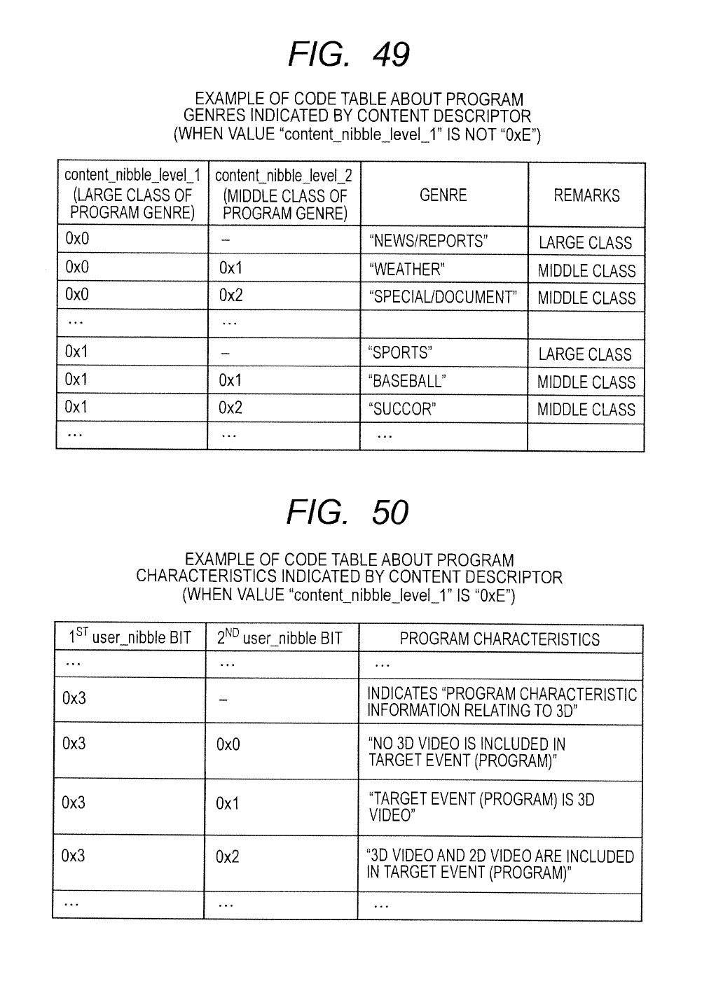

Herein, explanation will be given on the case, for example, as is shown in FIG. 49, wherein the large group of the program genre is defined as “news/reporting” when the value of “content_nibble_level_{—}1” is “0x0”, further defined as “weather” when the value of “content_nibble_level_{—}1” is “0x0” and the value of “content_nibble_level_{—}2” is “0x1”, and defined as “special program/document” when the value of “content_nibble_level_{—}1” is “0x0” and the value of “content_nibble_level_{—}2” is “0x2”, and the large group of the program genre is defined as “sports” when the value of “content_nibble_level_{—}1” is “0x1”, further defined as “baseball” when the value of “content_nibble_level_{—}1” is “0x1” and the value of “content_nibble_level_{—}2” is “0x1”, and is defined as “succor” when the value of “content_nibble_level_{—}1” is “0x1” and the value of “content_nibble_level_{—}2” is “0x2”, respectively.

In this case, for the receiver, it is possible to determine the large group of the program genre, if being “news/reporting” or “sports”, depending on the value of “content_nibble_level_{—}1”, and upon basis of the combination of the value of “content_nibble_level_{—}1” and the value of “content_nibble_level_{—}2”, it is possible to determine the middle group of the program genre, i.e., down to program genres lower than the large group of the program genre, such as, “news/reporting” or “sports”, etc.

However, for the purpose of achieving that determining process, in the memory portion equipped with the receiver may be memorized genre code table information for showing a corresponding relationship between the combination of the values of “content_nibble_level_{—}1” and “content_nibble_level_{—}2”, and the program genre, in advance.

Herein, explanation will be given on a case when transmitting the program characteristic information in relation to the 3D program of the target event (the program) with using that content describer. Hereinafter, the explanation will be given on the case where the identification information of the 3D program is transmitted as the program characteristics, but not the program genre.

Firstly, when transmitting the program characteristic information in relation to the 3D program with using the content describer, the broadcasting station transmits the content describer with setting the value of “content_nibble_level_{—}1” to “0xE”. With doing this, the receiver can determine that the information transmitted by that describer is, not the genre information of the target event (the program), but the program characteristic information of the target event (the program). Also, with this, it is possible to determine that the “first user_nibble” bits and the “second user_nibble” bits, which are described in the content describer, indicate the program characteristic information by the combination thereof.

Herein, explanation will be given on the case, for example, as is shown in FIG. 50, wherein the program characteristic information of the target event (the program), which that content describer transmits, is defined as “program characteristic information relating to 3D program” when the value of “first user_nibble” bits is “0x3”, the program characteristics are defined as “no 3D video is included in target event (program)” when the value of “first user_nibble” bits is “0x3” and the value of “second user_nibble” bits is “0x0”, the program characteristics are defined as “video of target event (program) is 3D video” when the value of “first user_nibble” bits is “0x3” and the value of “second user_nibble” bits is “0x1”, and the program characteristics are defined as “3D video and 2D video are included in target event (program)” when the value of “first user_nibble” bits is “0x3” and the value of “second user_nibble” bits is “0x2”, respectively.

In this case, for the receiver, it is possible to determine the program characteristics relating to the 3D program of the target event (the program), upon basis of the combination of the value of “first user_nibble” bits and the value of “second user_nibble” bits; therefore, the receiver receiving the EIT, including that content describer therein, can display an explanation on the electronic program table (EPG) display, in relation to program(s), which will be received in future or is received at present, that “no 3D video is included” therein, or that said program is “3D video program”, or that “3D video and 2D video are included” in said program, or alternately display a diagram for indicating that fact.

Also, the receiver receiving the EIT, including that content describer therein, is able to make a search on a program(s) including no 3D video therein, a program(s) including the 3D video therein, and a program(s) including the 3D video and 2D program therein, etc., and thereby to display a list of said program(s), etc.

However, for the purpose of achieving that determining process, in the memory portion equipped with the receiver may be memorized the program characteristic code table information for showing a corresponding relationship between the combination of the value of “first user_nibble” bits and the value of “second user_nibble” bits, and also the program characteristics, in advance.

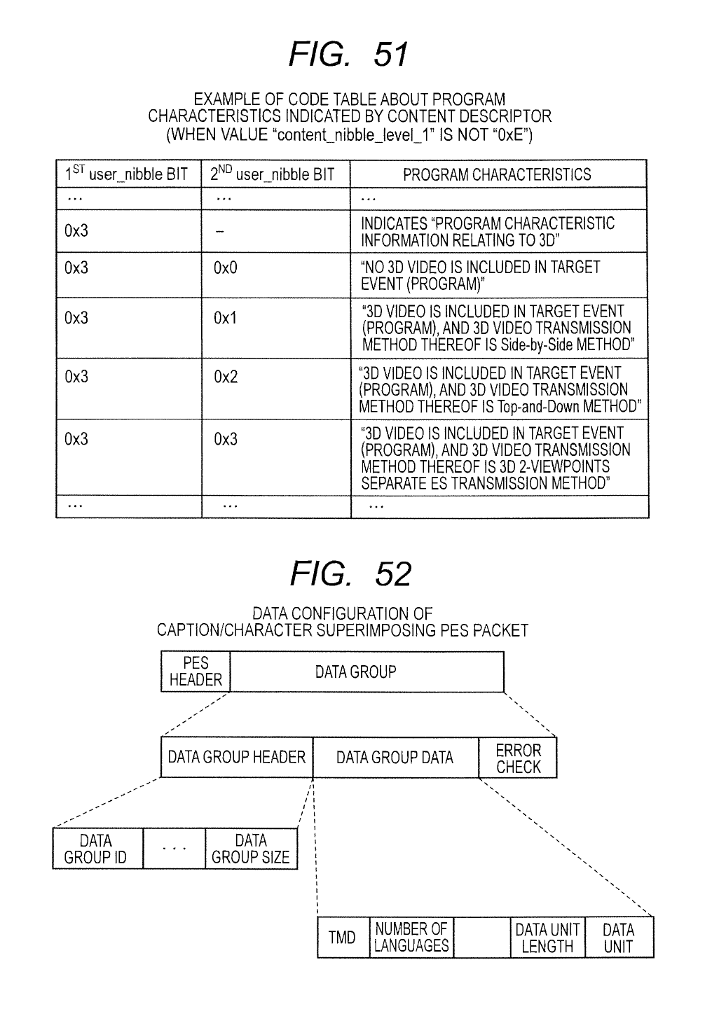

Also, as other example of definition of the program characteristic information in relation to the 3D program, explanation will be given on a case, for example, as is shown in FIG. 51, wherein the program characteristic information of the target event (the program), which that content descriptor transmits, is determined as “program characteristic information relating to 3D program” when the value of the “first user_nibble” bits is “0x3”, and further the program characteristics are defined as “no 3D video is included in target event (program)” when the value of the “first user_nibble” bits is “0x3” and the value of the “second user_nibble” bits is “0x0”, the program characteristics are defined as “3D video is included in target event (program), and 3D transmission method is Side-by-Side method” when the value of the “first user_nibble” bits is “0x3” and the value of the “second user_nibble” bits is “0x1”, the program characteristics are defined as “3D video is included in target event (program), and 3D transmission method is Top-and-Bottom method” when the value of the “first user_nibble” bits is “0x3” and the value of the “second user_nibble” bits is “0x2”, and the program characteristics are defined as “3D video is included in target event (program), and 3D transmission method is 3D 2-viewpoints separate ES transmission method” when the value of the “first user_nibble” bits is “0x3” and the value of the “second user_nibble” bits is “0x3”, respectively.

In this case, for the receiver, it is possible to determine the program characteristics relating to the 3D program of the target event (the program), upon basis of the combination of the value of “first user_nibble” bits and the value of “second user_nibble” bits, not only if the 3D video is included or not, in the target event (the program), but also to determine the 3D transmission method when the 3D video is included therein. If memorizing the information of the 3D transmission methods, with which the transmitter is enabled (e.g., 3D reproducible), in the memory portion equipped with the receiver, in advance, the receiver can display an explanation on the electronic program table (EPG) display, in relation to the program(s), which will be received in future or is received at present, that “no 3D video is included”, or that “3D video is included, and can be reproduced in 3D on this receiver” or that “3D video is included, but cannot be reproduced in 3D on this receiver”, or alternately display a diagram for indicating that fact.

Also, in the example mentioned above, although the program characteristics, when the “first user_nibble” bits is “0x3” and the value of the “second user_nibble” bits is “0x3”, are defined as “3D video is included in target event (program), and 3D transmission method is 3D 2-viewpoints separate ES transmission method”; however, there may be prepared values of the “second user_nibble” bits for each detailed combination of the streams of “3D 2-viewpoints separate ES transmission method”, as is shown in FIG. 47. With doing so, for the receiver, it is possible to make further detailed identification thereof.

Or, the information of the 3D transmission method of the target event (the program) may be displayed.

Also, the receiver receiving the EIT, including that content describer therein, is able to make a search on a program(s) including no 3D video therein, a program(s) including the 3D video and reproducible on the present receiver and a program(s) including the 3D video but irreproducible on the present receiver, etc., and thereby to display a list of said program(s), etc.

Also, it is possible to make a program search on each 3D transmission method, in relation to the program(s) including the 3D video therein, and thereby also enabling a list display for each 3D transmission method. However, the program search on the program, including the 3D video therein but unable to be reproduced on the present receiver, and/or the program search for each 3D transmission method are/is effective, for example, when it is reproducible on other 3D video program reproducing equipment, which the user has, even if it cannot be reproduced in 3D on the present receiver. This is because, even with the program including therein the 3D video, being irreproducible in 3D on the present receiver, if outputting that program, from the video output portion of the present receiver to the other 3D video program reproducing equipment, in the transport stream thereof as it is, then the program of that transport stream format received can be reproduced in 3D, also, on that 3D video program reproducing equipment, or alternately, if the present receiver has a recording portion for recording the content into a removable medium, and if recording that program into the removable medium, then the above-mentioned program recorded in that removable medium can be reproduced in 3D on the 3D video program reproducing equipment mentioned above.

However, for the purpose of achieving that determining process, in the memory portion equipped with the receiver may be memorized the program characteristic code table information for showing a corresponding relationship between the combination of the value of “first user_nibble” bits and the value of “second user_nibble” bits, and also the information of the 3D transmission methods, with which the receiver is enabled (reproducible in 3D), in advance.

<Relating to Regulation/Management of Transmission of Caption Data>

When superimposing caption data on the 3D video program to be transmitted from the transmitting apparatus, it is possible to deal with the 3D display by adding depth information to that caption data.

For example, with the data to be transmitted are carried the following services of caption/character superimposition. Namely, the service of caption means a caption service (for example, a caption of translation, etc.) in synchronism with main video/audio/data, and the service of the character (or letter) superimposition means a caption service (for example, a flash news, a notice of composition, a time signal, an urgent earthquake report, etc.), not in synchronism with main video/audio/data.

As a restriction on composition/transmission when the transmitting apparatus produces a stream, for the caption and the character superimposition, the caption or the character superimposition must be transmitted with an independent PES transmission method (“0x06”), among the assignment of kinds of the stream formats shown in FIG. 3, for example, and the caption and the character superimposition are transmitted with the ESs, which are separated from, respectively. Also, they are transmitted at the same time, with same PMT to that of the main video data or the like, but not distributing the caption data within the same program or before starting of the program, or for example, a number of ESs of the caption/character superimposing, which can be transferred, must be 1 ES for each, i.e., 2 ESs in total, or the number of ESs of the caption/character superimposing, which can be transferred to the same hierarchy at the same time (i.e., the hierarchy means, in transmission of broadcasting, an assembly of data, which can apply different modulation methods at one (1) time of transmission and are superimposed on frequency bands, to be transmitted with each of the modulation methods, and they are called, the “hierarchy”) must be 1 ES for each, i.e., 2 ESs in total. Also, for each of channels, which are composed temporarily, the number of ES of the caption must be 1, at the maximum, and the number of ES of the character superimposing must be 1, at the maximum. Also, a number of languages, which can be transmitted at the same time, must be up to two (2) languages at the maximum, and language identification (i.e., a number for identifying a language when transmitting the caption/character superimposing of plural numbers of languages) must be executed by means of caption management data (will be mentioned later) within the ES, and in case of the character superimposing, bitmap data can be used, and also in case of the caption, only “automatic display when receiving/selective display when recording/reproducing” and “selective display when receiving/selective display when recording/reproducing” (a method for each display will be mentioned later) can be managed. When transmitting plural numbers languages, display modes (will be mentioned later) of those languages must be same. An operation of a receiver when receiving them on the contrary to this, though depending on an implementation of the receiver, takes a priority on the automatic display, and an alarming sound in the caption/character superimposing can be managed within a range of sounds, which are stored in the receiver (i.e., audio data to be used in common in plural numbers of scenes are held on a memory within the receiving apparatus 4, in advance). An additional sound (e.g., the audio of a sound effect, which is transmitted each time from the transmitting apparatus 1) should not be managed with the caption and the character superimposing, and when conducting a designation of a target area on the caption, it is controlled by a target area descriptor of PMT. However, on the caption is conducted no management of designating the target area individually for each of the captions. On the character superimposing can be conducted a management of designating the target area individually for each character superimposing. In this instance, the character superimposing having different target areas must be transmitted, shifting the time from each other, and no data content descriptor of EIT is described since the character superimposing has no relationship with an event (e.g., the corresponding program). In the case of the caption, it is assumed that one (1) descriptor is described for each 1 ES. However, when a parameter is not coincident with settings of a data encoding method descriptor of PMT and caption management data, in the operation of the receiver, a sentence of the caption cannot be displayed during the time when the caption management data is received, since with respect to each parameter, such as, a display mode, a number of languages, a language code, etc., the settings of the data encoding method descriptor and the caption management data have priority, and also since information necessary for displaying the caption/character superimposing is included in the caption management data. Then, by taking the time when selecting the cannel, etc., into the consideration, when transmitting the caption/character superimposing, normally, it can be listed up to transmit the caption management data, at a predetermined time-period (for example, a maximum transmission frequency: 1 time/0.3 sec., a minimum transmission frequency: 1 time/0.5 sec., however may be interrupted due to CM (commercial message).

As the PES transmission method to be applied in caption, it is assumed that a synchronism-type PES transmission method is applied therein, and the synchronization of timing is taken by PTS. As the PES transmission method to be applied in the character superimposing, it is assumed that a non-synchronism-type PES transmission method is applied therein.

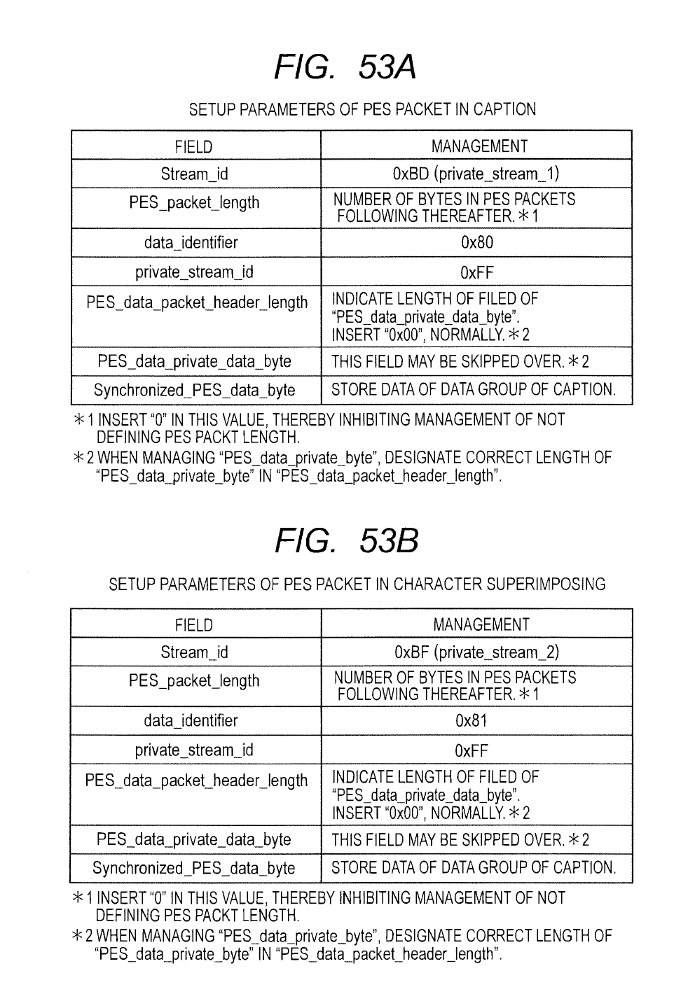

An example of a data format of PES of the caption, to be transmitted from the transmitting apparatus 1 to the receiving apparatus 4 is shown in FIG. 52, and parameters to be set in a is caption PES packet are shown in FIG. 53A. The PES data format is also similar to that of the character superimposing, and parameters to be set in a character superimposing PES packet are shown in FIG. 53B. Those, starting from “stream_id” to “PES_data_private_data_byte” shown in FIGS. 53A and 53B correspond to PES header portions shown in FIG. 52 and “Synchronized_PES_data_byte” corresponds to a data group portion. Recognition of the caption data/character superimposing data can be made in the receiver, if “Stream_id”, “data_identifier” and “private_stream_id” apply predetermined values, which are described in the figures. The data group is made up with a data group header and data group data, and parameters of those are shown in FIG. 54. Fields starting from “data_group” to “data_group_size” shown in FIG. 54 correspond to data group headers shown in FIG. 52, and therein are included information indicating a kid or a size of the caption data, wherein “data_group_data_byte” corresponds to the data group data.

When the receiving apparatus 4 shown in FIG. 25 receives the PES data of the data formats, which are shown in the above, it classifies the data by referring to the value of the “Stream_id”, or the “data_identifier”, and extends them for each kind thereof on a memory not described in the figures.

The data group data is transmitted by the caption management data and caption character data of “0” or “8” languages at the maximum, and this indicates a value and a meaning of a data group ID to be replaced, which is included in the data group header shown in FIG. 55. By referring to this number, it is possible to determine if the data group data is the caption management data or the caption character data, and also to determine the language kind of the caption character data (for example, Japanese, English, . . . etc.) “data_group_id” must be transmitted after changing the data groups thereof from a set “A” to a set “B” and from the set “B” to the set “A”, accompanying a renewal of the caption management data. However, when not transmitting the caption management data by ⅓ or more thereof, there is case where either one of the set “A” and the set “B” is transmitted from, irrespective of the previous set. “data_group_version” is not managed. When the caption management data is the set “A”, the receiver processes only the set “A”, also relating to the caption characters thereof (i.e., a main text, bitmap data, DRCS), while when the caption management data is the set “B”, the receiver processes only the set “B”, also relating to the caption characters thereof. When receiving the caption management data, being same to the caption management data, which was already received at present, in the set thereof, the receiver treats it as the caption management data, which is transmitted again, but executes no initializing operation, upon basis of the caption management data. When receiving the caption characters being same to that of the caption management data, which was already received at present, in the set thereof, by a plural number of times, it processes the caption characters, as new or novel caption characters, respectively.

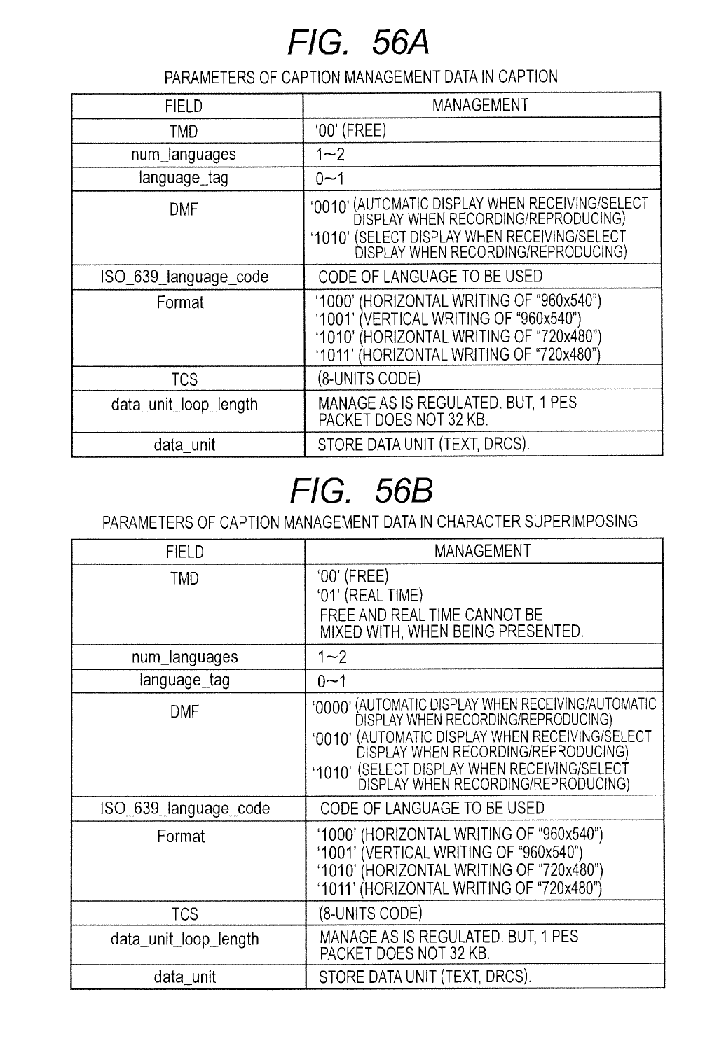

The caption management data is made up with such information as shown in FIGS. 56A and 56B, and is used for transmitting setting information, etc. FIG. 56A shows parameters of the caption management data in the caption.

“TMD” means a time control mode, and this time control mode when receiving/reproducing is presented by a field of two (2) bits. When the value of the two (2) bits is “00”, this indicates that the mode is in “free”, and means there is provided no restriction for synchronizing the reproducing time to a clock. When being “01”, this indicates the mode is in “real time”, and the reproducing time follows the time of the clock, which is corrected by the clock correction of a clock signal (TDT). Or, it means that the reproducing time is depending on TPS. When being “10”, this indicates the mode is in “offset time”, and this means that the reproducing will be made following to the clock, which is corrected through the clock correction of the clock signal, with adapting the time obtained by adding the offset time to the reproducing time, as a new reproducing time. “11” is a value for reservation, and not used.

“num_languages (a number of languages” means a number of the languages, which are included within the ES of this caption/character superimposing. “language_tag (language identification)” is a number for identifying the language, such as, “0”: a first language, . . . “7”: an eighth language, respectively.

“DMF” means a display mode, and the display mode of the caption characters is presented by a field of four (4) bits. The display mode indicates an operation of presentation when receiving and when recording/reproducing, by two (2) bits, respectively, wherein upper two (2) bits indicates the operation of presentation when receiving. In case where it is “00”, it presents an automatic display when receiving, “01” an automatic non-display when receiving, “10” a selective display when receiving, respectively. When it is “11”, this indicates automatic display/non-display of a specific condition when receiving. Lower two (2) bits indicate the operation of presentation when recording/reproducing, and for example, when “00”, they indicate the automatic display when recording/reproducing. When “01”, they indicate an automatic non-display when recording/reproducing. When “10”, they indicate a selective display when recording/reproducing. When “11”, no definition is made. However, a designation of the condition of display or non-display when the display mode is in an “automatic display/non-display of specific condition” designates a message display of a refusal when rainfall decreases, for example. Examples of operations when starting and/or ending the displays in each of the display modes are shown in FIG. 7.

“ISO_{—}639_language_code” (language code) presents the language code corresponding to a language, which is identified by the “language_tag”, by an alphabetic three (3) character code defined in ISO639-2.

“format” (display form) shows an initial condition of the display from on a caption display screen. It designates, such as, a lateral or horizontal writing within a display region of horizontal 1,920 pixels and vertical 1,080 pixels, or a vertical writing within a display region of horizontal 960 pixels and vertical 540 pixels, for example.

“TCS” (character encoding method) presents a king of a character encoding method. For example, it designates, such as, an encoding by 8 units codes.

“data_unit_loop_length” (data unit loop length) defines a total byte length of a data unit following thereto. However, when no data unit is disposed, the value thereof is determined to “0”.

In “data_unit ( )” (data unit) is disposed a data unit, which comes to be effective on all over the caption program, which is transmitted with the same ES.

In relation to the management of the caption management data, within the same caption management data can be disposed plural numbers of data units of the data unit parameters, being same to or different from. When plural numbers of data units are within the same caption management data, they are processed in an order of appearance of the data units. However, data can be described in the text is only a control code (will be mentioned later), such as, “SWF”, “SDF”, “SDP”, “SSM”, “SHS”, “SVS” or “SDD”, and no aggregation of character code accompanying a screen display can be described.

Regarding the caption management data to be used in the caption, it must be transmitted at least one (1) time or more than that per 3 minutes. When no caption management data can be received for 3 minutes or longer than that, the receiver conducts an operation of initialization to be made when selecting the channel.

Regarding the caption management data to be used in the character superimposing, not only “free”, but also a setup of “real time” can be made for “TMD”, for enabling to conduct the time synchronization by “STM” (presentation starting time, which can be designated by data “TIME” for use of time control), by taking the time signal superimposing into the consideration thereof. When no caption management data can be received for 3 minutes or longer than that, the receiver conducts the operation of initialization to be made when selecting the channel. FIG. 56B shows the parameters, which can be designated for the caption management data to be used in the character superimposing. Definitions of the parameters used in FIG. 56B are similar to those shown in FIG. 56B, and therefore the explanation thereof will be omitted herein.

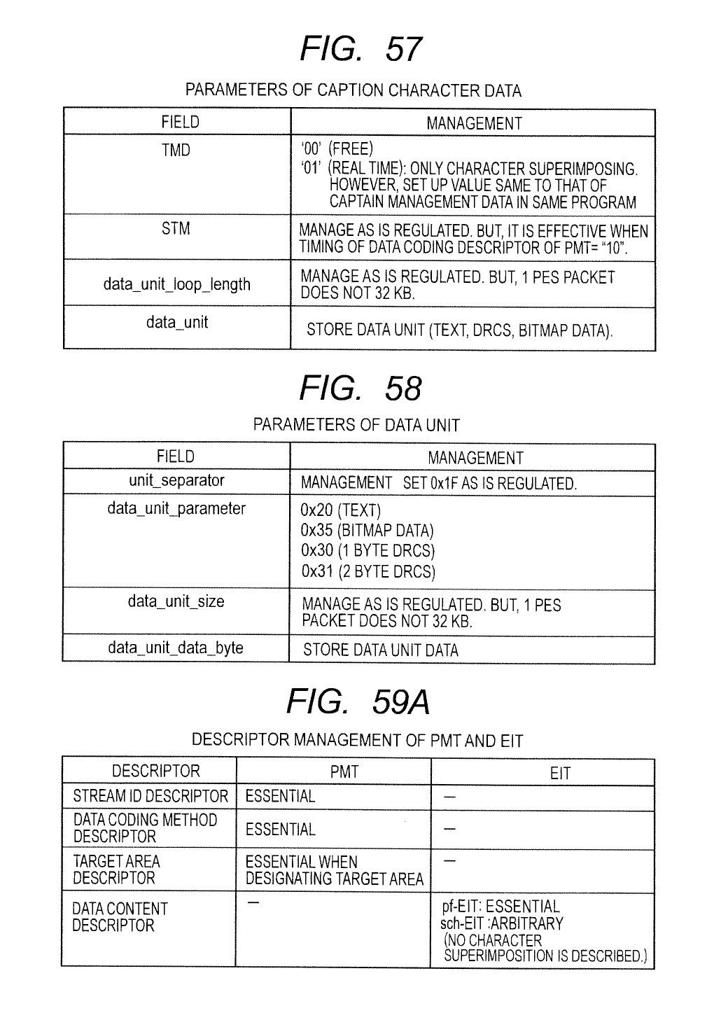

Within same caption character data can be disposed plural numbers of data units of the data unit parameters, being same to or different from. When plural numbers of data units are within the same caption character data, they are processed in an order of appearance of the data units. FIG. 57 shows the parameters, which can be set on the caption character data. “STM” (presentation starting time) presents the time for staring the presentation of the caption characters following thereto. The presentation starting time is encoded with using 9 pieces of 4-bits binary-coded decimal (BCD), in an order of hour, minute, second, millisecond. However, an ending of the presentation depends on the code of a character code portion.

Also, FIG. 58 shows parameters, which can be set in the data units.

“unit_separator” (data unit separation code) is assumed to be “0x1F” (a fixed value).

“data_unit_parameter” (data unit parameter) identifies a kind of the data unit. For example, by designating the data unit to be the text, transmission of character data, building up the caption characters as a function thereof, or transmission of setup data, such as, the display region, etc., in the caption management, can be presented, or by designating it to be geometric, a transmitting function of a geometric graphic data can be presented.

“data_unit_size” (data unit size) shows a byte number of the data unit data following thereto.

Into “data_unit_data_byte” (data unit data) is stored the data unit data to be transmitted. Further, “DRCS” presents graphic data to be deal with as a kind of user-defined or external character.

Within the receiving apparatus 4 shown in FIG. 25, the system controller portion 51 decrypts the caption data (i.e., a data group header and the data group data), being extended by the multiplex/demultiplex portion 29. When detecting that the information of the data unit data is the caption management data, upon the value of the data group ID included in the data group header, processing is executed depending on the value of each of the parameters owned by the caption management data shown in FIGS. 56A and 56B. For example, caption data transmission timing from the system controller portion 51 to the video conversion controller portion 61 is determined upon basis of the values of “TMD” and “DMF”. If “TMD” is “free”, and if being “automatic display when receiving”, then the system controller portion 51 may transfer the caption data to the video conversion controller portion 61, immediately when receiving the caption data, until when those data will be renewed. Also, from the value of “num_languages” or “ISO_{—}639_language_code”, it may instruct the OSD produce portion 60 to display a number of caption data and/or a language name identified on the display 47, so as to inform the caption information to the user. Or, depending on “Format”, for example, designation may be given to the video conversion controller portion 61, upon a position for drawing the caption character line(s) (including characters and graphic data) on a caption display plane.

Also, the system controller portion 51 decrypts the caption data, and if the information of the data unit data is the caption character data, judging from the value of the data group ID included in the data group header, it conducts processing depending on the value of the parameters shown in FIG. 57. For example, the caption data included in the data unit following thereto may be transferred to the video conversion controller portion 61, in order to be in time designated in “STM”. Also, when detecting “unit_separator” by analyzing the data unit, determination may be made on the data kind of the data unit data following thereto depending on the value of “data_unit_parameter” just after thereof. When detecting control data, which will be mentioned later, within the data unit data, such a control is made that a position for displaying and/or a method for decorating the caption data, etc., may be instructed to the video conversion controller portion 61. Production of the caption characters (the details thereof will be mentioned later) is conducted from the data unit data, and the caption characters to be displayed on the display 47 is noticed to the video conversion controller portion 61 at a predetermined timing. In the video processing processor portion 32, the video conversion controller portion 61 superimposes the character line(s) on the video data for use of display, which is outputted from the video decoder portion 30, at the display position, which is determined upon basis of the display control mentioned above, and combines it/them with the OSD data produced by the ODS produce portion 60; thereby producing a video to be displayed on the display 47.

Next, explanation will be given on management of PSI/SI relating to the caption/character superimposing.

A component tag value of the caption ES is determined at a value within the range “0x30-0x37”, the component tag value of the character superimposing ES with the range “0x38-0x3F” respectively. However, the component tag value of a default ES of the caption is determined at “0x30”, and the component tag value of a default ES of the character superimposing at “0x38”, respectively.

Renewal of “PMT” will be made, basically, by adding/deleting ES information, when staring/ending the caption and the character superimposing, but such management may be possible, of describing the ES information therein, always.

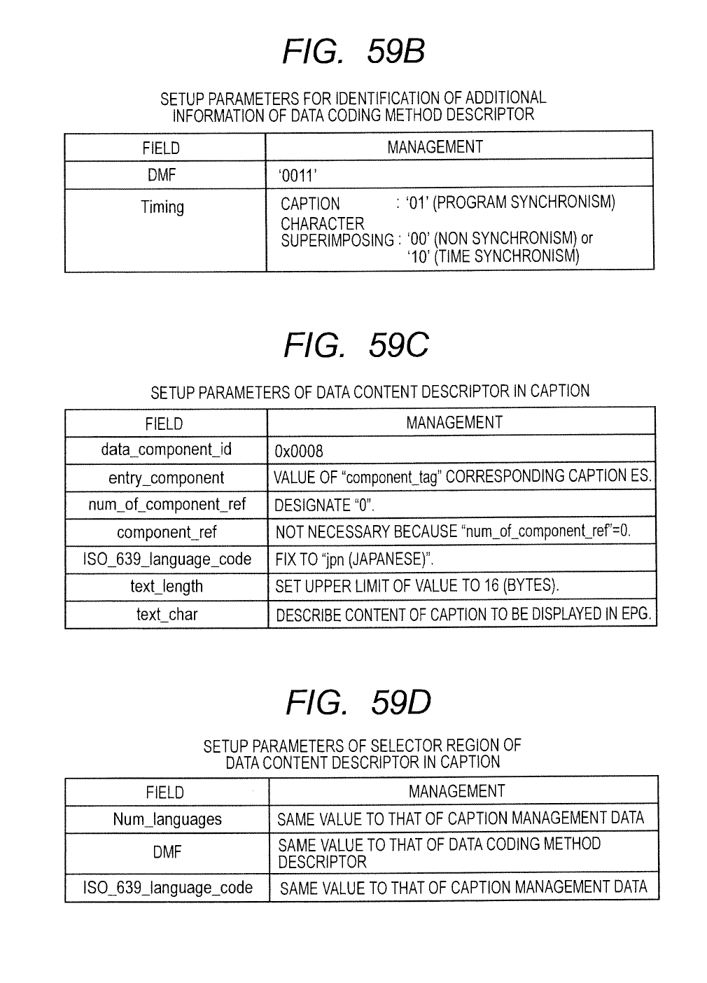

The stream indentify descriptor (“stream_type”) of the caption/character superimposing ES is “0x06” (an independent PES_packet). FIG. 59A shows descriptor management of PMT and EIT for the caption/character superimposing. In the caption transmission, the data content descriptor of EIT is assumed to describe therein 1 descriptor per 1 ES. However, in an application not expected in advance, such as, a quick report superimposing, etc., a management of not inserting the data content descriptor in EIT may be allowed or accepted. “data_component_id” of the data encoding method descriptor shown in FIG. 59A is “0x0008”, for both the caption and the character superimposing. Parameters to be determined, separately, for each of addition information, are shown in FIG. 59B. It may be a value indicating program synchronization, for the caption. For the character superimposing, it may be a value indicating non-synchronization or time-synchronization.

In managements of target area descriptors shown in FIG. 59A are described information of areas to be targets of the service as a whole thereof.

Parameters, which can be setup in the data content descriptors shown in FIG. 59A, are shown in FIGS. 59C and 59D. However, if the values of those setup parameters are inconsistent with the data encoding method descriptor and the caption management data of PMT, within the same event, the setup values of the data encoding method descriptor and the caption management data have priority. The value of “data_component_id” is set to be “0x0008”. The value of “entry_component” is set to the value of “component_tag” of the corresponding caption ES. As the value of “num_of_component_ref”, it is assumed that “0” is assigned. The value of “component_ref” is unnecessary because “num_of_component_ref”=0. The value of “ISO_{—}639_language_code” is assumed to be fixed, “jpn” (Japanese language). An upper limit of the value of “text_length” is assume to be 16 (bytes). As the value of “text_char” are described the contents of the caption to be displayed on EPG. Also, the value of “Num_languages” is assumed to be the same value of the caption management data. The value of DMF is assumed to be same to the value of the data encoding method descriptor. “ISO_{—}639_language_code” is assumed to be the value same to that of the caption management data.

In the receiving apparatus 4, the program information analyzer portion 54 analyzes the contents of PMT, being one of the PSI information mentioned above, and for example, if the value of the stream identification descriptor is “0x06”, it is possible to determine that the TS packet having the corresponding PID is the caption/character superimposing data, and thereafter a filter setup is made in the multiplex/demultiplex portion 29, so as to separating the PID presenting that PID. With this, it is possible to extract the PES data of the caption/character superimposing data, within the multiplex/demultiplex portion 29. Also, a setup of the caption display timing in the system controller portion 31 and/or the video conversion controller portion 61, upon basis of the value presented by “Timing”, being a setup parameter, which is included in the data encoding method descriptor. The value of the target area descriptor of the character superimposing, if it does not agree with the receiving area information, which is determined by the user in advance with using an appropriate method, may not be treated with a series of processes for the caption display. When detecting data from “text_char” included in the data content descriptor, the system controller portion 51 may use it as data when displaying the EPG. With each of the setup parameters for selector reigns of the data content descriptor, since the same value is used also in the caption management data, there is no necessity of conducting a control thereon, but such a control as was mentioned previously may be conducted in the system controller 51.

<Display Area>

When trying to receive and/or display the data, which is transmitted from the transmitting apparatus 1 with the format mentioned above, within the receiving apparatus 4, it follows the display format, for example, which will be shown below. For example, as the display format may be applied the horizontal writing, the vertical writing, etc., of 960×540 or 720×480, respectively. Also, the resolution of a moving picture plane (i.e., a memory area for storing the video data for use of display, after decoding it in the video decoder portion 30) and the display format for the caption/character superimposing are determined, depending on the resolution of the moving picture plane, i.e., when the moving picture plane is 1,920×1,080, the display format for the caption/character superimposing is set to 960×540, while when the moving picture plane is 720×480, the display format for the caption/character superimposing is set to 720×480, and they are set to the horizontal writing and the vertical writing, respectively. The display when 720×480 is assumed to the same display format irrespective of an aspect ratio of the picture, and when making a display by taking the aspect ratio in the consideration thereof, it is assumed that a correction can be made on the transmitter side.

It is assumed that, for the caption or the character superimposing, a display region is only one (1), respectively, which can be set up at the same time. Also, the display region comes to be effective to the bitmap data, too. An order of priority on the display region is as follows: (1) a value(s) designated by SDF and SDP, among the text of the caption character data, (2) a value(s) designated by SDF and SDP, among the text of the renewed caption management data, and (3) an initial value upon basis of the display format, which is designated by a header of the renewed caption management data. It is assumed that as the character encoding method to be applied for the caption/character superimposing is applied 8 units encoding. It is preferable the character font to be round gothic. Also, it is assumed that the character sizes displayable on the caption/character superimposing are 5 sizes, 16 dots, 20 dots, 24 dots, 30 dots and 36 dots. In designation of the character size when transmitting, one of the sizes mentioned above is designated. Also, for each of the sizes, a standard, medium or small size can be used. However, the definitions of the standard, medium and small sizes are assumed to be the followings: for example, the standard is a character having a size, which is designated by a control code “SSM”, the middle is a character having a size, being half (½) of the standard, only in the character direction, and the small is a character having a size, being half (½) of the standard, respectively, in both the character direction and the line direction.

<Regarding Control Code>

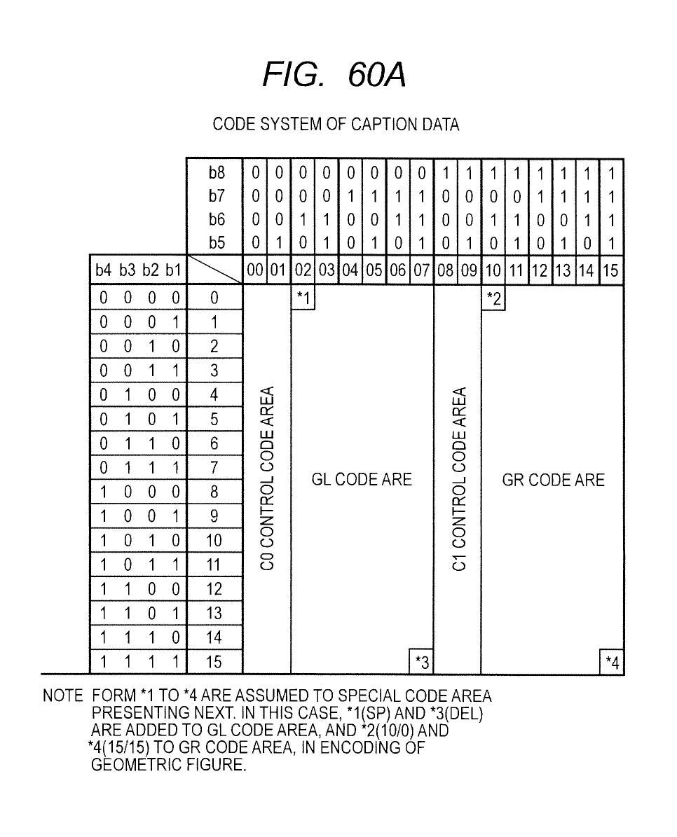

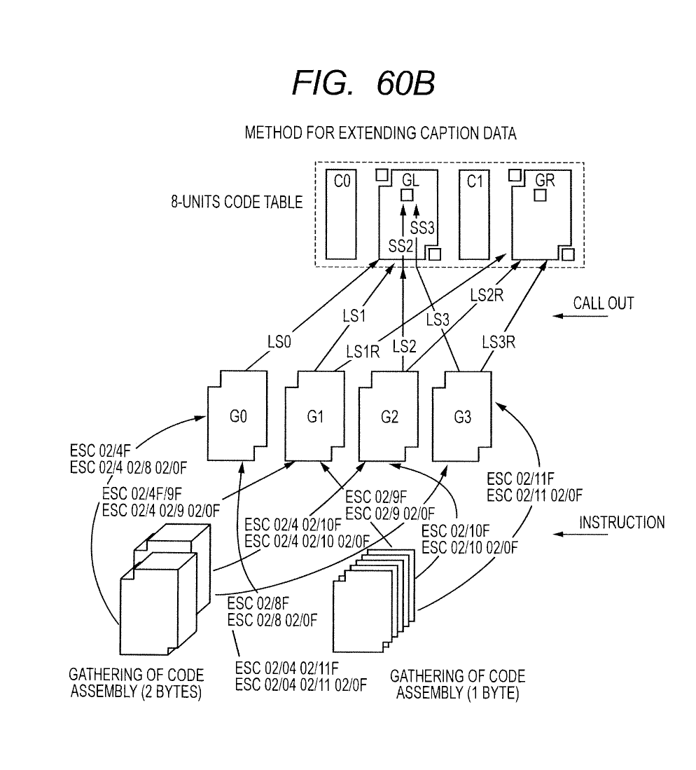

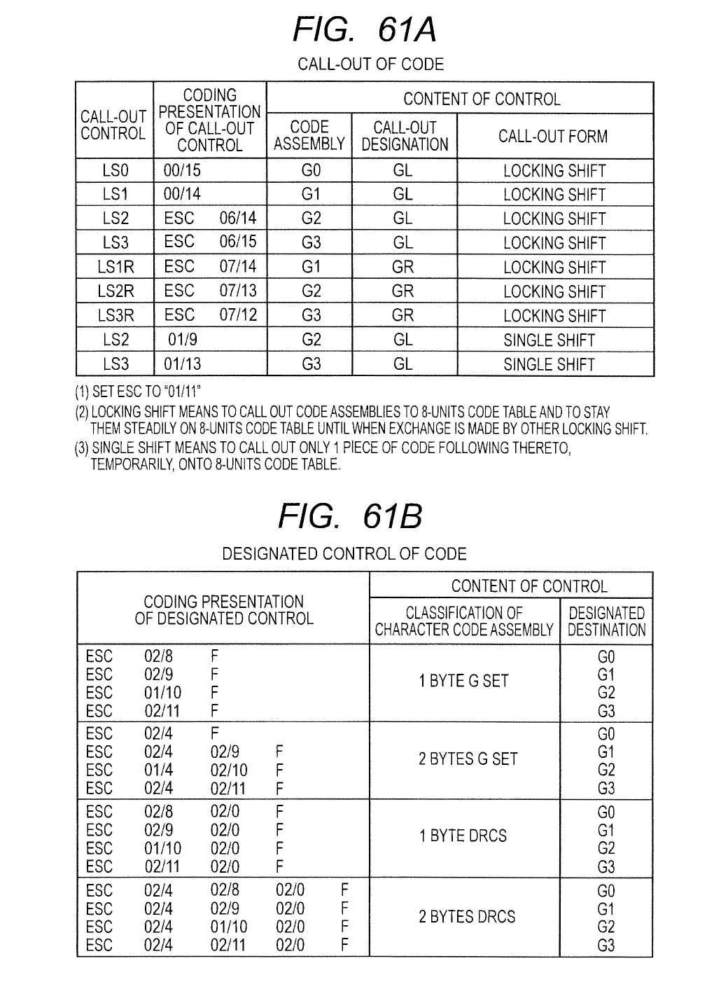

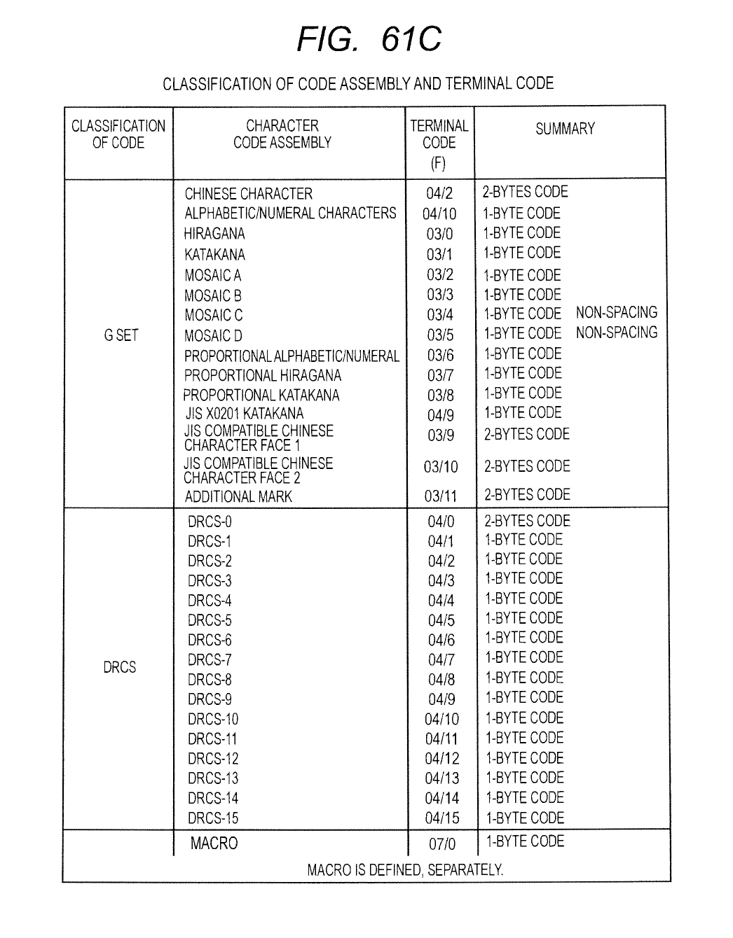

A code system of the caption data is made upon basis of an 8 unit code, wherein the code system is shown in FIG. 60A, and an expanding method thereof is shown in FIG. 60B. Contents of control of call-out of codes (i.e., calling out code assemblies G0, G1, G2 and G3 to a table of 8 unit codes) in an expansion of the codes are shown in FIG. 61A, and contents of control of designation of codes (i.e., designating one of the code assemblies among aggregate of the code assemblies as an assembly G0, G1, G2 or G3) is shown in FIG. 61B, and further classifications of the code assemblies and terminal codes are shown in FIG. 61C. Each call-out control and coding presentation of the designation control are presented by “column number/line number” in the code system shown in FIG. 60A, wherein for example, if an actual data is “0x11”, upper four (4) bits indicate the column number while lower four (4) bits indicate the line number, respectively, and it can be presented by “01/1”. With the ESC, it is “01/11” shown in the code system of the caption data shown in FIG. 60A. “F” is anyone of the terminal codes shown in FIG. 61C, and depending on the value of this is determined the kind of the code assembly to be called out, and it means to be the terminal of contents of one (1) designation.

In the code configurations of a Chinese character system assembly, an alphanumerical assembly, a hiragana assembly, a katakana assembly and a mosaic assembly, an arbitrary character is assigned to a data line of 2 bytes or 1 byte, respectively. It is assumed that JIS transposition Chinese character 1 surface assembly is as is shown by a Chinese character 1 surface indicated by “JIS X0213:2004”, and JIS transposition Chinese character 2 surface assembly is as is shown by a Chinese character 2 surface indicated by “JIS X0213: 2004”. An additional mark assembly is made up with an additional mark(s) and an additional Chinese character(s). A non-spacing character and a non-spacing mosaic are designated by the codes following thereto, for example, and are displayed combining with a mosaic or a space, etc.

A code to be used as the external character is assumed to be one (1) byte code or a two (2) byte code. One (1) byte external character codes are assumed to be 15 assemblies, from “DRCS-1” to “DRCS-15”, and each assembly is built up with 94 characters (i.e., those from 2/1 to 7/1 are used. In the method of presenting the column number/line number, if the column number is presented by 1 digit, it is assumed that the column number is indicated by a binary value of 3 bits, from “b7” ti “b5”.

A 2 byte user-defined or external character assembly is assumed to be an assembly of “DRCS-0”. The “DRCS-0” is assumed to be a table of codes, which is made up with 2 bytes.

In the receiving apparatus 4, the code assemblies to be used as the caption characters (indicating all of characters of the Chinese character system assembly, the alphanumerical assembly, the hiragana assembly and the katakana assembly, etc., and codes to be displayed as the caption, such as, the additional mark assembly and the external characters, etc.) are expanded in advance, while on a memory not shown in the figures are maintained a memory area according to the code system described in FIG. 60A and memory areas corresponding to G0 through G3 shown in FIG. 60B. The system controller portion 51 decrypts the character lines from a top, in an order of receiving the caption character data, and when detecting the data line corresponding to the coding expression of the designation control mentioned in FIG. 61B among those, it expands the character code assemblies, which are shown in the contents of control, within the memory region at a destination of designation. Also, when detecting the data line corresponding to the coding expression of the call-out control shown in FIG. 61A among the caption character data, the system controller portion 51 expands the character code assembly corresponding thereto (i.e., either one from G0 to G3) within the memory region at an origin of the call-out (i.e., a GL code region or a GR code region shown in FIG. 60A). In case where the call-out condition shown in FIG. 61A is in a locking-shift, if being made once, the call-out comes to be effective until other call-out of the code assembly is made next time. A single-shift is a call-out method for calling out only one (1) character just following thereafter, so as to bring it back to the previous condition after calling out. Data (02/1-07/14 and 10/1-15/14) other than the control commands of the caption character data mean to use the characters corresponding to the column number(s)/line number(s) of the code assembly(ies), which is/are read out into the GL code region or the GR code region at that time, as the caption characters. The video conversion controller portion 61 keeps a memory area for use of display of the character lines (e.g., a caption display plane), and when detecting numeral lines of “02/1-07/14” and from “10/1” to “15/14”, depending on the numeral lines of the caption character data, it changes the character data, which is mapped in the GL and GR code regions, into character line data for use of display, through the designation and the call-out control mentioned above. The system controller portion 51 transmits the caption character data to the video conversion controller portion 61, and the video conversion controller portion 61 draws display character line data on the caption display plane, for example, in the form of bitmap data. Also, when the system controller portion 51 detects the control code (and the parameter(s) thereof), it transfers the control code (and the parameter(s) thereof) to the video conversion controller portion 61, and the video conversion controller portion 61 executes the processes corresponding thereto. Details of the method for using the control codes will be mentioned later. However, the transfer of the caption character data must not be conducted for each one (1) character, necessarily, and for example, there may be applied a method of accumulating the data for a predestined time-period to be transferred collectively, or may be applied a method of accumulating it for a predetermined size to be transferred collectively.

With such code system and the management thereof, it is possible to conduct the control designation, which will be mentioned later, and the designation of the characters to displayed, with using the same caption character data, and by calling up the code assemblies, which are used at high frequency, to G0 to G3 in advance, there is achieved a mechanism for enabling to designate the characters to be used effectively among a massive amount of the character data. Further, the GL code region, the GR code region and the code assemblies to be set in the coding regions of G0 to G3 are defined in advance.

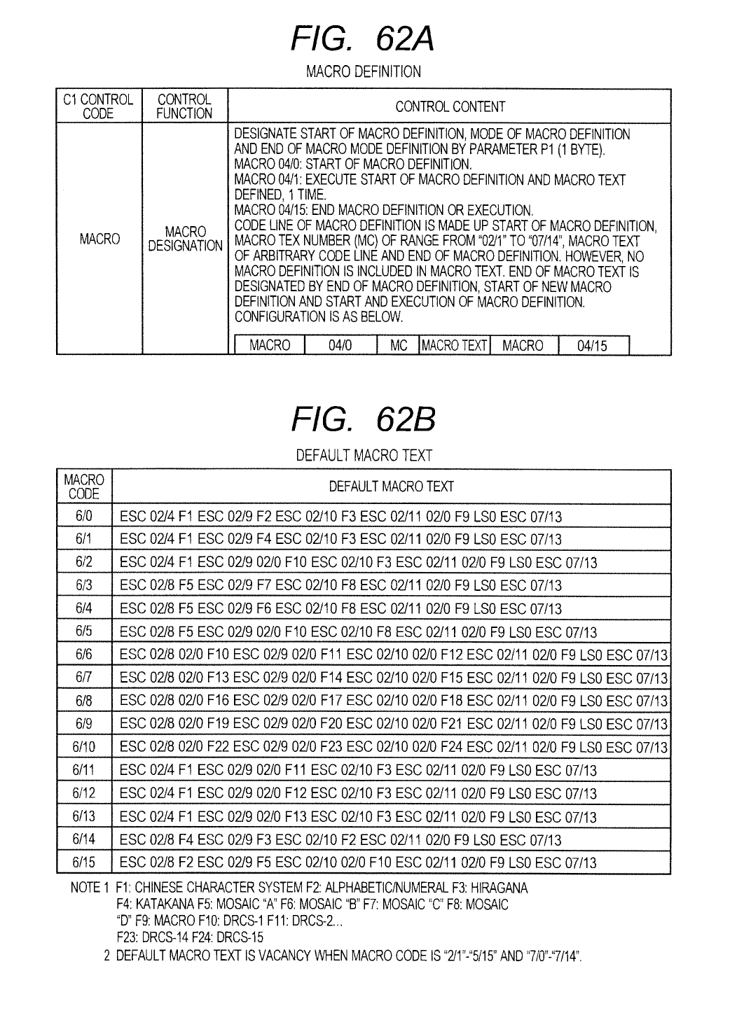

A macro code assembly means a code assembly having a function of being used, representatively (hereinafter, being called a “macro definition”), by a series of code lines, being built up with the character codes (including the graphics and the graphics displayed in DRCS graphic) and the control codes (hereinafter, being called a “macro text”). The macro definition is conducted by a macro designation shown in FIG. 62A. Macro codes, each being assumed to be 1 byte code, are made up with 94 kinds thereof (from 2/1 to 7/14 are used). When the macro code is designated, decoding is executed on the code line of the macro text. When no macro definition is conducted, execution is made according to a default macro text shown in FIG. 62B.

The receiving apparatus 4 decrypts the caption character data one by one, and when detecting “MACRO (09/5), then it executes a macro process just following to that. Macro codes are assigned in such a manner that the call-out and the designation control, being used at high frequency, which are indicated in the default macro text, can be presented easily, and in the system controller portion 51 is/are executed the control(s) indicated by the default macro text when it detects the macro code. With this, shortened expression of the complicated caption processing enables reduction of the caption character data.

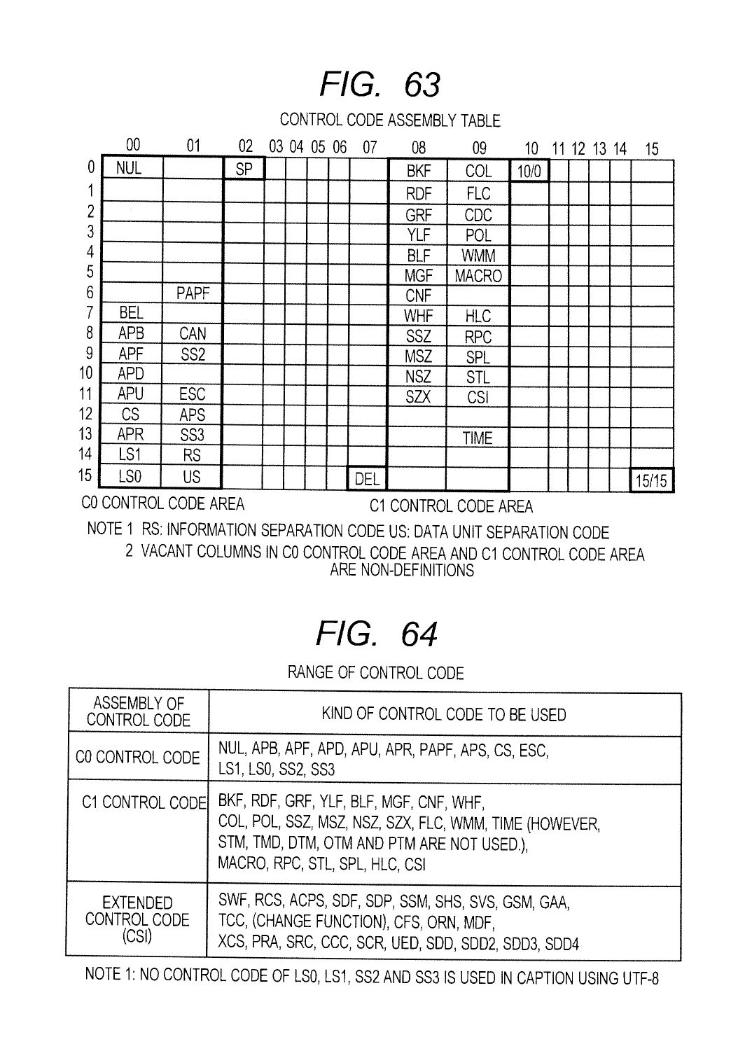

As a method for controlling the display method and the display format of the main text of the caption character data, actively, it is possible to insert the control code(s) into the caption character data. Examples of the configurations of C0 control code and C1 control code are shown in FIG. 63. With each control code, in the method of presenting the column number/line number, from “00/0” to “01/15” are assigned to the C0 control code and from “08/0” to “09/15” are assigned to the C1 control code. Kinds of the control codes to be used in each control code assembly are shown in FIG. 64. In the present embodiment, a control code indicating depth of the caption is newly included the extended control code. As the kinds of the control codes to be used newly, they are presented with using a character titles, SDD, SDD2, SDD3 and SDD4. The method for designating the display position in depth will be mentioned later.

An example of functions of the C0 control code will be shown below.

“NUL” is a control function of “vacancy”, and this is a control code for enabling addition or deletion without giving ill-influences upon the contents of information. “APB” is a control function of “operating position regress”, and this regresses or sets back the operating position along with the direction of operation, by a length of a display section in the operating direction thereof. In case where a reference point of the display section jumps over an end of the display area or region with this movement, the operating position is moved towards the opposite end of the display region along the direction of operation, and thereby achieving the operating line regress. “APF” is a control function of “operating position progress”, and this regresses or advances the operating position along with the direction of operation, by the length of the display section in the operating direction thereof. In case where the reference point of the display section jumps over the end of the display area with this movement, the operating position is moved towards the opposite end of the display region along the direction of operation, and thereby achieving the advance of a line of operation. “APD” is a control function of “operating line progress”, and this regresses or advances the operating line to a next line, along with the line direction, by the length of the display section in the line direction. In case where the reference point of the display section jumps over the end of the display area with this movement, the operating position is moved to a first line of the display region along the line direction. “APU” is a control function of “operating line regress”, and this regresses or sets back the operating line to a previous line, along with the line direction, by the length of the display section in the line direction. In case where the reference point of the display section jumps over the end of the display area with this movement, the operating position is moved to a last line of the display region along the line direction. “APR” is a control function of “operating position return”, and this moves the operating position to a first position on the same line, and thereby achieving the operating line progress. “PAPF” is a control function of “designated operating position progress”, and this executes an operating position progress or advance by a number of times, which is designated depending on a parameter P1 (1 byte). “APS” is a control function of “operating position designation”, and this executes the operating position progress or advance of the operating position, by a number of times designated depending on a first parameter, by a length of the display section in the line direction from a firs position of the first line of the display area or region, and also executes the operating position progress or advance of the operating position, by a number of times designated depending on a second parameter, by a length of the display section in the operating direction thereof. “CS” is a control function of “screen extinction”, and this brings the corresponding display area(s) or region(s) of the display screen into an extinction condition. “ESC” is a control function of “escape”, and this is a code for extending a code system. “LS1” is a control function of “locking shift 1” and is a code for calling out an assembly of the character codes. “SS2” is a control function of “single shift 2” and is a code for calling out an assembly of the character codes. “SS3” is a control function of “single shift 3” and is a code for calling out an assembly of the character codes.

An example of functions of codes of the C1 control code will be shown below.

“BKF” is a control function of “foreground color black and color map lower address designation”, and this designates a foreground color to be black, and also designates a color map lower address (CMLA), which defines a coloring value of the corresponding drawing plane, to “0”. “RDF” is a control function of “foreground color red and color map lower address designation”, and this designates the foreground color to be red, and also designates the color map lower address (CMLA), which defines the coloring value of the corresponding drawing plane, to “0”. “GRF” is a control function of “foreground color green and color map lower address designation”, and this designates the foreground color to be green, and also designates the color map lower address (CMLA), which defines the coloring value of the corresponding drawing plane, to “0”. “YLF” is a control function of “foreground color yellow and color map lower address designation”, and this designates the foreground color to be yellow, and also designates the color map lower address (CMLA), which defines the coloring value of the corresponding drawing plane, to “0”. “BLF” is a control function of “foreground color blue and color map lower address designation”, and this designates the foreground color to be blue, and also designates the color map lower address (CMLA), which defines a coloring value of the corresponding drawing plane, to “0”. “MGF” is a control function of “foreground color magenta and color map lower address designation”, and this designates the foreground color to be magenta, and also designates the color map lower address (CMLA), which defines the coloring value of the corresponding drawing plane, to “0”. “CNF” is a control function of “foreground color cyan and color map lower address designation”, and this designates the foreground color to be cyan, and also designates the color map lower address (CMLA), which defines the coloring value of the corresponding drawing plane, to “0”. “WHF” is a control function of “foreground color white and color map lower address designation”, and this designates the foreground color to be white, and also designates the color map lower address (CMLA), which defines the coloring value of the corresponding drawing plane, to “0”. “COL” is a control function of “color designation”, and this designates, as well as, the foreground color mentioned above, a background color, a fore-middle color, a back-middle color and further the color map lower address (CMLA), depending on the parameter(s). Herein, colors between the foreground color and the background color in a gradation font are defined as follows; i.e., a color close to the foreground color is the fore-middle color while a color close to the background is the back-middle color. “POL” is a control function of “pattern polarity”, and this designates the polarity of the patterns, such as, the characters or the mosaic presented by the codes following the present control codes (in case of a normal polarity, the foreground color and the background color are as they are, but in case of a reverse polarity, the foreground color and the background color are reversed). However, when a non-spacing character is included therein, designation is made of the pattern polarity after the composition. Also, conversion is made upon the middle colors in the gradation font, i.e., the fore-middle color is converted into the back-middle color, while the back-middle color into the fore-middle color. “SSZ” is a control function of “small size” and this bring the size of a character to be small. “MSZ” is a control function of “middle size” and this bring the size of the character to be middle. “NSZ” is a control function of “normal size” and this bring the size of a character to be normal. “SZX” is a control function of “designation size”, and this designates the size of the character depending on the parameter(s). “FLC” is a control function of “flashing control”, and this designates a start and an end of flashing and also difference between a positive phase and a reversed phase thereof, depending on the parameter(s). The positive phase flashing means a flashing staring on the screen at first, while the reversed phase flashing means a flashing obtained by reversing the phases of light and dark to the positive phase flashing. “WMM” is a control function of “writing mode changing”, and this designates changing of a writing mode in a display memory, depending on the parameter(s). Such writing mode includes a mode of making the writing into the portions, which are designated to be the foreground color and the background color, a mode of making the writing only into the portion, which is designated to be the foreground color, and a mode of making the writing only into the portion, which is designated to be the background color, etc. However, with the middle colors in the gradation font, both the fore-middle color designated portion and the back-middle color designated portion are treated as the foreground color. “TIME” is a control function of “time control”, and designates the control of time depending on the parameter(s). A unit of time of designation is assumed to be 0.1 sec., for example. No presentation starting time (STM), no time control mode (TMD), no reproduction time (DTM), no offset time (OTM) nor performance time (PTM) is used therein. A presentation ending time (ETM) is used. “MACRO” is a control function of “macro designation”, and this designates a start of macro definition, a mode of macro definition and an end of the macro definition, with using the parameter P1 (1 byte). “RPC” is a control function of “character repetition”, and this makes display of one (1) pieces of character or mosaic on the display following to this code, repetitively, by a number of times, which is designated depending on the parameter(s). “STL” is a control function of “underline start and mosaic separation start”, and no composing or combining is conducted when the mosaics “A” and “B” are on the display following after this code, but when a non-spacing and a mosaic are included during composing or combining upon the composition control, after the composition is executed a separation process (i.e., a process of dividing a mosaic prime element into small prime elements, each having sizes of ½ in the horizontal direction and ⅓ in the vertical direction of the display section, and providing distances on the peripheral portions thereof, respectively). In case of other than that, an underline is added. “SPL” is a control function of “underline end and mosaic separation end”, and with this code, addition of the underline and the separation process of the mosaic are ended. “HLC” is a control function of “enclosure control”, and this designates a start and an end of the disclosure with using the parameter(s). “CSI” is a control function of “control sequence introducer” and is a code for extension of the code system.

An example of function of codes of the extended control code (CSI) will be shown hereinafter.

“SWF” is a control code of “format setup”, and this selects an initialization with using the parameter(s) and also executes the initializing operation. Thus, as an initial value thereof, this conducts designation of the format, such as, horizontal writing with a normal density or vertical writing with high density, or designation of the character size, or designation of a number of characters on one (1) line and a number of lines. “RCS” is a control code of “raster color control” and this determines a raster color depending on the parameter(s). “ACPS” is a control code of “operating position coordinates designation”, and this designates an operating position reference point of the character displaying section, as the coordinates of a logical plane seeing it from a left-upper angle, with using the parameter(s) “SDF” is a control code of “display configuration dot designation” and designates a number of display dots with using the parameter(s). “SDP” is a control code of “display position designation”, and designates the display portion of the character screen by the positional coordinates of the left-upper angel, with using the parameter(s). “SSM” is a control code of “character configuration dot designation”, and designates a character dot, with using the parameter(s). “SHS” is a control code of “inter-characters distance designation” and designates a length of the display section in the operating direction thereof, depending on the parameter(s). With this, movement of the operating position is made by a unit of length, which is obtained by adding the inter-characters distance to a design frame. “SVS” is a control code of “inter-lines distance designation” and designates a length of the display section in the line direction, depending on the parameter(s). With this, movement of the operating position is made by a unit of length, which is obtained by adding the inter-lines distance to the design frame. “GSM” is a control code of “character deformation” and designates a deformation of the character depending on the parameter(s). “GAA” is a control code of “coloring section” and designates a coloring section of the characters depending on the parameter(s). “TCC” is a control code of “switching control” and designates a switching mode, a switching direction of the caption and a switching time of the caption, depending on the parameter(s). “CFS” is a control code of “character font setup” and designates a font of the character depending on the parameter(s). “ORN” is a control code of “character ornament designation” and designates a character ornament or decoration (e.g., trimming, shadowed or outlined, etc) and a color of the character ornament, with using the parameter(s). “MDF” is a control code of “typeface designation” and designates the typeface (e.g., bold, italic or bold/italic, etc.) depending on the parameter(s). “XCS” is a control code of “external character alternation designation” and defines a line of codes to be displayed alternately, when DRCS or it is impossible to display the characters of a third standard and a fourth standard. “PRA” is a control code of “built-in sound reproduction” and reproduces a built-in sound, which is designated by the parameter(s). “SRC” is a control code of “raster designation” and designates a display of superimposing and a raster color with using the parameter(s). “CCC” is a control code of “composing control” and designates a composition control of the characters and the mosaics depending on the parameter(s). “SCR” is a control code of “scroll designation” and designates a scroll mode of the caption (designation of character direction/line direction and designation of yes or no of rollout) and a scroll speed depending on the parameter(s). “UED” is a control code of “invisible character embedding control”, and with this is conducted an embedding of a line(s) of the invisible data codes, which is not displayed on an ordinary caption presentation system, for the purpose of adding notional contents to the character line(s) of the caption, etc. With the present control code, designations are made of this code of the invisible data code, as well as, of a line(s) of caption display characters, with which the invisible data is/are linked. SDD, SDD2, SDD3 and SDD4 will be mentioned later.

In code sequences of the C0 and C1 control codes, the parameter(s) is/are disposed just after the control code. In the code sequence of the extended control code are disposed the following: a control code (09/11=CSI), a parameter, middle characters, and a terminal character, in that order. In case where the parameter appears by a plural number thereof, then the parameter and the middle characters are repeated.

The receiving apparatus 4 analyzes the caption character data in the order of inputting thereof, and when detecting the data lines indicating the C0 and C1 control code, it conduct processing of the control contents depending on each of the control codes shown in FIG. 64. For example, when detecting “01/6” within the caption character data, this means to be PAPF (designated operating position progress), and when a numerical value just thereafter is “04/1”, the parameter value presents “1”; namely, it is assumed that the video conversion controller portion 61 advances the drawing position on the caption display plane by one (1) character in the horizontal direction. When detecting the extended control code (CSI), the video conversion controller portion 61 processes data, with treating the data following thereafter until when the terminal character thereof is detected, as one (1) set thereof, and determines the control function depending the terminal character, thereby to execute the control contents upon basis of each parameter between them.

The contents designated once by the extended control are reflected on the contents displayed, continuously, until when a different value is designated, again, by another extended control of being same in the kind thereof, or when the initializing operation is conducted on the caption display. For example, when trying to conduct the character configuration dot designation, read-in is made, after detecting the “09/11 (CSI)”, up to “05/7 (F (the terminal character)) thereafter, and within an interval between those is the parameter P1, from “09/11” up to “03/11 (I1 (middle character)” for example, and if it is “03/5” or “03/0”, then the designation of the dot number in the horizontal direction comes to “50”. On the similar manner, the interval from “03/11” to “20/0 (I2 (middle character))” is the parameter I2, and if it is “03/4” or “03/0”, then the designation of the dot number in the horizontal direction comes to “40”. Drawing is made on the caption display plane by converting the display character line data into the size of 50 dots in the horizontal and 40 in the vertical, on the line(s) of codes of the caption character data following thereafter, and thereafter is conducted the character configuration dot designation, again, or writing is made with this dot number until when the initialization is conducted. Other control functions are processed, also in the similar manner to the above, and then an arbitrary process is conducted.

In the C0 control code are mainly included codes for controlling the operating position and for calling out the assembly of the character codes (since the character codes are collected in the form of assemblies divided, for displaying the characters on the caption, it is necessary to designate the assemblies including the characters therein once. Such control conducts controlling, such as, extending the character data of the assembly (ies) on the predetermined memory when the call out of the assembly (ies) is instructed, etc., for example, and therefore having an advantage of enabling an effective use of the memory area, etc.) In the C1 control code are included the following controls, mainly, such as, designation of the character color and the character size, the flashing and the enclosure, for example. In the extended control code is/are included detailed control(s), which is/are not included in the C0 and C1 control codes. In this extended control code is included the control code to be used for designation of the depth display position, for displaying the caption in 3D.

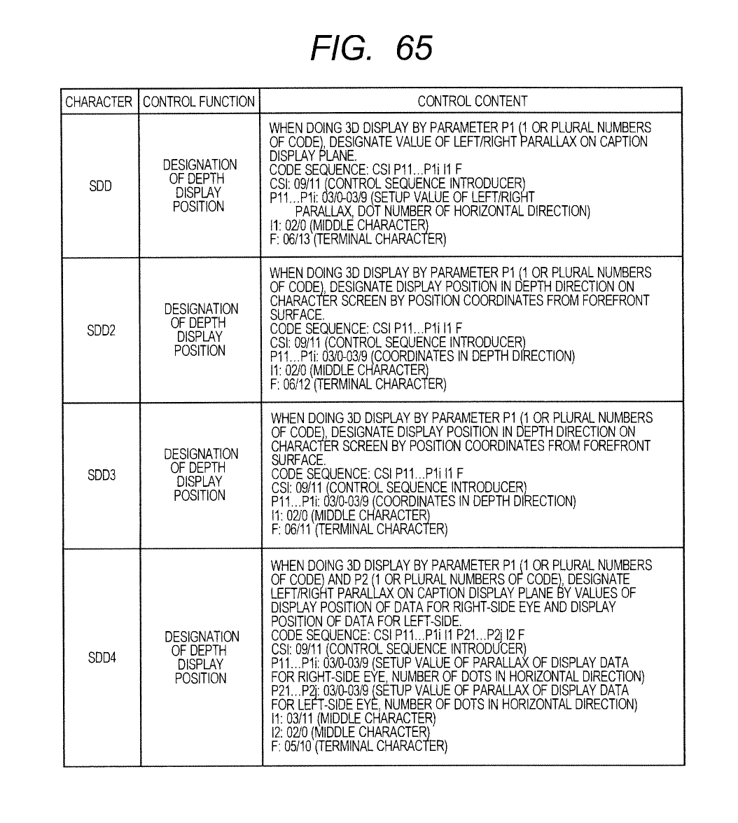

An example of control codes for conducting the 3D display of the caption data is shown in FIG. 65.

A character “SDD” having a control function of “depth display position designation” is provided, newly. In the contents thereof, for example, it designates the depth display position by parallax information of the caption data of 2-viewpoints for the 3D display, following to the value of the CSI (control sequence introducer). Thus, it designates the difference of the display position, between the caption data to be displayed as the video or picture for the right-side eye and the caption data to be displayed as the video or picture for the left-side eye of the 2-viewpoint video, in the horizontal direction. The data is built up, by determining a value for designating the difference of the display position between the left and the right in the horizontal direction by a number of dots, by P11 . . . P1i, following to the CSI information within the control contents, and thereafter continuing “02/0” (the middle character) and “06/13” (the terminal character F). However, a designation value of the terminal character F may be an arbitrary value, as far as it is not coincident with other control codes, and should not be limited to that of the present embodiment.

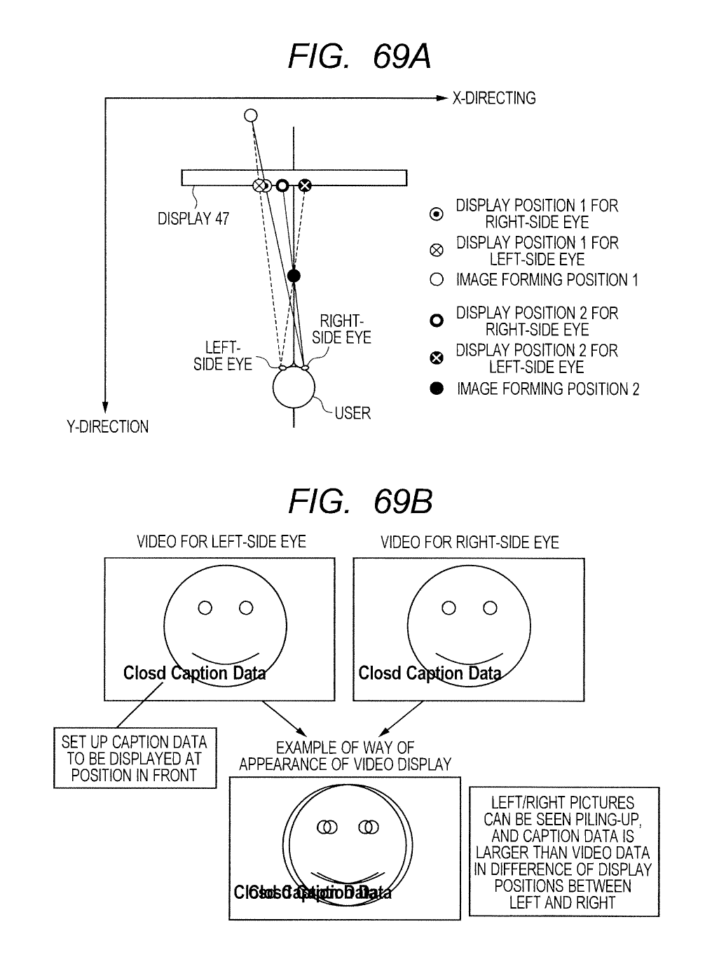

In the receiving apparatus, when superimposing the caption on the 3D program, in the similar manner of preparing two, i.e., a right-eye display area and a left-eye display area, as the display video, two (2) pieces of caption display planes, i.e., a right-eye display area plane and a left-eye display area plane are prepared, and then line data of the same display characters is drawn thereon, so that a parallax is generated on each of the planes. The depth information on the caption display plane at this time may be a value, being determined upon basis of the determination of depth of the display video. Namely, the condition where the right-eye data and the left-eye data are displayed at the same position on the display 47 shown in FIG. 69A (i.e., at the position where the parallax is “0”, and may be also expressed by a position designated when displaying the 2D) becomes a reference or base. And, when designating a value for determining (or setup) the depth display position of the caption data mentioned above, within the video conversion controller portion 61, the character line data to be superimposed together with the right-eye video and the left-eye video is adjusted, in the caption display position thereof, by a dot number of ½ of the setup value, in such a direction that the caption data jumps out. For example, when the setup value is an odd number, it is calculated out by cutting down a value lower than the decimal point. As a method for expressing or presenting the depth, in more details thereof, it is sufficient to make an adjustment, i.e., shifting the character line data to be displayed for the right-side eye to the left in the horizontal direction while shifting the character line data to be displayed for the left-side eye to the right in the horizontal direction. With this, lines of sight interest with, as is shown in FIG. 69A, and there can be obtained a feeling that the picture jumps out from the screen. For example, in case where the setup value of the depth display position comes to “03/4” and “03/0”, i.e., presenting “40”, the display character line data to be superimposed on the picture for the right-side eye is drawn in the direction shifting to the left by 20 dots from a reference display position (i.e., being the display position when conducting the 2D display, and may be designated by the extended control code SDP) of the caption display plane for the right-side eye, while in the direction shifting to the right by 20 dots from the reference display position of the caption display plane for the left-side eye. The character line(s) displayed with such the method as mentioned above, can be seen jumping out in front, and then for the user it is possible to view the caption in addition to the 3D video display.

Also, as other example of designation by means of the parameter P1 in the control contents, the designation may be made so that the display is made at the reference position with a predetermined positive numerical value. For example, the display when P1 is “30” may be the display at a reference surface (i.e., the display position when displaying 2D). In more details, when a value less than “30” is designated, an adjustment is made, i.e., shifting the character line data to be displayed for the right-side eye to the right in the horizontal direction while the character line data to be displayed for the left-side eye to the left in the horizontal direction, depending on the difference between the designated value and a predetermined value of integer. When a value larger than “30” is designated, an adjustment is made, i.e., shifting the character line data to be displayed for the right-side eye to the left in the horizontal direction while the character line data to be displayed for the left-side eye to the right in the horizontal direction, depending on the difference between the designated value and the predetermined value of integer. With doing in this manner, it is possible to make, not only the expression of jumping out from the reference surface, but also an expression of drawing back from the reference surface in depth.

Also, for rising up the presence or realism much more, designation may be made on the character configuration dot, fitting to the setup of the depth display position. In more details, when trying to display the caption data in front than a reference, it may be displayed after being enlarged up to the size larger than a normal display size by designation of the character dot. With this, the user can obtain the presence or realism when the caption data is displayed. Or, when trying to display behind the reference, the caption data may be displayed after being reduced down to the size smaller than the normal display size by designation of the character dot.

However, in case where the receiving apparatus 4 installs a function of adjusting an amount of parallax of the 3D video, the display positions for both the picture display and the caption display may be adjusted, by a unit of dot, in the horizontal direction, depending on an adjustment signal, which is inputted through the user operation. Next, explanation will be given on other method(s) for designating the depth different from the character “SDD” mentioned above. For example, a character “SDD2” is provided having a control function of “depth display position designation”, newly. In the control by “SDD2”, it is assumed that the coordinate designation in the depth direction is made upon basis of a forefront surface of the depth, which can be practiced on the display screen. The data is built up, by determining a value for designating the depth display position upon basis of the forefront surface, by P11 . . . P1i, following to the CSI information within the control contents, and thereafter continuing the middle character I1 and the terminal character F. In case where the setup value is settable up to “100” at the maximum, for example, when an arbitrary value from “0” to “100” is determined by P11 . . . P1i, the receiving apparatus 4 obtains designated width of depth, which can be set up by the video processing processor portion 32, as a ratio (a value designated value of the depth display position)/(the settable maximum value (e.g., “100”), and carries out the caption display while adjusting the display positions in the horizontal direction of the character line data for the right-side eye and the left-side eye, depending on the ratio. For the user, namely, the caption can be seen jumping out to the forefront at the most on the display 47, when the setup value is “0”. On the contrary, as a standard of designation, if it is determined to “0” at the deepest, but there can be also obtained an implementing method and an effect similar to those mentioned above.

Also, explanation will be made on further other method for designating the depth display position. A character “SDD3” having a control function of “depth display position designation” is provided, newly. In the control by “SDD3”, the designation is made by a setup value, designating relativity from the depth display position (i.e., depth of a reference surface) upon basis of the caption display plane. The data is built up, by determining a value for designating a relative depth display position from the reference surface, by P11 . . . P1i, following to the CSI information within the control contents, and thereafter continuing the middle character I1 and the terminal character F. As a method for designating the setup value, for example, in similar manner to that where applying the forefront surface in depth as the reference, designation is made by a ratio. In the display apparatus 4 is carried out the caption display, by adjusting the display position in the horizontal direction of the character line data for the right-side eye and the left-side eye, depending on the ratio designated. For example, in case where the setup value is “0”, this indicates a condition of displaying the data for the right-side eye and the data for the left-side eye at the same place on the display 47 (i.e., the position where the parallax is “0”, and may be also called “the designated position when displaying 2D”). Or, when the setup value is “100”, they are displayed on the forefront surface with providing the maximum parallax, which can be determined by the video conversion processor portion 32, and this indicates to provide an amount of parallax depending on a ratio, which can be obtained by dividing the distance between the position where the parallax is “0” and the position where the parallax is the maximum into 100, when it is an intermediate numerical value.

Also, explanation will be made on further other method for designating the depth display position. A character “SDD4” having a control function of “depth display position designation” is provided, newly. In the control by “SDD4”, the designation is made in the form of parallax information for 2-viewpoints caption data respectively. Namely, on the caption data to be displayed on the picture for the right-side eye of the 2-viewponts picture, and also on the caption data to be displayed on the picture for the left-side eye thereof, for each, the designation is made, how many numbers of pixel should be shifted in the horizontal direction further from the display position, which SDP designates, when the caption data is displayed. The data is built up, by determining a value for designating an amount of shift from the display position, which SDP designates, in the horizontal direction, by a number of dots, by P11 . . . P1i, following to the CSI information within the control contents, and thereafter continuing the middle character I1. Further, following thereto, the data is built up, by determining a value for designating the amount of shift from the display position, which SDP designates, in the horizontal direction, for the caption data to be mounted on the picture for the left-side eye, by P21 . . . P2i, and thereafter continuing the middle character I1 and the terminal character F. In the display apparatus 4, the character line data for the right-side eye is adjusted to the left in the horizontal direction while adjusting the character line data for the left-side eye to the right in the horizontal direction, depending on the values designated. For example, in case where the designated parallax value of the display data for the right-side eye comes to “03/2” and “03/0”, i.e., indicating “20”, while the designated parallax value of the display data for the left-side eye comes to “03/2” and “03/0”, i.e., indicating “20”, the display character line data to be superimposed on the video for the right-side eye is displayed at a position shifting by “20” dots from the reference display position (i.e., being the display position when conducting the 2D display, and may be designated by the extended control code SDP), while displaying it shifting by “20” dots from the reference display position of the caption display plane for the left-side eye. With the method mentioned above, it is also possible to add the depth to the character line(s) to be displayed, and the user can view the caption fitting or in synchronism with the 3D video display.

However, the control contents at this time may designate the display positions not depending on the SDP, for example, by absolute positions on the positional coordinates with using the parameters P1 and P2. With doing so, the receiving apparatus 4 enables the expression from the position where the parallax is “0” to the depth. In that instance, as management of the control code, it may be possible that no SDP is used in common with. Also, in designation of the control contents by the parameters P1 and P2, they may be so determined that the display can be obtained at the position where the parallax is “0”, with using a predetermined integer value. For example, with assuming that the predetermined integer value is “30”, they are so constructed that they designate the display on the reference surface (i.e., the display position when displaying 2D) when P1 and P2 are “30”. In this case, when designating a value less that the predetermined integer value “30”, an adjustment is made for shifting the display character line data for the right-side eye to the right in the horizontal direction, while shifting the display character line data for the left-side eye to the left in the horizontal direction, depending on the values designated. When designating a value larger that the predetermined integer value “30”, an adjustment is made for shifting the display character line data for the right-side eye to the left in the horizontal direction, while shifting the display character line data for the left-side eye to the right in the horizontal direction, depending on the values designated. With doing so, it is also possible to express the depth from the reference surface.

Also, the control contents at this time may be reversed in the order or sequence of designations at the 2 viewpoints by the parameters P1 and P2 (i.e., designation for the caption data for the left-side eye may be made by the parameter P1, while designation for the caption data for the right-side eye by the parameter P2).

If anyone is selected among the plural numbers of the control codes for designating the depth display position mentioned above, and is outputted from the transmitting apparatus 1, the 3D display of the caption can be made on the receiving apparatus 4 enabling to deal with. Also, it may be transmitted from the transmitting apparatus 1 with using the plural numbers of the control codes for designating the depth display position. When the plural numbers of the control codes for designating the depth display position at one time, for example, the receiving apparatus 4 may determined the display position of the caption depending on the control code for designating the depth display position, which is received at the last. Or, the receiving apparatus 4 may detect a control code corresponding to the method for designating the depth display position, which it can be deal with, among the plural numbers of the control codes for designating the depth di splay position, which are transmitted from the transmitting apparatus 1, so as to determined the display position of the caption.

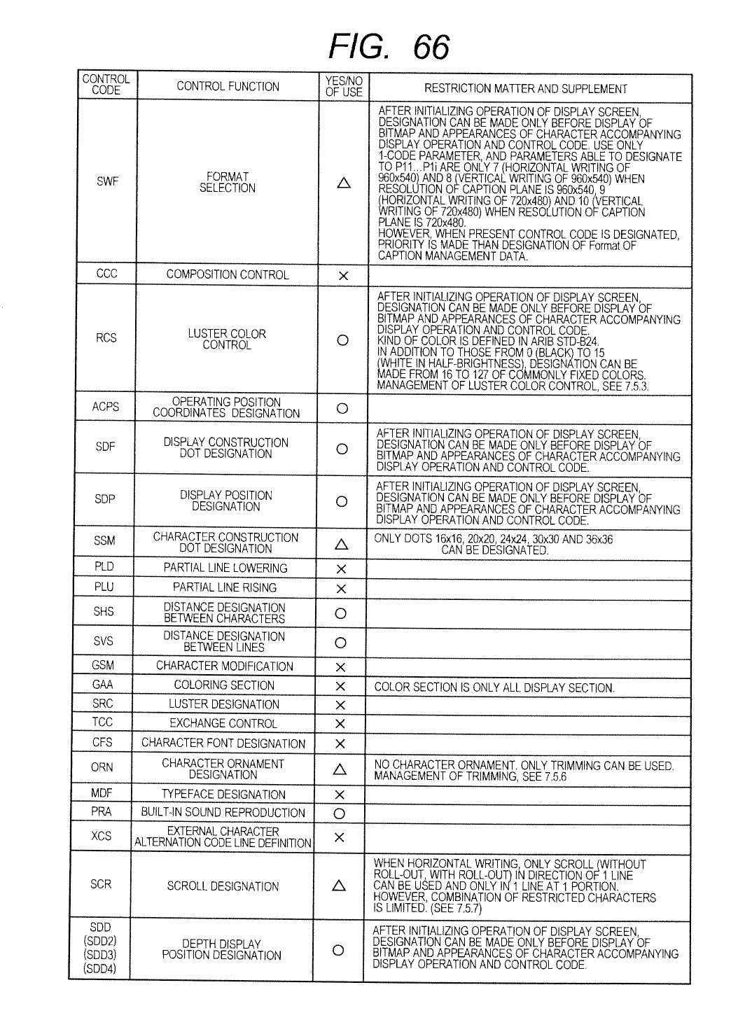

As was mentioned above, the control codes to be applied in the caption are as were explained by referring to FIGS. 64 and 65: however, in FIG. 66 is shown an example of restrictions of the extended control codes, within the transmitting apparatus 1. Restrictions of the extended control code SDD for designating the depth display position are as follows. It may be managed, being made usable regarding “yes/no” of the use thereof, but as other restriction matters, after an initializing operation of the display screen, which will be mentioned later, designation may be made thereon, only when the character(s) and/or the control code(s) appear(s), accompany with the display of the bitmap and the displaying operation thereof. With provision of such restriction, it is possible to build up a control sequence similar to the designation of the display position and/or designation of display configuration dots, other than the designation of the depth display position, within the receiving apparatus 4. For example, restrictions for SDD2, SDD3 and SDD4 may be provided in the similar manner.

With applying the control codes, according to the present embodiment explained in the above, since it is possible to designate the position for the depth display position/parallax information upon each initializing operation of the display screen, change can be made for an arbitrary number of character(s). For example, designation can be made for each one (1) line of the caption data to be displayed, and of course, since the initializing operation can be installed on the way of a line, the designation of the position can be made even for each (1) character of the caption data to be displayed. The receiving apparatus 4, reading out the control codes explained in the above, calculates the display positions for the videos for the right-side eye and the left-side eye, respectively, for achieving the depth designated on the caption data within the range where the control contents of the control codes are effective, and superimposes the caption data on the video data.

Also, as the control contents for transmitting with the control code for designating the depth display position, the depth information may be transferred, for presenting the display position of the forefront surface in the depth, which can be settable within a program. For example, it is apparent that an amount of parallax between the left and the right could shift up to “20” pixels at the maximum, when producing the video, then in the transmitting apparatus 1, the setup value of the parallax between the left and the right is always set at “20” when transmitting. With doing so, on the receiving apparatus 4, it is possible to display the video or picture having no uncomfortable feeling, by displaying the caption on the forefront surface of the picture displayed, always, with using this setup value “20” when displaying the 3D. For example, if the receiving apparatus 4 includes a function for adjusting strength/weakness of the 3D display effect, for example, it may be sufficient to apply a value of “20” as the default value for the parallax, and may be changed to be same to the parallax amount of the video data when designation is made on the strength/weakness by the user.

Also, upon basis of such configuration as was mentioned above, in case of the receiving apparatus not being enabled to deal with the 3D program display, for example, it is possible to display the caption data on the 2D screen, by neglecting this extended control code; i.e., building up the data configuration not brining about an erroneous operation even in the conventional types of apparatuses.

No such designation as mentioned above is made, on the depth display position in the caption data on the 3D program, the receiving apparatus 4 can conducts the display of the caption data under the condition of no parallax, or can applies a method of presenting it on the forefront surface, which can be set up within the video conversion processor portion 32.

However, although the control codes for executing the 3D display are described as part of the extended control code in the present embodiment, but the present invention may be achieved by including them in other control codes (e.g., the C0 or C1 code), and the character name or title thereof may be presented, other than that of the present embodiment. When applying the control codes for designating the depth display position in the C0 control code or the C1 control code, the position of describing the information for designating the depth position within the management restrictions shown in FIG. 66 is also changed, appropriately.

<Restrictions in Other Transmitting Operations>

In the operation of transmitting the caption data within the transmitting apparatus 1, for example, for brining the information for designating the depth display position to be effective only when the program as the target includes the 3D video therein, as a restriction in the transmitting operation may be provided a restriction, such as, the designation of the depth display position can be transmitted only when the program characteristics indicated by the content descriptor or the like is “video of a target event (e.g. program) is 3D video” or “3D video and 2D video are included in the target event (program)”, and so on.

Also, regarding the caption data on the broadcasting, it is possible to set up a presenting method, among various character ornamentals or the like, such as, a flashing (blinking), an underline or a scroll, etc., for example. On the 3D display of the caption data, by taking a fatigue/load of the user due to viewing/listening of the 3D program into the consideration thereof, there may be provided a restriction in a combination between the method of the character ornament and the display applying the depth therein. For example, as a restricted matter in the flashing when conducting the 3D display of the caption data, it is assumed that a number for colors of the flashing can be designated up to 24 colors in total (including neutrals of 4 gradation fonts), at the same time, for use of flashing of a character line of 8-units codes, separating from 128 colors of common fixed colors for non-flashing characters and the bitmap data. For use of flashing the bitmap data, it is assumed that designation can be made up to 16 colors in total, at the same time. In the caption, it is assumed that 24 colors in total can be designated, arbitrarily, at the same time, among from 128 colors of the common fixed colors. In the character superimposing, it is assumed that 40 colors (i.e., 24 colors for the character+16 colors for the bitmap data) in total can be designated, arbitrarily, at the same time, among from 128 colors of the common fixed colors. Also, it is assumed that the flashing has only that having the positive phase. Also, it is is inhibited to mix up with the trimming. And also, it is inhibited to mix up with the scroll designation. It is assumed that a number of colors of flashing can be designated up to 24 colors in total (including the neutrals of the 4 gradation fonts) for use of flashing the character line(s) of 8-units codes, separating from the 128 colors, separating from 128 colors of common fixed colors for non-flashing characters and the bitmap data. For use of flashing the bitmap data, it is assumed that designation can be made up to 16 colors in total. In the caption, it is assumed that designation can be made on 24 color in total (i.e., the 24 colors for the characters), at the same time, among from the 128 colors of the common fixed colors. In the character superimposing, it is assumed that 40 colors (i.e., 24 colors for the character+16 colors for the bitmap data) in total can be designated, arbitrarily, at the same time, among from 128 colors of the common fixed colors. Also, it is assumed that the flashing has only that having the positive phase. Also, it is inhibited to mix up with the trimming. And also, it is inhibited to mix up with the scroll designation. And, it is inhibited to mix up with the designation of the depth display position.

Or alternately, an example of the matters restricted in the management of the scroll designation (SCR) when conducting the 3D display of the caption data, hereinafter.

It is inhibited to designate the SCR by a plural number of times within the same text. When conducting the scroll, an area for display one (1) line is transmitted, by means of SDF, as a data unit (text) different from that designated. As an operation of the receiver when the scroll is designated, the scroll is executed within a rectangular area or region, which is designated by SDF and SDP, but drawing is not made in an outside of the rectangular area. Also, it is assumed that an imaginary area for one (1) character (having a sized designated) lies on the left-side of a first line in the display area, and at the time when the scroll designation (SCR) is made, an operating position is reset within the imaginary write-in area. The characters, which are written in the display area before the scroll designation, are deleted after the scroll designation is made. They are displayed from a right-side end of the display area, starting from a first character thereof. Also, a start of the scroll is made by writing the character into the imaginary write-in area. Also, when no rollout is made, the scroll is stopped after displaying the last character. Or when the rollout is made, then the scroll is continued until when the characters are distinguished. Also, when receiving data to be displayed next during the scroll, the receiver waits until when the scroll is ended. Also, when the inter-character value or the inter-line value, being designated from the time when the scroll starts until the time when the scroll ends, exceeds the maximum value within the display section, then the scroll display depends on the installation of the receiver. Also, it is inhibited to mix up with the designation of the depth display position.

In the similar manner, in relation to the designation of the character ornamental method (i.e., a polarity inversion, lusters color control, an enclosure, an underline, a trimming, shading, a gothic, an italic, etc.), there may be provided a restriction of inhibiting from being mixed up with the designation of the depth display position.

<Example of Operation of Receiving Apparatus>

Hereinafter, explanation will be given on an example of operation when the receiving apparatus 4 receives content including the caption data therein, which is transmitted from the transmitting apparatus 1.

<Initializing Operation of Caption>

In the initializing operation, the receiving apparatus 4 executes an initializing operation for the caption management when it is renewed, when a data group of the received caption management data is exchanged from a group “A” to a group “B”, or when it is exchanged from the group “B” to the group “A”. In this instance, the display area and the display position come to predetermined initial values, respectively, and then also the depth display position may be released from the designated value thereof, which has been designated by the control code up to that time. With that initial value for designating the depth display position of the caption data, it is assumed to be in the condition that the data for the right-side eye and the data for the left-side eye are displayed at the same position on the display shown in FIG. 69A, for example (i.e., the position where the parallax is “0”, and may be presented as the designated position when displaying 2D).

Timing for executing the initialization is assumed to be the time, which will be shown below.

As an initialization by the caption characters, the receiving apparatus 4 executes an initializing operation when receiving the caption character data, being same in the set and/or the language, to the data group being under the process for displaying. Namely, it execute the initializing operation by detecting an ID value, which is included in a data group header of the caption PES data.

Also, as an initialization by means of the text data unit, the receiving apparatus executes the initializing operation, just before a receiver presenting process of the text data unit, when the text data unit is included in the caption character data, when receiving the caption character data, being same in the set and/or the language. Namely, it execute the initializing operation on a unit of the data unit.

Also, as an initialization by means of the character control code, the receiving apparatus executes that initializing operation just before a receiver executing process for a screen deletion (CS) and a format selection (SWF). Since this control code can be inserted at an arbitrary position, the initializing operation can be executed by an arbitrary unit of character(s).

That mentioned in the above means that; i.e., it is possible is to change the depth display position of the caption data, at any timing, arbitrarily, by conducting the designation of the depth display position at every time when executing the initialization.

<Example of Caption Data Receiving Control of Receiving Apparatus>

As an example of an operation within the receiving apparatus 4, a number of the captions/character superimposing, which can be displayed at the same time, may be one (1) for the caption and one (1) for the character superimposing, i.e., 2 in total thereof. Also, the receiving apparatus 4 is constructed in such a manner that it makes the controls for presenting the caption and for presenting the character superimposing, independently. Also, the receiving apparatus 4 controls the caption and the character superimposing, principally, so that the display areas thereof do not pile up with each other. However, in case where those displays must file up, the character superimposing is displayed in front prior to the caption. Also, in each of the caption/character superimposing, respectively, if the bitmap data and the text, or the bitmap data themselves file up, a postscript has the priority. The caption/character superimposing in a data broadcasting program is/are displayed, with the size and at the position thereof, determined upon basis of the entire screen area thereof. Also, the receiving apparatus 4 determines presence/absence of transmission of the caption data upon the presence/absence of receipt of the caption management data. Display of a mark for noticing receipt of the caption to the view/listener, display of the caption, and deletion thereof are made, mainly, upon basis of that caption management data. By taking an interruption of transmission of that caption management data during CM, etc., into the consideration thereof, a timeout process may be conducted if not receiving the caption management data for three (3) minutes or longer than that. Further, upon the caption management data may be conducted a display control in cooperation with other data, such as, EIT data, etc.

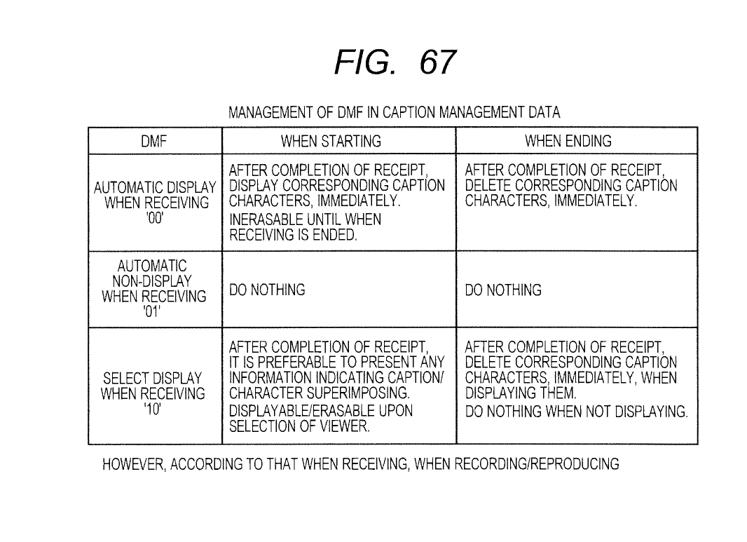

Operations of the receiving apparatus 4 when starting and ending the display of the caption/character superimposing are shown in FIG. 67. However, the starting indicates “starting display of the caption, which is designated by the caption character”, and ending indicates “deleting the caption character(s)”. The receiving apparatus 4 conducts the starting of the display of the caption, which is designated by the caption character and the deletion of the caption character(s), as is shown in FIG. 67, in accordance with DMF within the caption management data explained bt referring g to FIG. 56A. Also when receiving a 3D program, to which the caption data is given or attached, i.e., thereby displaying the video and the caption data in 3D, the receiving apparatus 4 follows that DMF. For example, if it is an automatic display when receiving, the system controller portion 51 displays the caption data upon basis of the designation of the depth display position mentioned above. If being an automatic non-display when receiving, it does not display the caption data when starting. If being selective display when receiving, it conducts display/deletion depending on selection of the user.

Next, as an operation relating to the setup of the caption/character superimposing within the receiving apparatus 4 may be conducted the following. For example, the receiving apparatus 4 displays the caption and the character superimposing of the language, which is selected just before through an input of the user operation. For example, in case where a caption of a second (2^{nd}) language is selected through the input of the user operation during viewing/listening of the program, then the caption of the second (2^{nd}) language is displayed when another program attached with the caption is started. Also, with the initialization setup when the receiver is shipped, a first (1^{st}) language is displayed. Also, the receiver enabling the setup of a language code, such as, Japanese language and English, etc., displays the caption/character superimposing in accordance with the language code determined. Also, if the caption/character superimposing of the language code, which is determined in the receiver, is not send out, the receiver display the caption/character superimposing of the first (1^{st}) language.

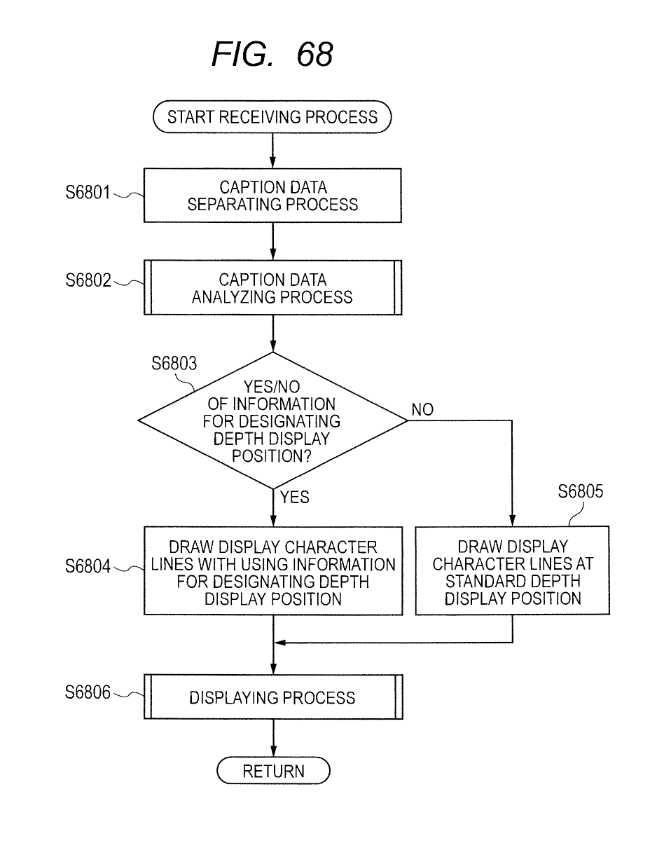

Explanation will be given on controlling steps when the receiving apparatus 4 receives a stream including the caption data mentioned above and the video for 3D display and superimpose the caption data on the video data to be displayed in 3D, by referring to FIG. 68. When radio waves broadcasted are received, in S6801, the caption data, after passing through a tuner 23 and a descrambler 24, is separated within a multiplex/demultiplex portion 29, and is memorized on a volatile memory not illustrated in FIG. 25, and then the process advances to S6802. In S6802, the system controller portion 51 of the CPU 21 reads out the caption character data memorized on the memory, and then the caption character data is analyzed within the video conversion controller portion 61 of the CPU 21, and determination is made on the control code, and thereafter the process advances to S6803. As the process for the caption data at this instance may be made the operation for the caption data mentioned above. In S6803, determination is made on presence/absence of the information for designating the depth display position within the 3D video content, and if that information for designating the depth display position is therein, the process advances to S6804, and if no such information, the process advances to S6805. In S6804, the character line data to be displayed for the right-side eye and the character line data to be displayed for the left-side eye are drawn on the caption display planes, respectively. In this instance, depending on a result of the analysis of the information for designating the depth display position by means of the video conversion controller portion 61 of the CPU 21, the positions are determined for drawing the character line data to be displayed for the right-side eye and the character line data to be displayed for the left-side eye. After drawing, the process advances to S6806. In S6085, since not designation is made on the depth display position, the video conversion controller portion 61 draws the character line data to be displayed for the right-side eye and the character line data to be displayed for the left-side eye on the caption display planes, respectively, with applying a position for drawing, which can be obtained from a standard depth (parallax) information, stored in a memory not shown in the figure in advance. As the standard depth (parallax) information may be determined information in advance, and it may be stored in the memory not shown in the figure. In this instance, as an example of the depth display position indicated by the standard depth information may be a display position, i.e., the forefront surface, which can be displayed by the video conversion processor portion 32, for example. In this instance, since the caption display always fuses at the position in front with respect to the 3D video, it is possible to display the caption without uncomfortable feeling. After drawing, the process advances to S6806. In S6806, the system controller portion 51 and the video conversion controller portion 61 of the CPU 21 superimpose the respective display area planes produced in S6805 and the respective video display planes, and also control the video conversion processor portion 32, so that also the OSD data produced in the ODS producer portion is superimposed thereon, depending on the necessity thereof. The video data superimposed is displayed on the display 47, or outputted from the video output 41, and then the process is completed. With repetition of such series of processes as was mentioned above, for each caption data, it is possible to display the caption in 3D, preferably. For example, such processes as was mentioned above may be repeated, continuously, during receipt of the radio wavers broadcasted, within the receiving apparatus 4.

However, the depth display position, which the depth information indicates, shown in S6805, may be other position. For example, the position where the parallax is “0” (under the condition of no parallax between the character line displayed for the right-side eye and the character line displayed for the left-side) is a standard depth display position. Also, for example, new parameters of standard parallax information may be set up for presenting a standard parallax of the display data for the right-side eye and the display data for the left-side eye, and those parameters may be stored in a new descriptor, or those parameters may be stored in a part of the existing descriptor. Those parameters may be transmitted from the transmitting apparatus 1, being combined with the program information, such as, PMT, etc., to be received by the receiving apparatus 4, so that the determined can be made with using the parameters received in the receiving apparatus 4.

In the place of the processes starting from S6805, the caption may be controlled not to be displayed, when no control code is included for designating the depth display position within the caption data. For example, this can be achieved by allowing the video conversion controller portion 61, in S6805, to draw the video data on the video display plane, but not draw the display character data on the caption display plane. In this case, it is possible to avoid the display under the condition having an inconsistency between the video data in the depth display position. Also, if no control code for designating the depth display position is included within the caption data, the data for use in display may be drawn on the caption display plane at the position of no parallax, to be displayed. In this case, there is still a possibility of bringing about the inconsistence between the video data in the depth display position, but it is possible to avoid at least the caption from non-display.

Also, in the example of the control mentioned above was shown the case where the composing or combining of the caption data and the video data is executed within the video conversion controller portion 61 and the video conversion processor portion 32 of the CPU 21; but those processes can be also executed within the OSD produce portion 60 of the CPU 21, in the similar manner, and may be executed by providing a processing block and/or a controller portion, differently, not shown in the figure.

Also in case where the content is inputted to the receiving apparatus 4 via the network 3, the stream data including the caption data is received through the network I/F 25, and the separation process is made on the caption data within the multiplex/demultiplex portion 29, i.e., the caption enabled with the 3D display can be viewed with the control, being similar to the example of the control where receiving the broadcast mentioned above.

An example of display of the caption information, which is executed by the control explained in the above, is shown in FIGS. 69A and 69B. The method for generating the parallax by shifting the positions of displaying the video for the right-side eye and the video for the left-side eye is as was explained previously. Herein, FIG. 69A is an explanatory view of a simplified model for showing the positions of displaying the display data for the right-side eye and the data for the left-side eye, and the depth of the fusing position of the target of display by the function of a brain of the user. Regarding a certain first display target data, when it is displayed at the display position 1 for the right-side eye on the display area for the right-side eye while at the display position 1 for the left-side eye on the display area for the left-side eye, they are in fusion at the fusion position 1 in the brain of the user, and as a result thereof, the data of the target of display is sensed to locate in the depth than the display surface of the display 47. On the other hand, when a certain second display target data is displayed at the display position 2 for the right-side eye on the display area for the right-side eye while at the display position 2 for the left-side eye on the display area for the left-side eye, they are in fusion at the fusion position 1 in the brain of the user, and as a result thereof, the data of the target of display is sensed to jump out in front than the display surface of the display 47. Namely, in relation to the display of the caption data, by shifting the character line data to be displayed for the right-side eye to the left in the horizontal direction while shifting the character line data to be displayed for the left-side eye to the right in the horizontal direction, the fusion position comes close to the user; i.e., the caption data can be seen jumping out from the screen in the brain of the user. However, there is no necessity that the amounts of shifting in the left and the right directions are always same to each other. Accordingly, it is possible to display the picture having no uncomfortable feeling when displaying, by determining the parallax of the caption data in such a manner that the caption data comes in front that the video data in the display positions thereof. Namely, for the caption data to be displayed together with a 3D video data including the picture for the left-side eye and the right-side eye, the parallax is provided in the horizontal direction so as to be displayed in front than the video data. The picture for the left-side eye and the picture for the right-side eye shown in FIG. 69B, which are produced in this manner, respectively, are displayed, alternately, as was shown in FIG. 37A or 39B, the pictures are displayed on the display 47, like a manner of seeing of the displayed picture, and therefore, for the user, it is possible to view this, as the 3D picture superimposing the caption thereon, with using an assistance device, such as, glasses equipped with filters of the active shutter method, etc., for example.

Also, explanation will be given on an operation of the receiving apparatus 4, when the caption data including therein the information for designating the depth display position, which is shown in the present embodiment, is included within the content not including the 3D video therein.

For example, when the program information analyzer portion 54 in the receiving apparatus 4 detects the value of the program characteristics, which is indicated by the content descriptor shown in FIG. 50, and the system controller portion 51 determines that no 3D video is included in the target event (e.g., the program), the processes are executed in such a manner that the 3D display of the caption data is not conducted even if the information for designating the depth display position, which is included in the caption data. With doing that, it is possible to avoid the display of the picture, superimposing the caption data of 3D on the 2D picture, being difficult for the user to view.

<When Displaying 3D Video in 2D>

Upon receipt of the 3D contents of the “3D 2-viewpoints separate ES transmission method”, when the user instructs to exchange or switch the display to the 2D video during or before the viewing/listening thereof (for example, pushes down the “2D” key of the remote controller), the user instruction receive portion 52 receiving information of the exchanging instruction mentioned above instructs the system controller portion 51 to switch the signal into the 2D video. In this instance, it is so determined that it displays the caption in 2D even when the information for designating the depth display position is included in the content received.

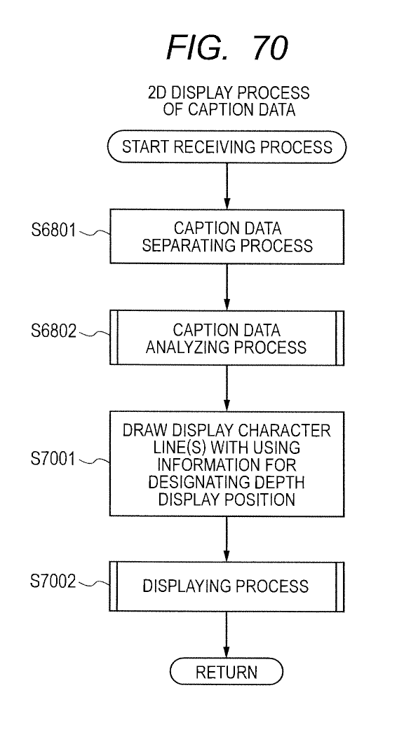

An example of a sequence of processing in relation to the determination of the depth position of the caption is shown in FIG. 70, when the receiving apparatus receives the picture transmitted in the form of the 3D video, to be viewed/listened in 2D (for example, the case shown in FIG. 40A).

After receipt of the stream including the caption data therein, and after analyzing the caption data through the processes similar to S6801 and S6802, the video conversion controller portion 61 of the CPU 21 draws the character line to be displayed for the right-side eye on the display area plane for the right-side eye, and draws the character line to be displayed for the left-side eye on the display area plane for the left-side eye, in S7001, upon the information for designating the depth display position, when it detects that, and then advances the process to S7002. In S7002, the system controller portion 51 and the video conversion controller portion 61 of the CPU 21 produce the data for use of display, for example, superimposing the video data to be displayed for the left-side eye, the caption display plane for the left-side eye and the OSD display plane, in the similar manner to that of S404. Herein, in the displaying, the 2D display is achieved by only displaying either one of the data for use of display for the two (2) viewpoints produced. As the data to be displayed at this time, it is enough to utilize the picture for the left-side eye and the caption data of the picture for the left-side eye. After the display processing mentioned above, the processes are ended. By conducting the processes mentioned above, repetitively, every time when receiving the caption data, it is possible to display the caption in 2D, preferably. Also, the exchange between the displays in 3D/2D can be made at high speed, since it can be achieved by changing only the displaying process of S7002, i.e., the last process.

However, not being restricted to the present example, the above may be achieved by a method of producing the caption plane for use of display by only one (1) piece to superimpose it on the display picture of either one of the picture to be displayed for the right-side eye or the picture to be displayed for the left-side eye.

According to the present embodiment, with executing the 2D display on the caption data, too, when outputting/displaying the 3D content in 2D, for the user it is possible to view/listen the program without the uncomfortable feeling.

Also, implementation of those processes shown by the present sequence may be made within the step S404 shown in FIG. 41, or may be made at the same time. With conducting the control mentioned above in synchronism with the process for displaying the picture in 2D, the system controller portion 51 enables to view/listen the program without the uncomfortable feeling, while fitting the timing between the 3D/2D display of the picture and the 3D/2D display of the caption data.

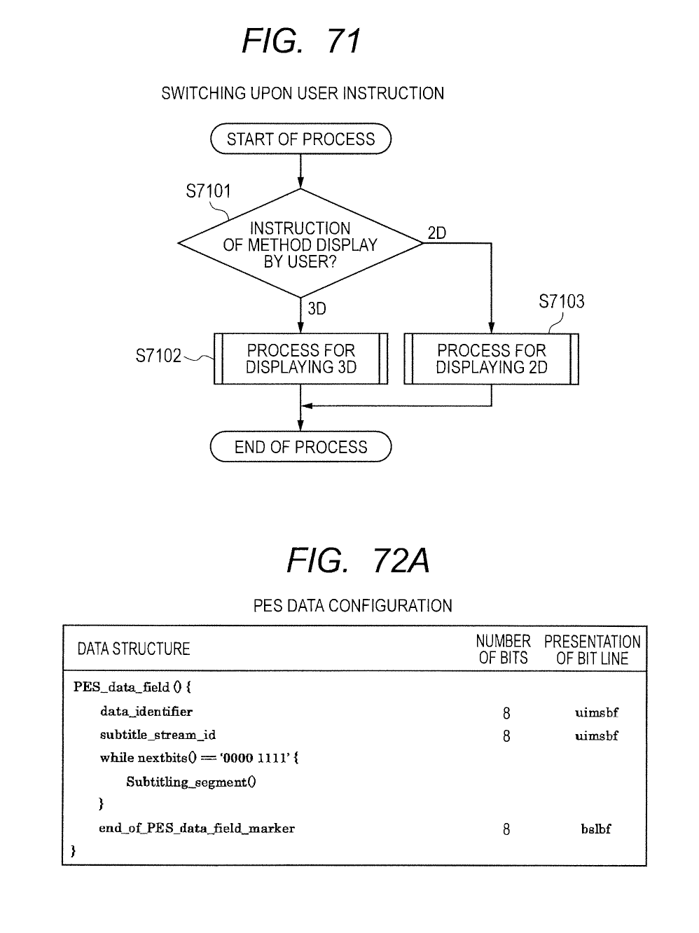

FIG. 71 shows an example of a sequence for exchanging the display of the caption when an instruction for exchanging 3D/2D display of the 3D content is made by the user, The processing is started when the instruction for exchanging 3D/2D is given from the user during the time when receiving the 3D content. In S7101, the process advances to S7103 when the instruction for exchanging is an instruction to exchange from the 3D video display to the 2D video display. In 7102, the system controller portion 51 exchanges the method into that for displaying the caption data in 3D, accompanying with the process of exchanging the method into that for displaying the video signal in 3D, and thereby ends the process. In this instance, the 3D display of the caption data is achieved by the sequence of processes shown in FIG. 68. In S7103, the system controller portion 51 exchanges the method into that for displaying the caption data in 2D, accompanying with the process of exchanging the method into that for displaying the video signal in 3D, and thereby ends the process. In this instance, the 2D display of the caption data is achieved by the sequence of processes shown in FIG. 70.

According to the present embodiment, when the picture of the 3D content is displayed/outputted in 3D, then the caption data is also displayed/outputted in 3D, while the caption data is also displayed/outputted in 2D, when the picture of the 3D content is displayed/outputted in 2D. With this, 3D/2D display of the caption data can be achieved responding to outputting/displaying of the 3D content, and for the user, it is possible to view/listen the program without the uncomfortable feeling.

<Caption Display when 2D Video is Convertible into 3D in Receiving Apparatus 4>

Explanation will be made on a case when the receiving apparatus 4 converts the 2D video data into the 3D video within the receiving apparatus to display, after receiving it, while the broadcast signal, including the caption data and the 2D video data therein, is transmitted from the transmitting apparatus. Conversion of the 2D video data into 3D is executed by a converter circuit, which may be included in the video conversion processor portion 32, or through software processing by means of the CPU 21. In this instance, no information for designating the depth display position is added to the caption data received. Accordingly, in the similar manner to that executed in S6805 shown in FIG. 68, may be constructed in such a manner, the parallax information is determined so that the caption information can be displayed on the forefront surface in the depth direction. With such construction as mentioned above, it is possible to prevent the inconsistency from being generated in the depth display position between the video data and the caption data, when displaying them in 3D after the conversion thereof.

Also, in this instance, because of an assumption of the 2D display in the transmitting apparatus 1, there are cases where the control code(s), not appropriate for use in common with the 3D display, is/are applied into the control information of the caption. For that reason, in the receiving apparatus 4, the display is made, but without executing the instruction of the control code, not appropriate for the 3D display, such as, a control brining about an anxiety that the user may be fatigue when viewing/listening if applying it when displaying the caption in 3D, etc. For example, no scrolling process will be made with using the control code designating the scroll, nor the flashing operation with using the control code for the flashing control. With this, it is possible to achieve the 3D view/listen of the picture and the caption, preferably much more.

On the other hand, by taking the case of displaying the 2D video in 3D into the consideration thereof, in case where the 2D video data is transmitted from the transmitting apparatus 1, including the information for designating the depth display position in the caption data accompanying therewith, the receiving apparatus 4 determines if the corresponding program is the 3D program or not, in the similar manner to that of S401 and S402 shown in FIG. 41, for example, and if it is the 2D program and is displayed in 2D, the caption is also displayed in 2D, without referring to the information for designating the depth display position. If that program is the 2D program and further it must be displayed after the conversion into 3D, the caption is displayed in 3D by referring to the information for designating the depth display position.

<Other Example of Operation for Transmitting Caption Data>

Explanation will be given, hereinafter, on other example of the method for inserting the data for controlling the parallax of the caption data into the content, when the 3D video is transmitted from the transmitting apparatus with “3D 2-viewpoints separate ES transmission method”.

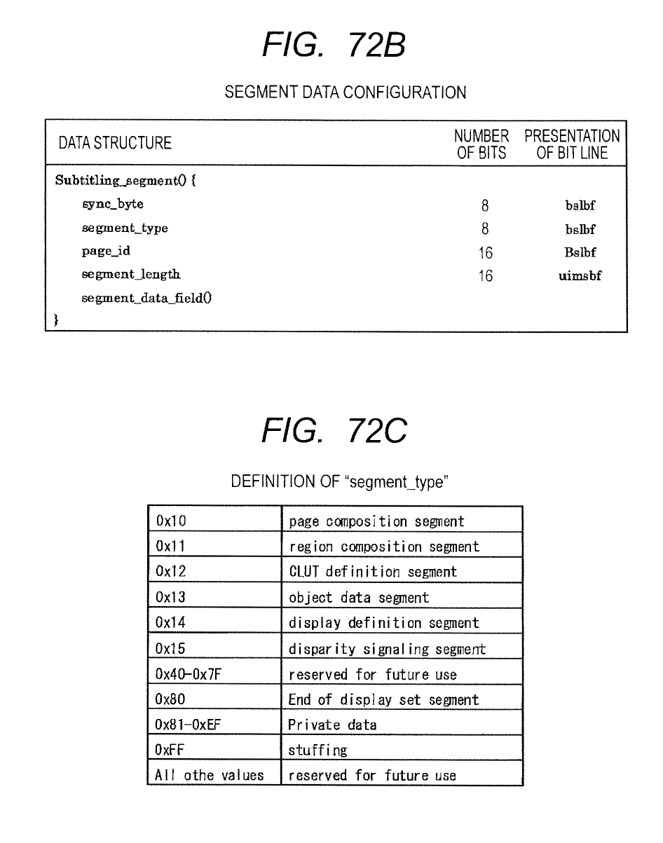

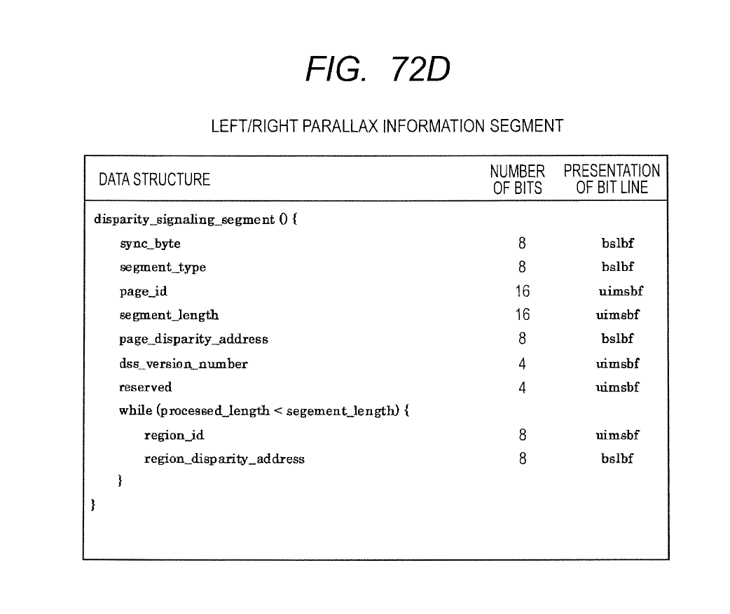

FIG. 72A shows an example of the format of PES data, including the caption data therein, according to the present embodiment. “data_identifier” is an identification number of the caption PES data, being determined uniquely. For example, it may be a fixed value, such as, “0x20” or so on. “subtitle_stream_id” is an identification number for indicating, uniquely, that the corresponding PES packet is the caption data. Following this is inserted segment data. For example, it may be a fixed value, such as, “0x00”, etc. “subtitle_stream_id” is an identification number for designating the present caption data, uniquely, from PTM of the program. Following this is inserted the segment data. “end_of_PES_data_field_marker” is a fixed value for indicationg an end of the caption PES data. For example, it may be 8-bits information, i.e., a line of information, such as, “111 111”, and so on.

FIG. 72 B shows the structure or configuration of the segment data, which is designated in FIG. 72A. “sync_byte” is a value, being determined uniquely, for identifying the segment data on the receiver. A definition value, which “segment_type” can designate, will be mentioned later. In “page_id” is designated a page number for selecting the position to display the caption data. “segment_length” indicates length of data following thereto. In “segment_data_field” is a definite data included in each segment, i.e., defining what kind of information is included therein.

FIG. 72 C shows the definition of the “segment_type”, exemplarily, being the kind of the segment relating to the caption.

For example, there is defined “object data segment” including the character line information of the caption, a page or an region where the caption is displayed, or segment data relating to color management, etc. In this example, “segment_type” for determining the parallax of the caption data is newly defined to “0x15 (Disparity_signaling_segment)”

FIG. 72 D shows an example of the data configuration of left-right parallax information segment “disparity_signaling_segment”. “sync_byte” is a value, being determined for identifying to be the segment, uniquely. For example it may be a value “0000 1111” by 8-bits information. “segment_type” designates the value of “0x15” defined in FIG. 72C, and confirms the kind of the segment to be “disparity_signaling_segment”. “page_id” determines the page number, on which this information of segment is applied. “segment_lengthe” indicates the information length of the segment just following thereafter. The parallax information presents the parallax between the left and right screens, for example, by a unit of sub-pixel. “dss_version_number” indicates a version of this “disparity_signaling_segment”. The receiving apparatus can determine the dataformat following thereafter with using this version. “region_id” designates the identification number of the region corresponding thereto, for defining the parallax for each region, being a unit the display position, which is much finer than the page. “region_disparity_address” presents and designates the parallax on the left and right screens, by a unit of the sub-pixel, for example, in relation to the region corresponding thereto. With this, it is possible to display even when there are plural numbers of the caption data, with assigning the depth (parallax) information differing from, to them, respectively, and thereby displaying them at the depths differing from each other.

Upon basis of such data configuration as was mentioned above, the information having this “segment_type” is neglected in the receiving apparatus not enabled to deal with the 3D program display, and the ordinary caption data can be displayed on the 2D screen. With this, it is possible to obtain an advantage that the conventional types of apparatuses do not make malfunctions even if transmitting the content including the caption data, applying the left/right parallax information segment shown in FIG. 72D, newly.

The operation of the receiving apparatus, for the control data having such data configuration, applying the left/right parallax information segment mentioned above therein, is that, which can be obtained by changing “information for designating depth display position” in the example of operations shown in FIGS. 68, 70 and 71, into “left/right parallax information segment”. In the S6805 shown in FIG. 68, in particular, when no left/right parallax information segment is included within the 3D video content received, the display character line of the caption may be displayed, with using the information of the predetermined left/right parallax information segment, while storing this in a memory in advance, as the standard information of the left/right parallax information segment. Other operation(s) is/are same to that shown in FIGS. 68, 70 and 71, and therefore the explanation thereof will be omitted herein.

The examples of the configurations shown in FIGS. 72A, 72B, 72C and 72D should not be limited to an alignment of the data, the title, the data size/type shown in each figure, necessarily, similar information may be included therein.

With using such left/right parallax information segment as was explained in the above, it is possible to achieve the determination of depth in relation to the caption data for use in the 3D display.

<Further Other Example of Operation of Caption Data Transmission>

Further other example of the method for inserting the caption data and the data for use of control of the parallax thereof will be shown hereinafter, in case where the 3D video is transmitted from the transmitting apparatus 1 with the “2-viewpoints same ES transmission method”.

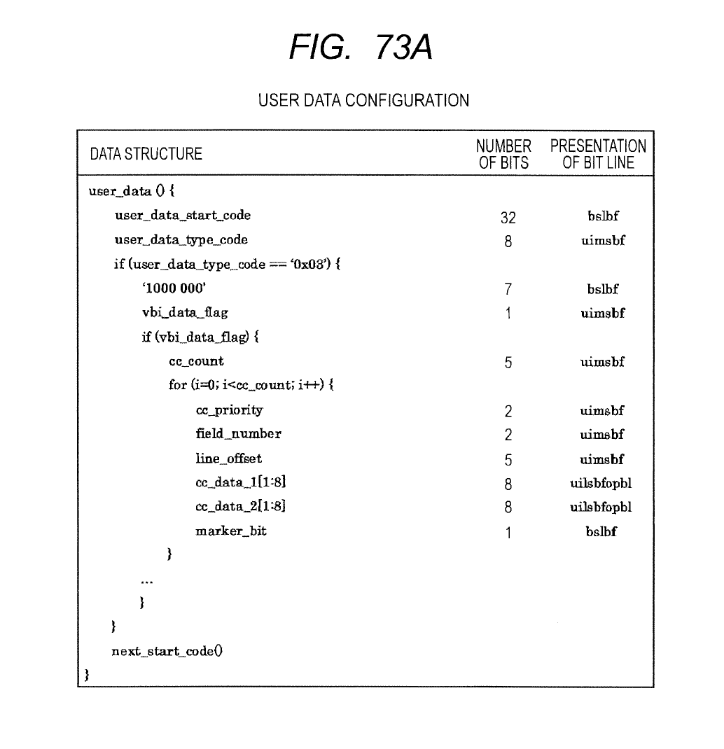

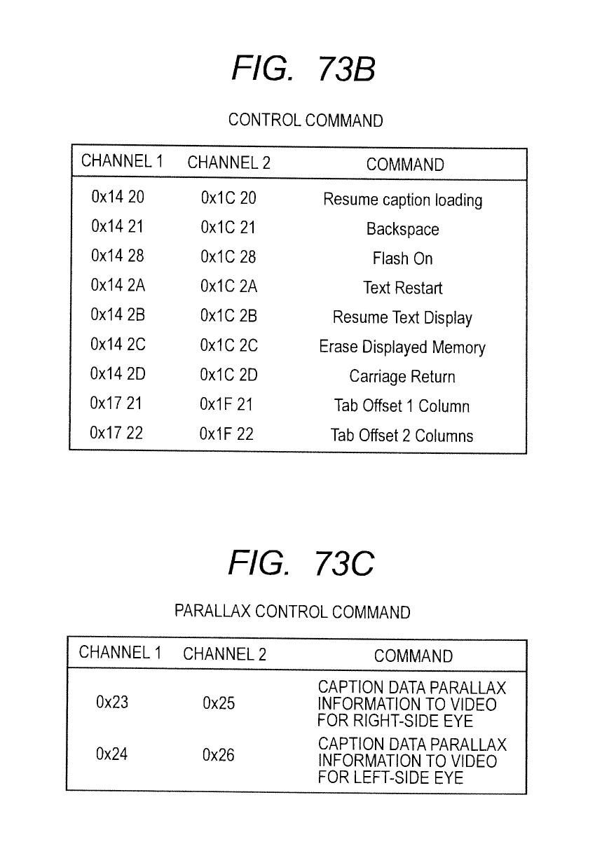

First of all, there is a possibility that the data for use of the caption may be inserted, for example, into a user data area included within a sequence header of the video data. FIG. 73A shows an example of the configuration of the user data, which is included within the sequence header to be the extended data. “user_data_start_code” is a fixed value, for identifying uniquely, that the data hereinafter be the user data, and it is “0x000001B2”, for example. “user_data_type_code” is a fixed value, for identifying uniquely, that in the data hereinafter be included the caption information, etc., and it is “0x03”, for example. “vbi_data_flag” indicates if the caption data or the like is included therein, or not. If it is “1”, an analysis is made on the caption data hereinafter, and if “0”, no analysis is necessary. “cc_count” indicates an amount or volume of the caption data hereinafter. “cc_priority” indicates priority when producing the picture, such as, in the forms of “0” the maximum priority) through “3” (the lowest priority), for example. “field_number” selects is a field for displaying the caption therein, such as, by “Odd/Even”, for example. In “cc_data_{—}1” and “cc_data_{—}2” are included the character line to be displayed and a control command. In the control command are included: for example, a command for designating the character color or the background color, and/or a command for designating an operation, such as, the roll-up (i.e., a caption service of displaying the caption data, which is transmitted as the page data, within an areas of about 3 lines, which is set up previously, by a unit of a line, one by one. The roll-up is made in the direction of the line when a return key is pushed down.), or blinking, etc. An example of the control commands is shown in FIG. 73B. A reason why it indicates plural numbers of channels, such as, “channel 1” and “channel 2”, for example, lies in enabling to display the plural numbers of the caption data at once. To the channels are assigned the control commands, having the similar meaning of control and different values, respectively. Also, for preventing the character line and the control command from being mixed up with, for example, it is sufficient to determine that the character line may use a value after “0x20” and the control command may start from a value within “0x10”-“0x1F”, and so on.

In this instance, regarding the parallax information for indicating the parallax of the caption data, it is enough to designate it while disposing the parallax control command data shown in FIG. 73C, for example, just after the “Text Restart” command. Thus, it is sufficient to dispose the parallax amount just after the control commend, to be selectable within a range of the values, for example, “0x20” through “0x7 E” (i.e., “32” through “126” in the decimal number). Meaning of that designated value is presenting the parallax from “0x4F” (i.e., “79” in the decimal number), to be a center thereof, by an increasing/decreasing amount (“−47” through “+47”). With this, it is possible to produce the parallax of 94 pixels in total. For example, a position direction is defined to the right while a negative direction to the left (of course, the reverse is also true), herein.

By determining the value to be designated within the transmitting apparatus in this manner, it is possible to interpret the depth information, uniquely, in an arbitrary receiving apparatus.

For example, when trying to provide the parallax of 10 pixels in the positive direction on the video data for the right-side eye with using the channel 1, it is possible to deal with, by transmitting an alignment of data, such as, “0x14”, “0x2A”, “0x23” and “0x59”, for example, from the transmitter side, and by interpreting it on the receiver side. It can be seen, the caption information of the channel 1 is initialized upon “0x14” and “0x2A”, and next the parallax information of the caption data directing for the picture for the right-side eye is transmitted upon “0x23”. “0x59” next thereto is an actual parallax data, and “10”, i.e., the difference from “0x4F” is the parallax information. Following thereto, by implementing the processes, such as, transmitting the parallax information of the caption data directing for the left-side eye, transmitting the main body of the caption data, etc., for example, in the similar trick.

Within the user data shown in FIG. 73A may be included data other than the caption data, after the caption data explained in the above. “next_start_code( )” may be a fixed value, such as, “0x000001”, for example, and with this, it is enough to interpret that the user data is ended hereinafter.

The method for controlling within the receiving apparatus, in particular, when receiving the parallax control command data mentioned above, is that, which can be obtained by changing “information for designating the depth display position” in the example of operation shown in FIGS. 68, 70 and 71, into “parallax control command” shown in FIG. 73C. In the S6805 shown in FIG. 68, in particular, when no left/right parallax information segment is included within the 3D video content received, the display character line of the caption may be displayed, with using the information of the predetermined left/right parallax information segment, while storing this in a memory in advance, as the standard information of the left/right parallax information segment. Other operation(s) is/are same to that shown in FIGS. 68, 70 and 71, and therefore the explanation thereof will be omitted herein.

<Example of Processes when Recording/Reproducing>

Next, explanation will be given on the processes when recording and reproducing the content, including therein the 3D video data and the caption data explained in the above.

<Recording Entire of 3D Broadcast Attaching Caption Data/Recording Entire of CSI>

When receiving the 3D content stream, including the caption data explained in the above, and recording it onto a recording medium, the record/reproduce portion 27 records the caption data PES, including the information for designating the depth display position motioned above therein, as they are, on the recording medium 26. Also, when reproducing, upon the caption data readout from the recording medium 26 is treated the control by the multiplex/demultiplex portion 29, etc., in the similar manner to that when receiving the broadcast signal, as shown in FIGS. 68, 70 and 71. With this, it is possible to view the caption capable with the 3D display. If such data for use of control is included in the caption data PES, as is shown in FIG. 52, even in a case of editing the video data and the audio data during the time when recording (e.g., a trans-code process, etc.), for example, it is possible to deal with the recording/reproducing mentioned above.

Also, when recording the 3D program content after converting it into the 2D format, or when the recording/reproducing apparatus can execute the 2D display only, it does not matter to delete the information relating to the depth display position and the parallax for the 3D display of the caption data, for example, the information for designating the depth display position shown in FIG. 65, the left/right parallax information segment shown in FIG. 72D, and the parallax control command shown in FIG. 73C, etc., which are mentioned above, when recording. Reduction of the data amount or volume in that manner enables to utilize the recording capacity of the recording medium, effectively.

Also, on the contrary to the example of processes when recording, as was mentioned above, in case where the video data of the stream received is the 2D video having no information relating to the depth display position and the parallax for the 3D display of the caption data, for example, the information for designating the depth display position shown in FIG. 65, the left/right parallax information segment shown in FIG. 72D, and the parallax control command shown in FIG. 73C, etc., and in particular when recoding the video data after converting it into the 3D video, in the receiving apparatus 4, the information relating to the depth display position and the parallax for the 3D display of those caption data may be recorded together with the video data after the 3D conversion thereof and/or the caption data.

<When Superimposing Caption Data and OSD Unique to TV on 3D Display>

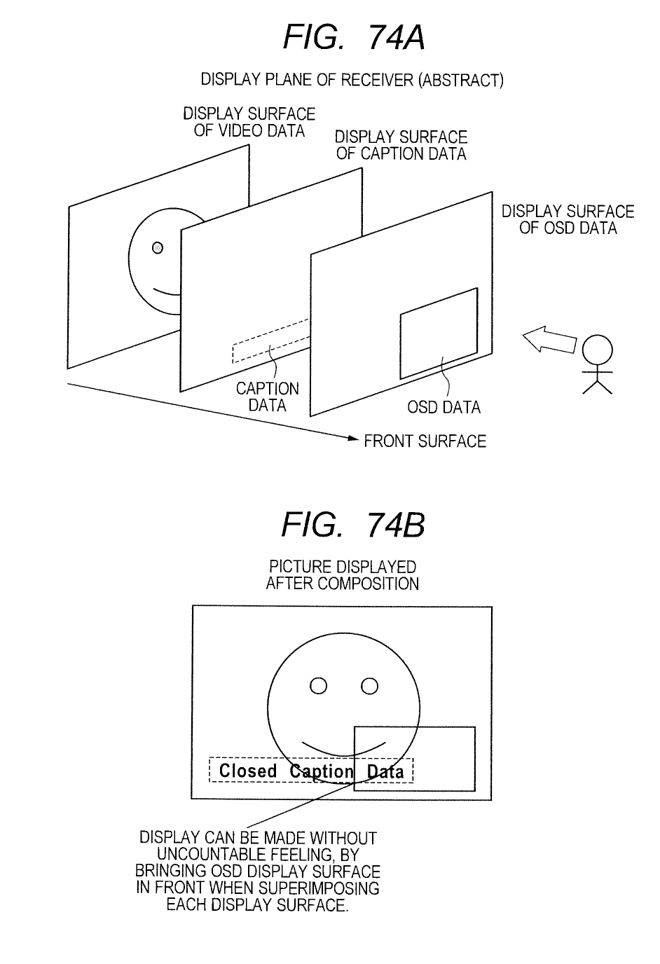

Herein, consideration will be given on case where the receiving apparatus or the recording/reproducing apparatus displays a unique OSD on the screen, upon the display of the caption data explained in the above, at the same time. A view of conception of a surface, on which the caption data and the OSD data are written, is shown in FIG. 74A. Within the receiving apparatus 4, a display plane is so configured that the OSD data comes in front than the caption data, as is shown in the figure. Further, when producing the 3D display screen, the parallax is controlled, in such a manner that the OSD is displayed, in the depth display position thereof, on the forefront surface. With doing so, in relation with the depth display position of the caption data, it is possible to prevent the OSD display from producing the uncomfortable feeling to the user. For example, even if the caption data locates on the forefront surface, since the screen is composed by writing the display data of the OSD over the caption, depending on an order of piling-up of the planes, it results into a display without the uncomfortable feeling. An example of the display screen after the composing is shown in FIG. 74B. Even in case where the OSD data has a transmitting property, it is possible to produce the display screen having no uncomfortable feeling, by conducting the display control in the similar manner.

<Example of HDMI Output Control>

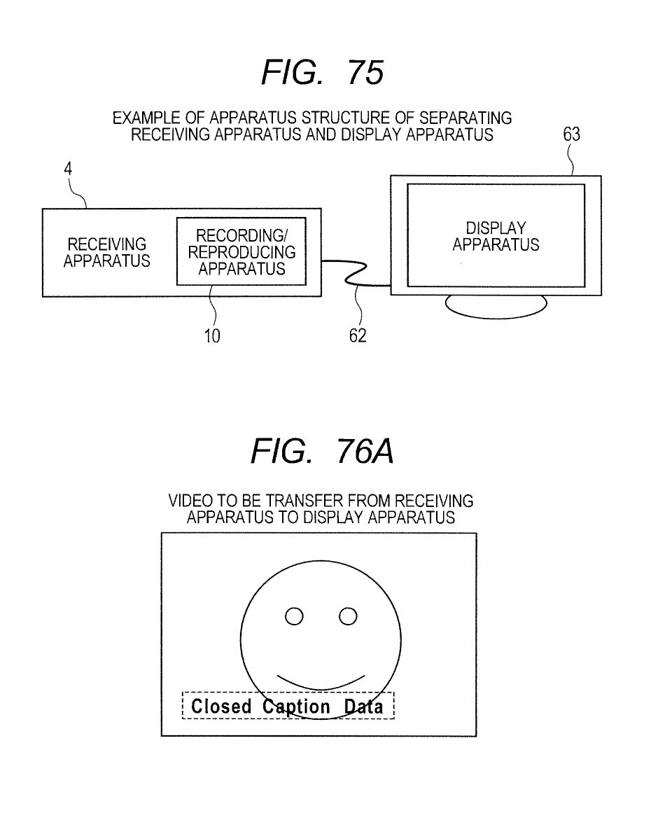

As an example of configuration of the equipment, other than the embodiment mentioned above, explanation will be given on the configuration, where the receiving apparatus 4 and a display apparatus 63 are separated, and they are connected with, for example, through a serial transmission method, as is shown in FIG. 75. A transmission bas 62, connecting between the display apparatus 4 and the display apparatus 63, can transmit the video/audio data thereon, and also can transmit a command, which can be sent with a predetermined format. As the transmission method can be listed up connection with using HDMI (0), for example. The display apparatus 63 is an apparatus for displaying the video/audio data transmitted through the transmission bas 62, and it has a display panel and a speaker(s), etc. In case of the present configuration, so as to output/display the caption data on the display apparatus 63, it is enough to produce data composing or combining the caption data on the video data in the receiving apparatus 4, to transfer it to the display apparatus 63. Upon the view/listen of the 3D video, the 3D display can be obtained on the display apparatus 63, if according to the transmission method of the 3D video data, which is determined in the transmission method. On the display apparatus 63 may be displayed such picture for the left-side eye and such picture for the right-side eye, respectively, as is shown in FIG. 69A or 69B.

When superimposing the OSD in the receiving apparatus 4, similarly, it is enough to produce the picture by superimposing the OSD in the receiving apparatus 4, to be transmitted to the display apparatus 63, wherein the display apparatus 63 displays the picture for the left-side eye and the picture for the right-side eye, respectively.

On the other hand, when the picture for the 3D display is produced in the receiving apparatus 4, to be displayed on the display apparatus 63 superimposing the OSD thereon, the display apparatus 63 cannot display on the forefront surface, if it cannot grasp the maximum amount of parallax of the picture for 3D display, which is produced on side of the receiving apparatus 4. For that reason, the parallax information is transmitted through the transmission bas 62, from the receiving apparatus 4 to the display apparatus 63. With this, on the display apparatus 63 can be grasped the maximum amount of parallax of the picture for 3D display, which is produced on side of the receiving apparatus 4. As a detailed method for transmitting the parallax information can be listed up, for example, a transmission with using CEC, being an equipment control signal in HDMI connection. It is possible to deal with, by providing an area for describing the parallax amount, newly, in “Reversed” area of “HDMI Vendor Specific InfoFrame Packet Contents.

As is such example as shown in FIG. 74A or 74B mentioned above, since the display without uncomfortable feeling can be obtained if displaying the OSD on the forefront surface, it is possible to display the OSD on the forefront surface, on the display apparatus 63, for the display screen, by transferring the parallax information, such as, the maximum value of the parallax and/or the number pixels, etc., from the receiving apparatus 4 to the display apparatus 63. As timing for transmitting the parallax information, it is sufficient, for example, for the receiving apparatus 4 to transmits a fixed maximum value, only one (1) time, when the display of the 3D program starts. In this case, there can be obtained a merit that a number of times of transmission is small and a processing load is less. Also, in case where there is a method for determining the amount of the maximum parallax for the user on the receiving apparatus 4, it is sufficient to make the transmission every time when it is changed.

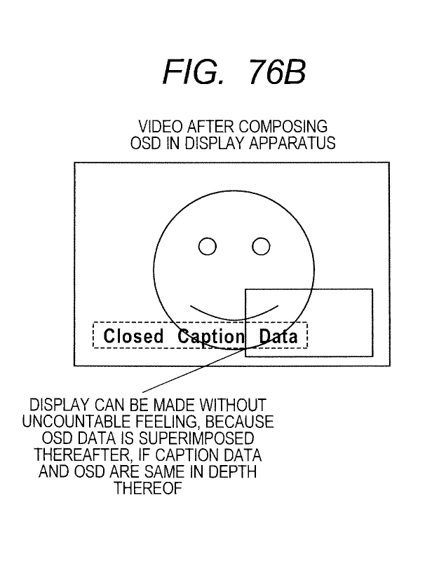

FIG. 76A shows an example of the display screen to be transmitted from the receiving apparatus 4 to the display apparatus 63. For example, the caption data is the 3D display picture, which is displayed in front that the display picture. This picture comes to be displayed as it is, if no OSD is displayed on the display apparatus 63.

On the contrary thereto, FIG. 76B shows an example of the picture displaying the OSD on the display apparatus 63, to which the maximum value information of parallax is transmitted from the receiving apparatus 4. With using the maximum value information of the parallax, it is possible to obtain the display without the uncomfortable feeling, by superimposing the OSD at the position in front than that of any one of the display pictures and the caption data, among the pictures transferred from the receiving apparatus 4.

FIGS. 76A and 76B show the examples of displays including the caption data therein, however even in case where no caption data is displayed on the receiving apparatus 4, it is possible to display the OSD on the forefront surface on the display apparatus 63, by transmitting the parallax information from the receiving apparatus 4, in accordance with such steps as was mentioned above. Or, even when transmitting the data obtained by superimposing the caption data and the OSD in the receiving apparatus 4, it is possible to display the OSD, which is produced in the display apparatus 63, in front than the caption data and the OSD of the receiving apparatus 4, and also to obtain the display without the uncomfortable feeling, by transmitting the parallax information from the receiving apparatus 4, in accordance with such steps as was mentioned above. Also, though the explanation was given on the example of transmitting the maximum value of the parallax, in the present embodiment, however it is also possible to transmit the minimum value in addition thereto, or to transmit the maximum value and the minimum value for each of the areas, being separated on the screen. Also, regarding the timing for transmitting the value(s) of the parallax, it/they may be transmitted at a periodic time interval, such as, 1 sec., for example. Conducting those processes enables to widen the width, in which the OSD can be displayed without the uncomfortable feeling on the display apparatus 63, in the depth direction thereof.

What is claimed is:

1. A receiving apparatus, comprising:
a receiving portion, which is configured to receive a 3D video content, including video data and caption data therein;
a video processing portion, which is configured to conduct video processing on said video data and said caption data, so as to display it/them in 3D or 2D; and
an operation input/output portion, which is configured to input an operation input signal from a user, wherein
the video processing made by said video processing portion, when information of depth display position or parallax information relating to said caption data is included within said 3D content received, comprises the followings:
a first video process for displaying the video data of said 3D video content received, and for displaying said caption data received with using said information of depth display position or said parallax information; and
a second video process for displaying the video data of said 3D video content received in 2D, and for displaying said caption information received without based on said information of depth display position or said parallax information, when an operation input signal to change 3D display into 2D display is inputted.

2. The receiving apparatus, as described in the claim 1, wherein the video process of said video processing portion further executes a third video process for displaying said caption data in 3D upon basis of a predetermined depth display position or a predetermined parallax, when no information of depth display position nor parallax information relating to said caption data within said 3D video content received.

3. The receiving apparatus, as described in the claim 1, wherein said video processing portion displays the video data and said caption of said 3D video content received, and further when displaying OSD, displays the OSD in 3D, at a display position in front at the most.

4. A video displaying method, comprising the following steps of:
a step for receiving a 3D video content, including video data and caption data therein; and
a video processing step for conducting video processing so as to display said video data and said caption data received, so as to display it/them in 3D or 2D, wherein
the video processing in said video processing step, when information of depth display position or parallax information relating to said caption data is included within said 3D content received, comprises the followings:
a first video process for display the video data of said 3D video content received, and for displaying said caption data received with using said information of depth display position or said parallax information; and
a second video process for displaying the video data of said 3D video content received in 2D, and for displaying said caption information received without based on said information of depth display position or said parallax information, when an operation input signal to change 3D display into 2D display is inputted.

5. The video displaying method, as described in the claim 4, wherein the video process of said video processing step further executes a third video process for displaying said caption data in 3D upon basis of a predetermined depth display position or a predetermined parallax, when no information of depth display position nor parallax information relating to said caption data within said 3D video content received.

6. The video displaying method, as described in the claim 4, wherein said video processing portion displays the video data and said caption of said 3D video content received, and further when displaying OSD, displays the OSD in 3D, at a display position in front at the most.

7. A video displaying method, comprising the following steps of:
a step for a transmitting apparatus to transmit a 3D video content, including video data and caption data therein;
a step for a receiving apparatus to receive said 3D video content; and
a step for said receiving apparatus to conduct video processing, so as to display said video data and said caption data received, and thereby to display it/them in 3D or 2D, wherein
the video processing in said video processing step, when information of depth display position or parallax information relating to said caption data is included within said 3D content received, comprises the followings:
a first video process for display the video data of said 3D video content received, and for displaying said caption data received with using said information of depth display position or said parallax information; and
a second video process for displaying the video data of said 3D video content received in 2D, and for displaying said caption information received without based on said information of depth display position or said parallax information, when an operation input signal to change 3D display into 2D display is inputted.

8. A receiving apparatus, comprising:
a receiving portion, which is configured to receive a 3D video content, including video data and caption data therein; and
a video processing portion, which is configured to conduct video processing on said video data and said caption data, so as to display it/them in 3D or 2D, wherein
the video processing made by said video processing portion, for displaying the video data of said 3D video content received, comprises the followings:
a first video process for displaying said caption data in 3D, upon basis of information of depth display position or parallax information, when said information of depth display position or said parallax information relating to said caption data is included within said 3D content received; and
a second video process for displaying said caption data in 3D with using a predetermined depth display position or a predetermined parallax, when no information of depth display position nor parallax information relating to said caption data within said 3D video content received.

9. The receiving apparatus, as described in the claim 8, wherein said video processing portion displays the video data and said caption of said 3D video content received, and further when displaying OSD, displays the OSD in 3D, at a display position in front at the most.

10. A video displaying method, comprising the following steps of:
a step for receiving a 3D video content, including video data and caption data therein; and
a video processing step for conducting video processing so as to display said video data and said caption data received, so as to display it/them in 3D or 2D, wherein
the video processing in said video processing step comprises the followings:
a first video process for displaying said caption data in 3D, upon basis of information of depth display position or parallax information, when said information of depth display position or said parallax information relating to said caption data is included within said 3D content received; and
a second video process for displaying said caption data in 3D with using a predetermined depth display position or a predetermined parallax, when no information of depth display position nor parallax information relating to said caption data within said 3D video content received.

11. The video displaying method, as described in the claim 10, wherein said video processing portion displays the video data and said caption of said 3D video content received, and further when displaying OSD, displays the OSD in 3D, at a display position in front at the most.

12. A video displaying method, comprising the following steps of:
a step for a transmitting apparatus to transmit a 3D video content, including video data and caption data therein;
a step for a receiving apparatus to receive said 3D video content; and
a step for said receiving apparatus to conduct video processing, so as to display said video data and said caption data received, and thereby to display it/them in 3D, wherein
the video processing in said video processing step comprises the followings:
a first video process for displaying said caption data in 3D, upon basis of information of depth display position or parallax information, when said information of depth display position or said parallax information relating to said caption data is included within said 3D content received; and
a second video process for displaying said caption data in 3D with using a predetermined depth display position or a predetermined parallax, when no information of depth display position nor parallax information relating to said caption data within said 3D video content received.
